(19) United States
(12) Patent Application Publication
(10) Pub. No.: US 2020/0120326 A1
(43) Pub. Date: Apr. 16, 2020

(54) SYSTEMS AND METHODS FOR SIGNALING VIEW INFORMATION FOR VIRTUAL REALITY APPLICATIONS

(71) Applicant: SHARP KABUSHIKI KAISHA

(72) Inventor: SACHIN G. DESHPANDE, Vancouver, WA (US)

(73) Assignees: SHARP KABUSHIKI KAISHA, Sakai City, Osaka (JP); SHARP KABUSHIKI KAISHA, Sakai City, Osaka (JP)

(21) Appl. No.: 16/627,197

(22) PCT Filed: Jul. 4, 2018
(86) PCT No.: PCT/JP2018/025312

§ 371 Date: Dec. 27, 2019

Related U.S. Application Data
(60) Provisional application No. 62/585,864, filed on Nov. 14, 2017.
(60) Provisional application No. 62/572,312, filed on Oct. 13, 2017.
(60) Provisional application No. 62/570,540, filed on Oct. 10, 2017.
(60) Provisional application No. 62/530,253, filed on Jul. 9, 2017.
(60) Provisional application No. 62/530,136, filed on Jul. 8, 2017.
(60) Provisional application No. 62/529,429, filed on Jul. 6, 2017.

(51) Int. Cl. H04N 13/178; H04N 19/70; H04N 19/597

(52) U.S. Cl. CPC H04N 13/178; H04N 19/597; H04N 19/70

(57) ABSTRACT

Informations associated omnidirectional video in MPD (Media Presentation Description) are disclosed. They contain “region-wise quality ranking information” in a set of values using a comma separated list enclosed by delimiters. (See paragraphs [0180], [0216]-[0218], [0292], [0293] and FIG. 10.) They also contain “view indicator”, “yaw of a center point”, “pitch of a center point”, “roll angle”, “horizontal range” and “vertical range”. (See paragraphs [0218] and [0287].) They also contain “projection type” or “region-wise packing information” as a list of unsigned bytes. (See paragraphs [0356], [0359] and FIGS. 13A, 13B, 14A, 15A.) They also contain “top level element” and “common set of attributes”. (See paragraphs [0009], [0010].)

### TECHNICAL FIELD

This disclosure relates to the field of interactive video distribution and more particularly to techniques for signaling of information associated with a region in a virtual reality application.

### BACKGROUND ART

Digital media playback capabilities may be incorporated into a wide range of devices, including digital televisions, including so-called “smart” televisions, set-top boxes, laptop or desktop computers, tablet computers, digital recording devices, digital media players, video gaming devices, cellular phones, including so-called “smart” phones, dedicated video streaming devices, and the like. Digital media content (e.g., video and audio programming) may originate from a plurality of sources including, for example, over-the-air television providers, satellite television providers, cable television providers, online media service providers, including, so-called streaming service providers, and the like. Digital media content may be delivered over packet-switched networks, including bidirectional networks, such as Internet Protocol (IP) networks and unidirectional networks, such as digital broadcast networks.

Digital video included in digital media content may be coded according to a video coding standard. Video coding standards may incorporate video compression techniques. Examples of video coding standards include ISO/IEC MPEG-4 Visual and ITU-T H.264 (also known as ISO/IEC MPEG-4 AVC) and High-Efficiency Video Coding (HEVC). Video compression techniques enable data requirements for storing and transmitting video data to be reduced. Video compression techniques may reduce data requirements by exploiting the inherent redundancies in a video sequence. Video compression techniques may sub-divide a video sequence into successively smaller portions (i.e., groups of frames within a video sequence, a frame within a group of frames, slices within a frame, coding tree units (e.g., macroblocks) within a slice, coding blocks within a coding tree unit, etc.). Prediction coding techniques may be used to generate difference values between a unit of video data to be coded and a reference unit of video data. The difference values may be referred to as residual data. Residual data may be coded as quantized transform coefficients. Syntax elements may relate residual data and a reference coding unit. Residual data and syntax elements may be included in a compliant bitstream. Compliant bitstreams and associated metadata may be formatted according to data structures. Compliant bitstreams and associated metadata may be transmitted from a source to a receiver device (e.g., a digital television or a smart phone) according to a transmission standard. Examples of transmission standards include Digital Video Broadcasting (DVB) standards, Integrated Services Digital Broadcasting Standards (ISDB) standards, and standards developed by the Advanced Television Systems Committee (ATSC), including, for example, the ATSC 2.0 standard. The ATSC is currently developing the so-called ATSC 3.0 suite of standards.

### SUMMARY OF INVENTION

In general, this disclosure describes various techniques for signaling information associated with a virtual reality application. In particular, this disclosure describes techniques for signaling information associated with regions on a sphere. It should be noted that although in some examples, the techniques of this disclosure are described with respect to transmission standards, the techniques described herein may be generally applicable. For example, the techniques described herein are generally applicable to any of DVB standards, ISDB standards, ATSC Standards, Digital Terrestrial Multimedia Broadcast (DTMB) standards, Digital Multimedia Broadcast (DMB) standards, Hybrid Broadcast and Broadband Television (HbbTV) standards, World Wide Web Consortium (W3C) standards, and Universal Plug and Play (UPnP) standard. Further, it should be noted that although techniques of this disclosure are described with respect to ITU-T H.264 and ITU-T H.265, the techniques of this disclosure are generally applicable to video coding, including omnidirectional video coding. For example, the coding techniques described herein may be incorporated into video coding systems, (including video coding systems based on future video coding standards) including block structures, intra prediction techniques, inter prediction techniques, transform techniques, filtering techniques, and/or entropy coding techniques other than those included in ITU-T H.265. Thus, reference to ITU-T H.264 and ITU-T H.265 is for descriptive purposes and should not be construed to limit the scope of the techniques described herein. Further, it should be noted that incorporation by reference of documents herein should not be construed to limit or create ambiguity with respect to terms used herein. For example, in the case where an incorporated reference provides a different definition of a term than another incorporated reference and/or as the term is used herein, the term should be interpreted in a manner that broadly includes each respective definition and/or in a manner that includes each of the particular definitions in the alternative.

An aspect of the invention is a method of signaling information associated with an omnidirectional video, the method comprising:

signaling region-wise quality ranking information associated with an omnidirectional video using a media presentation description document, wherein signaling region-wise quality ranking information associated with an omnidirectional video using a media presentation description document includes signaling a set of values using a comma separated list enclosed by delimiters.

An aspect of the invention is a method of determining information associated with an omnidirectional video, the method comprising:
parsing region-wise quality ranking information associated with an omnidirectional video using a media presentation description document, wherein parsing region-wise quality ranking information associated with an omnidirectional video using a media presentation description document includes parsing a set of values from a comma separated list enclosed by delimiters.

An aspect of the invention is a method of signaling information associated with an omnidirectional video, the method comprising:
signaling projection type or region-wise packing information associated with an omnidirectional video using a media presentation description document, wherein signaling the information associated with an omnidirectional video using a media presentation description document includes signaling a list of unsigned bytes.

An aspect of the invention is a method of determining information associated with an omnidirectional video, the method comprising:
parsing projection type or region-wise packing information associated with an omnidirectional video using a media presentation description document, wherein parsing the information associated with an omnidirectional video using a media presentation description document includes parsing a list of unsigned bytes.

An aspect of the invention is a method of signaling information associated with an omnidirectional video, the method comprising:
signaling region-wise quality ranking information associated with an omnidirectional video using a media presentation description document, wherein signaling region-wise quality ranking information associated with an omnidirectional video using a media presentation description document includes signaling a top level element and with a common set of attributes.

An aspect of the invention is a method of determining information associated with an omnidirectional video, the method comprising:
parsing region-wise quality ranking information associated with an omnidirectional video using a media presentation description document, wherein parsing region-wise quality ranking information associated with an omnidirectional video using a media presentation description document includes parsing a top level element and with a common set of attributes.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example of a system that may be configured to transmit coded video data according to one or more techniques of this disclosure.

FIG. 2A is a conceptual diagram illustrating coded video data and corresponding data structure according to one or more techniques of this disclosure.

FIG. 2B is a conceptual diagram illustrating coded video data and corresponding data structure according to one or more techniques of this disclosure.

FIG. 3 is a conceptual diagram illustrating coded video data and corresponding data structures according to one or more techniques of this disclosure.

FIG. 4 is a conceptual diagram illustrating an example of processing stages that may be used to derive a packed frame from a spherical projection structure according to one or more techniques of this disclosure.

FIG. 5A is conceptual diagram illustrating example of a projected picture region and a packed picture according to one or more techniques of this disclosure.

FIG. 5B is conceptual diagram illustrating example of a projected picture region and a packed picture according to one or more techniques of this disclosure.

FIG. 6A is conceptual diagram illustrating example of specifying sphere regions according to one or more techniques of this disclosure.

FIG. 6B is conceptual diagram illustrating example of specifying sphere regions according to one or more techniques of this disclosure.

FIG. 7 is a conceptual drawing illustrating an example of components that may be included in an implementation of a system that may be configured to transmit coded video data according to one or more techniques of this disclosure.

FIG. 8 is a block diagram illustrating an example of a data encapsulator that may implement one or more techniques of this disclosure.

FIG. 9 is a block diagram illustrating an example of a receiver device that may implement one or more techniques of this disclosure.

FIG. 10 is a computer program listing illustrating an example of signaling metadata according to one or more techniques of this disclosure.

FIG. 11A is computer program listing illustrating example of signaling metadata according to one or more techniques of this disclosure.

FIG. 11B is computer program listing illustrating example of signaling metadata according to one or more techniques of this disclosure.

FIG. 12 is a computer program listing illustrating an example of signaling metadata according to one or more techniques of this disclosure.

FIG. 13A is computer program listing illustrating example of signaling metadata according to one or more techniques of this disclosure.

FIG. 13B is computer program listing illustrating example of signaling metadata according to one or more techniques of this disclosure.

FIG. 14A is computer program listing illustrating example of signaling metadata according to one or more techniques of this disclosure.

FIG. 14B is computer program listing illustrating example of signaling metadata according to one or more techniques of this disclosure.

FIG. 15A is computer program listing illustrating example of signaling metadata according to one or more techniques of this disclosure.

FIG. 15B is computer program listing illustrating example of signaling metadata according to one or more techniques of this disclosure.

FIG. 16 is a computer program listing illustrating an example of signaling metadata according to one or more techniques of this disclosure.

FIG. 17A is a computer program listing illustrating an example of signaling metadata according to one or more techniques of this disclosure.

FIG. 17B is the next part of FIG. 17A

FIG. 17C is a computer program listing illustrating an example of signaling metadata according to one or more techniques of this disclosure.

FIG. 17D is the next part of FIG. 17C

FIG. 18A is a computer program listing illustrating an example of signaling metadata according to one or more techniques of this disclosure.

FIG. 18B is the next part of FIG. 18A

FIG. 19A is a computer program listing illustrating an example of signaling metadata according to one or more techniques of this disclosure.

FIG. 19B is the next part of FIG. 19A

FIG. 19C is a computer program listing illustrating an example of signaling metadata according to one or more techniques of this disclosure.

FIG. 19D is the next part of FIG. 19C

FIG. 20 is a computer program listing illustrating an example of signaling metadata according to one or more techniques of this disclosure.

FIG. 21 is a computer program listing illustrating an example of signaling metadata according to one or more techniques of this disclosure.

FIG. 22 is a computer program listing illustrating an example of signaling metadata according to one or more techniques of this disclosure.

FIG. 23 is a computer program listing illustrating an example of signaling metadata according to one or more techniques of this disclosure.

### DESCRIPTION OF EMBODIMENTS

Video content typically includes video sequences comprised of a series of frames. A series of frames may also be referred to as a group of pictures (GOP). Each video frame or picture may include a one or more slices, where a slice includes a plurality of video blocks. A video block may be defined as the largest array of pixel values (also referred to as samples) that may be predictively coded. Video blocks may be ordered according to a scan pattern (e.g., a raster scan). A video encoder performs predictive encoding on video blocks and sub-divisions thereof. ITU-T H.264 specifies a macroblock including 16×16 luma samples. ITU-T H.265 specifies an analogous Coding Tree Unit (CTU) structure where a picture may be split into CTUs of equal size and each CTU may include Coding Tree Blocks (CTB) having 16×16, 32×32, or 64×64 luma samples. As used herein, the term video block may generally refer to an area of a picture or may more specifically refer to the largest array of pixel values that may be predictively coded, sub-divisions thereof, and/or corresponding structures. Further, according to ITU-T H.265, each video frame or picture may be partitioned to include one or more tiles, where a tile is a sequence of coding tree units corresponding to a rectangular area of a picture.

In ITU-T H.265, the CTBs of a CTU may be partitioned into Coding Blocks (CB) according to a corresponding quadtree block structure. According to ITU-T H.265, one luma CB together with two corresponding chroma CBs and associated syntax elements are referred to as a coding unit (CU). A CU is associated with a prediction unit (PU) structure defining one or more prediction units (PU) for the CU, where a PU is associated with corresponding reference samples. That is, in ITU-T H.265 the decision to code a picture area using intra prediction or inter prediction is made at the CU level and for a CU one or more predictions corresponding to intra prediction or inter prediction may be used to generate reference samples for CBs of the CU. In ITU-T H.265, a PU may include luma and chroma prediction blocks (PBs), where square PBs are supported for intra prediction and rectangular PBs are supported for inter prediction. Intra prediction data (e.g., intra prediction mode syntax elements) or inter prediction data (e.g., motion data syntax elements) may associate PUs with corresponding reference samples. Residual data may include respective arrays of difference values corresponding to each component of video data (e.g., luma (Y) and chroma (Cb and Cr)). Residual data may be in the pixel domain. A transform, such as, a discrete cosine transform (DCT), a discrete sine transform (DST), an integer transform, a wavelet transform, or a conceptually similar transform, may be applied to pixel difference values to generate transform coefficients. It should be noted that in ITU-T H.265, CUs may be further sub-divided into Transform Units (TUs). That is, an array of pixel difference values may be sub-divided for purposes of generating transform coefficients (e.g., four 8×8 transforms may be applied to a 16×16 array of residual values corresponding to a 16×16 luma CB), such sub-divisions may be referred to as Transform Blocks (TBs). Transform coefficients may be quantized according to a quantization parameter (QP). Quantized transform coefficients (which may be referred to as level values) may be entropy coded according to an entropy encoding technique (e.g., content adaptive variable length coding (CAVLC), context adaptive binary arithmetic coding (CABAC), probability interval partitioning entropy coding (PIPE), etc.). Further, syntax elements, such as, a syntax element indicating a prediction mode, may also be entropy coded. Entropy encoded quantized transform coefficients and corresponding entropy encoded syntax elements may form a compliant bitstream that can be used to reproduce video data. A binarization process may be performed on syntax elements as part of an entropy coding process. Binarization refers to the process of converting a syntax value into a series of one or more bits. These bits may be referred to as “bins.”

Virtual Reality (VR) applications may include video content that may be rendered with a head-mounted display, where only the area of the spherical video that corresponds to the orientation of the user's head is rendered. VR applications may be enabled by omnidirectional video, which is also referred to as 360 degree spherical video of 360 degree video. Omnidirectional video is typically captured by multiple cameras that cover up to 360 degrees of a scene. A distinct feature of omnidirectional video compared to normal video is that, typically only a subset of the entire captured video region is displayed, i.e., the area corresponding to the current user's field of view (FOV) is displayed. A FOV is sometimes also referred to as viewport. In other cases, a viewport may be part of the spherical video that is currently displayed and viewed by the user. It should be noted that the size of the viewport can be smaller than or equal to the field of view. Further, it should be noted that omnidirectional video may be captured using monoscopic or stereoscopic cameras. Monoscopic cameras may include cameras that capture a single view of an object. Stereoscopic cameras may include cameras that capture multiple views of the same object (e.g., views are captured using two lenses at slightly different angles). Further, it should be noted that in some cases, images for use in omnidirectional video applications may be captured using ultra wide-angle lens (i.e., so-called fisheye lens). In any case, the process for creating 360 degree spherical video may be generally described as stitching together input images and projecting the stitched together input images onto a three-dimensional structure (e.g., a sphere or cube), which may result in so-called projected frames. Further, in some cases, regions of projected frames may be transformed, resized, and relocated, which may result in a so-called packed frame.

A region in an omnidirectional video picture may refer to a subset of the entire video region. It should be noted that regions of an omnidirectional video may be determined by the intent of a director or producer, or derived from user statistics by a service or content provider (e.g., through the statistics of which regions have been requested/seen by the most users when the omnidirectional video content was provided through a streaming service). For example, for an omnidirectional video capturing a sporting event, a region may be defined for a view including the center of the playing field and other regions may be defined for views of the stands in a stadium. Regions may be used for data pre-fetching in omnidirectional video adaptive streaming by edge servers or clients, and/or transcoding optimization when an omnidirectional video is transcoded, e.g., to a different codec or projection mapping. Thus, signaling regions in an omnidirectional video picture may improve system performance by lowering transmission bandwidth and lowering decoding complexity.

Transmission systems may be configured to transmit omnidirectional video to one or more computing devices. Computing devices and/or transmission systems may be based on models including one or more abstraction layers, where data at each abstraction layer is represented according to particular structures, e.g., packet structures, modulation schemes, etc. An example of a model including defined abstraction layers is the so-called Open Systems Interconnection (OSI) model. The OSI model defines a 7-layer stack model, including an application layer, a presentation layer, a session layer, a transport layer, a network layer, a data link layer, and a physical layer. It should be noted that the use of the terms upper and lower with respect to describing the layers in a stack model may be based on the application layer being the uppermost layer and the physical layer being the lowermost layer. Further, in some cases, the term “Layer 1” or “L1” may be used to refer to a physical layer, the term “Layer 2” or “L2” may be used to refer to a link layer, and the term “Layer 3” or “L3” or “IP layer” may be used to refer to the network layer.

A physical layer may generally refer to a layer at which electrical signals form digital data. For example, a physical layer may refer to a layer that defines how modulated radio frequency (RF) symbols form a frame of digital data. A data link layer, which may also be referred to as a link layer, may refer to an abstraction used prior to physical layer processing at a sending side and after physical layer reception at a receiving side. As used herein, a link layer may refer to an abstraction used to transport data from a network layer to a physical layer at a sending side and used to transport data from a physical layer to a network layer at a receiving side. It should be noted that a sending side and a receiving side are logical roles and a single device may operate as both a sending side in one instance and as a receiving side in another instance. A link layer may abstract various types of data (e.g., video, audio, or application files) encapsulated in particular packet types (e.g., Motion Picture Expert Group-Transport Stream (MPEG-TS) packets, Internet Protocol Version 4 (IPv4) packets, etc.) into a single generic format for processing by a physical layer. A network layer may generally refer to a layer at which logical addressing occurs. That is, a network layer may generally provide addressing information (e.g., Internet Protocol (IP) addresses) such that data packets can be delivered to a particular node (e.g., a computing device) within a network. As used herein, the term network layer may refer to a layer above a link layer and/or a layer having data in a structure such that it may be received for link layer processing. Each of a transport layer, a session layer, a presentation layer, and an application layer may define how data is delivered for use by a user application.

Choi et al., ISO/IEC JTC1/SC29/WG11 M40849, “OMAF DIS text with updates based on Berlin OMAF AHG meeting agreements,” July 2017, Torino, IT, which is incorporated by reference and herein referred to as Choi, defines a media application format that enables omnidirectional media applications. Choi et al., ISO/IEC JTC1/SC29/WG11 W16950, “Study of ISO/IEC DIS 23000-20 Omnidirectional Media Format,” July 2017, Torino, IT, which is incorporated by reference and herein referred to as Choi_1, defines a media format that enables omnidirectional media applications. Choi specifies a list of projection techniques that can be used for conversion of a spherical or 360 degree video into a two-dimensional rectangular video; how to store omnidirectional media and the associated metadata using the International Organization for Standardization (ISO) base media file format (ISOBMFF); how to encapsulate, signal, and stream omnidirectional media using dynamic adaptive streaming over Hypertext Transfer Protocol (HTTP) (DASH); and which video and audio coding standards, as well as media coding configurations, may be used for compression and playback of the omnidirectional media signal.

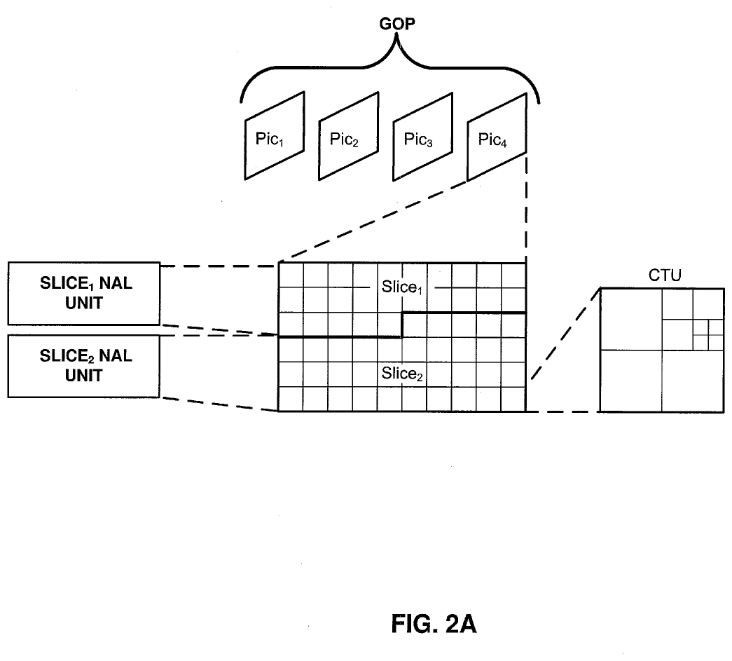

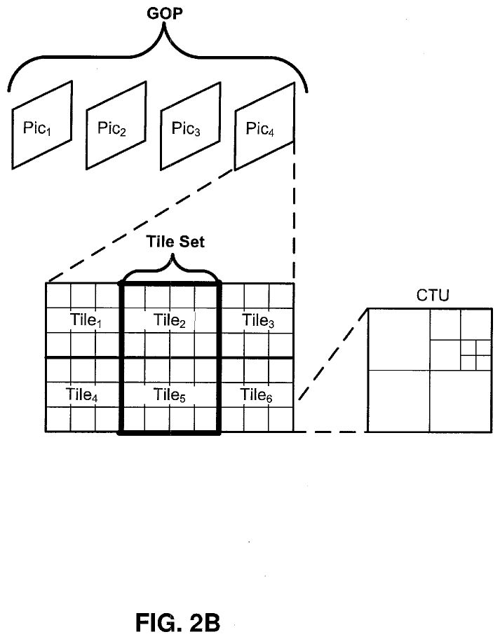

Choi provides where video is coded according to ITU-T H.265. ITU-T H.265 is described in High Efficiency Video Coding (HEVC), Rec. ITU-T H.265 December 2016, which is incorporated by reference, and referred to herein as ITU-T H.265. As described above, according to ITU-T H.265, each video frame or picture may be partitioned to include one or more slices and further partitioned to include one or more tiles. FIGS. 2A-2B are conceptual diagrams illustrating an example of a group of pictures including slices and further partitioning pictures into tiles. In the example illustrated in FIG. 2A, Pic₄ is illustrated as including two slices (i.e., Slice₁ and Slice₂) where each slice includes a sequence of CTUs (e.g., in raster scan order). In the example illustrated in FIG. 2B, Pic₄ is illustrated as including six tiles (i.e., Tile₁ to Tile₆), where each tile is rectangular and includes a sequence of CTUs. It should be noted that in ITU-T H.265, a tile may consist of coding tree units contained in more than one slice and a slice may consist of coding tree units contained in more than one tile. However, ITU-T H.265 provides that one or both of the following conditions shall be fulfilled: (1) All coding tree units in a slice belong to the same tile; and (2) All coding tree units in a tile belong to the same slice. Thus, with respect to FIG. 2B, each of the tiles may belong to a respective slice (e.g., Tile₁ to Tile₆ may respectively belong to slices, Slice₁ to Slice₆) or multiple tiles may belong to a slice (e.g., Tile₁ to Tile₃ may belong to Slice₁ and Tile₄ to Tile₆ may belong to Slice₂).

Further, as illustrated in FIG. 2B, tiles may form tile sets (i.e., Tile₂ and Tile₅ form a tile set). Tile sets may be used to define boundaries for coding dependencies (e.g., intra-prediction dependencies, entropy encoding dependencies, etc.) and as such, may enable parallelism in coding. For example, if the video sequence in the example illustrated in FIG. 2B corresponds to a nightly news program, the tile set formed by Tile₂ and Tile₅ may correspond to a visual region including a news anchor reading the news. ITU-T H.265 defines signaling that enables motion-constrained tile sets (MCTS). A motion-constrained tile set may include a tile set for which inter-picture prediction dependencies are limited to the collocated tile sets in reference pictures. Thus, it is possible to perform motion compensation for a given MCTS independent of the decoding of other tile sets outside the MCTS. For example, referring to FIG. 2B, if the tile set formed by Tile₂ and Tile₅ is a MCTS and each of Pic₁ to Pic₃ include collocated tile sets, motion compensation may be performed on Tile₂ and Tile₅ independent of coding Tile₁, Tile₃, Tile₄, and Tile₆ in Picₒ and tiles collocated with tiles Tile₁, Tile₃, Tile₄, and Tile₆ in each of Picₜ to Picₐ. Coding video data according to MCTS may be useful for video applications including omnidirectional video presentations.

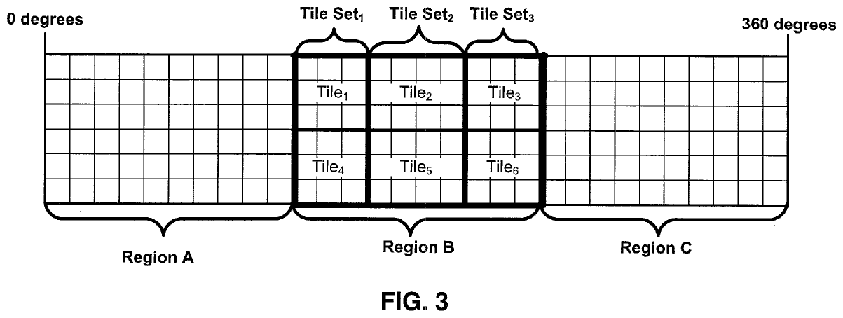

As illustrated in FIG. 3, tiles (i.e., Tile₁ to Tile₆) may form a region of an omnidirectional video. Further, the tile set formed by Tile₂ and Tile₅ may be a MCTS included within the region. Viewport dependent video coding, which may also be referred to as viewport dependent partial video coding, may be used to enable coding of only part of an entire video region. That is, for example, view port dependent video coding may be used to provide sufficient information for rendering of a current FOV. For example, omnidirectional video may be coded using MCTS, such that each potential region covering a viewport can be independently coded from other regions across time. In this case, for example, for a particular current viewport, a minimum set of tiles that cover a viewport may be sent to the client, decoded, and/or rendered. That is, tile tracks may be formed from a motion-constrained tile set sequence.

Referring again to FIG. 3, as illustrated in FIG. 3, the 360 degree video includes Region A, Region B, and Region C. In the example illustrated in FIG. 3, each of the regions are illustrated as including CTUs. As described above, CTUs may form slices of coded video data and/or tiles of video data. Further, as described above, video coding techniques may code areas of a picture according to video blocks, sub-divisions thereof, and/or corresponding structures and it should be noted that video coding techniques enable video coding parameters to be adjusted at various levels of a video coding structure, e.g., adjusted for slices, tiles, video blocks, and/or at sub-divisions. Referring again to FIG. 3, in one example, the 360 degree video illustrated in FIG. 3 may represent a sporting event where Region A and Region C include views of the stands of a stadium and Regions B includes a view of the playing field (e.g., the video is captured by a 360 degree camera placed at the 50-yard line).

It should be noted that regions of omnidirectional video may include regions on a sphere. As described in further detail below, Choi describes where a region on a sphere may be specified by four great circles, where a great circle (also referred to as a Riemannian circle) is an intersection of the sphere and a plane that passes through the center point of the sphere, where the center of the sphere and the center of a great circle are co-located. Choi further describes where a region on a sphere may be specified by two yaw circles and two pitch circles, where a yaw circle is a circle on the sphere connecting all points with the same yaw value, and pitch circle is a circle on the sphere connecting all points with the same pitch value.

As described above, Choi specifies a list of projection techniques that can be used for conversion of a spherical or 360 degree video into a two-dimensional rectangular video. Choi specifies where a projected frame is a frame that has a representation format by a 360 degree video projection indicator and where a projection is the process by which a set of input images are projected onto a projected frame. Further, Choi specifies where a projection structure includes a three-dimensional structure including one or more surfaces on which the captured image/video content is projected, and from which a respective projected frame can be formed. Finally, Choi provides where a region-wise packing includes a region-wise transformation, resizing, and relocating of a projected frame and where a packed frame is a frame that results from region-wise packing of a projected frame. Thus, in Choi, the process for creating 360 degree spherical video may be described as including image stitching, projection, and region-wise packing. It should be noted that Choi specifies a coordinate system, omnidirectional projection formats, including an equirectangular projection, a rectangular region-wise packing format, and an omnidirectional fisheye video format, for the sake of brevity, a complete description of these sections of Choi is not provided herein. However, reference is made to the relevant sections of Choi.

With respect to projection structure and coordinate system, Choi provides where the projection structure is a unit sphere, the coordinate system can be used for example to indicate the orientation of the projection structure or a spherical location of a point, and the coordinate axes used for defining yaw (Φ), pitch (θ), and roll angles, where yaw rotates around the Y (vertical, up) axis, pitch around the x (lateral, side-to-side) axis, and roll around the Z (back-to-front) axis. Further, Choi provides where rotations are extrinsic, i.e., around the X, Y, and Z fixed reference axes and the angles increase clockwise when looking from the origin towards the positive end of an axis. Choi further provides the following definitions for a projection structure and coordinate system in Clause 5.1:

YawAngle indicates the rotation angle around the Y axis, in degrees.
Type: floating point decimal values
Range: in the range of −180, inclusive, to 180, exclusive
PitchAngle indicates the rotation angle around the X axis, in degrees.
Type: floating point decimal values
Range: in the range of −90, inclusive, to 90, inclusive
RollAngle indicates the rotation angle around the Z axis, in degrees.
Type: floating point decimal values
Range: in the range of −180, inclusive, to 180, exclusive.

With respect an equirectangular projection format, Choi provides the following in Clause 5.2:
Equirectangular projection for one sample

Inputs to this clause are:
pictureWidth and pictureHeight, which are the width and height, respectively, of the equirectangular panorama picture in samples, and
the center point of a sample location (i, j) along horizontal and vertical axes, respectively.

Outputs of this clause are:
angular coordinates (Φ, θ) for the sample in degrees relative to the coordinate axes specified in [Clause 5.1 Projection structure and coordinate system of Choi].

The angular coordinates (Φ, θ) for the luma sample location, in degrees, are given by the following equirectangular mapping equations:

Φ=(i÷pictureWidth−0.5)*360

θ=(0.5−j÷pictureHeight)*180

With respect to conversion between spherical coordinate systems of different orientations, Choi provides the following in Clause 5.3:

Conversion between spherical coordinate systems of different orientations

Inputs to this clause are:
orientation change yaw_center (in the range of −180, inclusive, to 180, exclusive), pitch_center (in the range of −90, inclusive, to 90, inclusive), roll_center (in the range of −180, inclusive, to 180, exclusive), all in units of degrees, and
angular coordinates (Φ, θ) relative to the coordinate axes that have been rotated as specified in [Clause 5.1 Projection structure and coordinate system of Choi], and

Outputs of this clause are:
angular coordinates (Φ′, θ′) relative to the coordinate system specified in [Clause 5.1 Projection structure and coordinate system of Choi]

The outputs are derived as follows:

α=(Clip_{yaw}(ϕ+yaw_center))*π÷180

β=(clip_{pitch}(θ+pitch_center))*π÷180

ω=roll_center*÷180

ϕ′=(Cos(ω)*α−Sin(ω)*β)*180÷π

θ′=(Sin(ω)*α+Cos(ω)*β)*180÷π

With respect to conversion of sample locations for rectangular region-wise packing, Choi provides the following in Clause 5.4:

Conversion of sample locations for rectangular region-wise packing

Inputs to this clause are:
sample location (x, y) within the packed region in integer sample units,
the width and the height of the projected region in sample units (projRegWidth, projRegHeight),
the width and the height of the packed region in sample units (packedRegWidth, packedRegHeight),
transform type (transformType), and
offset values for sampling position (offsetX, offsetY).

Outputs of this clause are:
the center point of the sample location (i, j) within the projected region in sample units.

The outputs are derived as follows:

```
if( transformType = =0 | | transformType = =1 | |
transformType = =2 | | transformType = = 3 ) {
  horRatio = projRegWidth ÷ packedRegWidth
  verRatio = projRegHeight ÷ packedRegHeight
} else if ( transformType = = 4 | | transformType = = 5 | |
  transformType = = 6 | | transformType = = 7 ) {
  horRatio = projRegWidth ÷ packedRegHeight
  verRatio = projRegHeight ÷ packedRegWidth
}
if( transformType = = 0 ) {
  i = horRatio * ( x + offsetX )
  j = verRatio * ( y + offsetY )
} else if ( transformType = = 1 ) {
  i = horRatio * ( packedRegWidth − x − offsetX )
  j = verRatio * ( y + offsetY )
}else if ( transformType = = 2 ) {
  i = horRatio * ( packedRegWidth − x − offsetX )
  j = verRatio * ( packedRegHeight − y − offsetY )
} else if ( transformType = = 3 ) {
  i = horRatio * ( x + offsetX )
  j = verRatio * ( packedRegHeight − y − offsetY )
} else if ( transformType = = 4 ) {
  i = horRatio * ( y + offsetY )
  j = verRatio * ( x + offsetX )
} else if ( transformType = = 5 ) {
  i = horRatio * ( y + offsetY )
  j = verRatio * ( packedRegWidth − x − offsetX )
} else if ( transformType = = 6 ) {
  i = horRatio * ( packedRegHeight − y − offsetY )
  j = verRatio * ( packedRegWidth − x − offsetX )
} else if ( transformType = = 7 ) {
  i = horRatio * ( packedRegHeight − y − offsetY )
  j = verRatio * ( x+ offsetX )
}
```

With respect to projection structure and coordinate system, Choi_1 provides where the projection structure is a unit sphere, the coordinate system can be used for defining the sphere coordinates azimuth (ψ) and elevation (θ) and for identifying a location of a point on the unit sphere, as well as the rotation angles yaw (α), pitch (β), and roll (γ), where yaw rotates around the Z (vertical, up) axis, pitch around the Y (lateral, side-to-side) axis, and roll around the X (back-to-front) axis. Further, Choi_1 provides where rotations are extrinsic, i.e., around the X, Y, and Z fixed reference axes and the angles increase clockwise when looking from the origin towards the positive end of an axis. Choi_1 provides where the value ranges of azimuth, yaw, and roll are all −180.0, inclusive, to 180.0, exclusive, degrees. The value range of elevation and pitch are both −90.0 to 90.0, inclusive, degrees. Further, Choi_1 provides where in rendering, the local coordinate axes may be converted to the global coordinate axes by applying the following ordered sequence of X-Y-Z of extrinsic rotations:

The XYZ rotates around the X axis by roll.

The XYZ rotates around the Y axis by pitch.

The XYZ rotates around the Z axis by yaw.

With respect to an omnidirectional projection for one sample location, Choi_1 specifies an equirectangular projection and a cubemap projection. With respect an equirectangular projection format, Choi_1 provides the following in Clause 5.2.1:

Equirectangular projection for one sample location

Inputs to this clause are:
pictureWidth and pictureHeight, which are the width and height, respectively, of a monoscopic projected luma picture, in luma samples, and
the center point of a sample location (i, j) along horizontal and vertical axes, respectively.

Outputs of this clause are:
sphere coordinates (Φ, θ) for the sample location in degrees relative to the coordinate axes specified in [Clause 5.1 Projection structure and coordinate system of Choi_1].

The sphere coordinates (Φ, θ) for the luma sample location, in degrees, are given by the following equations:

Φ=(i÷pictureWidth−0.5)*360

θ=(0.5−j÷pictureHeight)*180

With respect a cubemap projection format, Choi_1 provides the following in Clause 5.2.2:

Inputs to this clause are:
pictureWidth and pictureHeight, which are the width and height, respectively, of a monoscopic projected luma picture, in luma samples, and
the center point of a sample location (i, j) along the horizontal and vertical axes, respectively.

Outputs of this clause are:
sphere coordinates (Φ, θ) for the sample location in degrees relative to the coordinate axes specified in [Clause 5.1 Projection structure and coordinate system of Choi_1, described above].

The sphere coordinates (Φ, θ) for the luma sample location, in degrees, are given by the following equations:

```
lw = pictureWdith ÷ 3
lh = pictureHeight ÷ 2
i′ = −(2 * (i % lw) ÷ lw) + 1
j′ = −(2 * (j % lh) ÷ lh) + 1
w = Floor( i/lw)
h = Floor( j/lh)
if(w = = 1 && h = = 0) {//front face
  x = 1.0
  y = −i′
  z = j′
}else if(w = = 1 && h = = 1) {//back face
  x = −1.0
  y = j′
  z = −i′
}else if(w = = 2 && h = = 1) {//top face
  x = −i′
  y = j′
  z = 1.0
}else if(w = = 0 && h = = 1) {//bottom face
  x = i′
  y = j′
  z = −1.0′
}else if(w = = 0 && h = = 0) {//right face
  x = −i′
  y = −1.0
  z = j′
}else {//(w = = 2 && h = = 0), left face
  x = i′
  y = 1.0
  z = j′
}
$φ = atan 2 ( y , x ) \times \frac{180 °}{π}$
$θ = {sin}^{- 1} ( z \div {( {x}^{2} + {y}^{2} + {z}^{2} )}^{1 / 2} ) \times \frac{180 °}{π}$
```

With respect to conversion from the local coordinate axes to the global coordinate axes, Choi_1 provides the following in Clause 5.3:

Conversion between spherical coordinate systems of different orientations

Inputs to this clause are:
rotation_yaw (α), rotation_pitch (β), rotation_roll (γ), all in units of degrees, and
sphere coordinates (Φ, θ) relative to the local coordinate axes.

Outputs of this clause are:
sphere coordinates (Φ′, θ′) relative to the global coordinate axes.

The outputs are derived as follows:

$${x}_{1} = cos φcosθ$$

$${y}_{1} = sin φcosθ$$

$${z}_{1} = sin θ \\ [ \begin{matrix}{x}_{2} \\ {y}_{2} \\ {z}_{2}\end{matrix} ] = [ \begin{matrix}cos βcosγ & - cos βsiinγ & sin β \\ \begin{matrix}cos αsinγ + \\ sin αsinβcosγ\end{matrix} & \begin{matrix}cos αcosγ - \\ sin αsinβsinγ\end{matrix} & - sin αcosβ \\ \begin{matrix}sin αsinγ - \\ cos αsinβcosγ\end{matrix} & \begin{matrix}sin αcosγ + \\ cos αsinβsinγ\end{matrix} & cos αcosβ\end{matrix} ] [ \begin{matrix}{x}_{1} \\ {y}_{1} \\ {z}_{1}\end{matrix} ]$$

$${φ}^{′} = atan 2 ( {y}_{2} , {x}_{2} ) \times \frac{180 °}{π}$$

$${θ}^{′} = {sin}^{- 1} {z}_{2} \times \frac{180 °}{π}$$

With respect to conversion of sample locations for rectangular region-wise packing, Choi_1 provides the following in Clause 5.4:

Conversion of sample locations for rectangular region-wise packing

Inputs to this clause are:
sample location (x, y) within the packed region in integer sample units,
the width and the height of the projected region in sample units (projRegWidth, projRegHeight),
the width and the height of the packed region in sample units (packedRegWidth, packedRegHeight),
transform type (transformType), and
offset values for sampling position (offsetX, offsetY).

Outputs of this clause are:
the center point of the sample location (i, j) within the projected region in sample units.

The outputs are derived as follows:

```
if( transformType = = 0 | | transformType = = 1 | |
transformType = = 2 | | transformType = = 3 ) {
  horRatio = projRegWidth ÷ packedRegWidth
  verRatio = projRegHeight ÷ packedRegHeight
} else if ( transformType = = 4 | | transformType = = 5 | |
  transformType = = 6 | | transformType = = 7 ) {
  horRatio = projRegWidth ÷ packedRegHeight
  verRatio = projRegHeight ÷ packedRegWidth
}
if( transformType = = 0 ) {
  i = horRatio * ( x + offsetX )
  j = verRatio * ( y + offsetY )
} else if ( transformType = = 1 ) {
  i = horRatio * ( packedRegWidth − x − offsetX )
  j = verRatio * ( y + offsetY )
} else if ( transformType = = 2 ) {
  i = horRatio * ( packedRegWidth − x − offsetX )
  j = verRatio * ( packedRegHeight − y − offsetY )
} else if ( transformType = = 3 ) {
  i = horRatio * ( x + offsetX )
  j = verRatio * ( packedRegHeight − y − offsetY )
} else if ( transformType = = 4 ) {
  i = horRatio * ( y + offsetY )
  j = verRatio * ( x + offsetX )
} else if ( transformType = = 5 ) {
  i = horRatio * ( y + offsetY )
  j = verRatio * ( packedRegWidth − x − offsetX )
} else if ( transformType = = 6 ) {
  i = horRatio * ( packedRegHeight − y − offsetY )
  j = verRatio * ( packedRegWidth − x − offsetX )
} else if ( transformType = = 7 ) {
  i = horRatio * ( packedRegHeight − y − offsetY )
  j = verRatio * ( x+ offsetX )
}
```

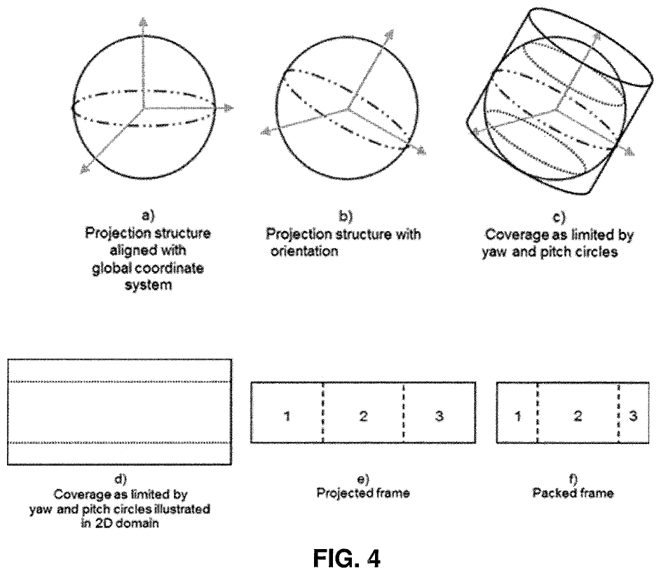

FIG. 4 illustrates conversions from a spherical projection structure to a packed picture that can be used in content authoring and the corresponding conversions from a packed picture to a spherical projection structure that can be used in content rendering. It should be noted that the example illustrated in FIG. 4 is based on an informative example provided in Choi. However, the example illustrated in FIG. 4 may be generally applicable and should not be construed to limit the scope of techniques for mapping sample locations to angular coordinates described herein. Further, it should be noted that Choi_1 provides an informative example for conversions from a spherical projection structure to a packed picture that can be used in content authoring and the corresponding conversions from a packed picture to a spherical projection structure that can be used in content rendering. However, for the sake of brevity the illustrative example in Choi_1 is not repeated here, reference is made to Claus 7.2 of Choi_1 for details of the illustrative example.

In the example illustrated in FIG. 4, the projection structure is along a global coordinate axes as illustrated in (a), when the equator of the equirectangular panorama picture is aligned with the X axis of the global coordinate axes, the Y axis of the equirectangular panorama picture is aligned with the Y axis of the global coordinate axes, and the Z axis of the global coordinate axes passes through the middle point of the equirectangular panorama picture.

According to the example illustrated in FIG. 4, content authoring may include one or more the following: rotating a projection structure relative to the global coordinate axes, as illustrated in (b); indicating the coverage as an area enclosed by two yaw circles and two pitch circles, where the yaw and pitch circles may be indicted relative the local coordinate axes; determining a projection picture (or frame); and obtaining a packed picture from a projection picture (e.g., by applying region-wise packing). It should be noted that in the example illustrated in FIG. 4, (c) illustrates an example coverage that is constrained only by two pitch circles while yaw values are not constrained. Further, it should be noted that on a 2D equirectangular domain, the coverage corresponds to a rectangle (i.e., (d) in FIG. 4 indicates the 2D correspondence of (c)), where the X and Y axes of the 2D representation may be aligned with the X and Y local coordinate axes of the projection structure. Further, the projected picture may include a portion of the coverage. In the example illustrated in FIG. 4, the projected picture in (e) includes a portion of the coverage illustrated in (d), which may be specified using horizontal and vertical range values. In the example illustrated in FIG. 4, in (f) the side regions are horizontally down sampled, while the middle region is kept at its original resolution. Further, with respect to FIG. 4, it should be noted that in order to map a sample location of a packed picture to a projection structure used in rendering, a computing device may perform sequential mappings in reverse order from (f) to (a). That is, a video decoding device may map the luma sample locations within a decoded picture to angular coordinates relative to global coordinate axes.

It should be noted that in Choi, if region-wise packing is not applied, the packed frame is identical to the projected frame. Otherwise, regions of the projected frame are mapped onto a packed frame by indicating the location, shape, and size of each region in the packed frame. Further, in Choi, in the case of stereoscopic 360 degree video, the input images of one time instance are stitched to generate a projected frame representing two views, one for each eye. Both views can be mapped onto the same packed frame and encoded by a traditional two-dimensional video encoder. Alternatively, Choi provides, where each view of the projected frame can be mapped to its own packed frame, in which case the image stitching, projection, and region-wise packing is similar to the monoscopic case described above. Further, in Choi, a sequence of packed frames of either the left view or the right view can be independently coded or, when using a multiview video encoder, predicted from the other view. Finally, it should be noted that in Choi, the image stitching, projection, and region-wise packing process can be carried out multiple times for the same source images to create different versions of the same content, e.g. for different orientations of the projection structure and similarly, the region-wise packing process can be performed multiple times from the same projected frame to create more than one sequence of packed frames to be encoded.

As described above, Choi specifies how to store omnidirectional media and the associated metadata using the International Organization for Standardization (ISO) base media file format (ISOBMFF). Choi specifies where a file format that generally supports the following types of metadata: (1) metadata specifying the projection format of the projected frame; (2) metadata specifying the area of the spherical surface covered by the projected frame; (3) metadata specifying the orientation of the projection structure corresponding to the projected frame in a global coordinate system; (4) metadata specifying region-wise packing information; and (5) metadata specifying optional region-wise quality ranking.

It should be noted that with respect to the equations used herein, the following arithmetic operators may be used:
+ Addition
− Subtraction (as a two-argument operator) or negation (as a unary prefix operator)
* Multiplication, including matrix multiplication
x^{y} Exponentiation. Specifies x to the power of y. In other contexts, such notation is used for superscripting not intended for interpretation as exponentiation.
/ Integer division with truncation of the result toward zero. For example, 7/4 and −7/−4 are truncated to 1 and −7/4 and 7/−4 are truncated to −1.
÷ Used to denote division in mathematical equations where no truncation or rounding is intended.

$$\frac{x}{y}$$

Used to denote division in mathematical equations where no truncation or rounding is intended.
x % y Modulus. Remainder of x divided by y, defined only for integers x and y with x>=0 and y>0.
cos(x) The trigonometric cosine function operating on an argument x in units of degrees
sin(x) The trigonometric sine function operating on an argument x in units of degrees
sin⁻¹(x) The trigonometric arcsine function (inverse sine function) operating on an argument x,

x={x|x is any real number,−1≤x≤1}
tan⁻¹(x) The trigonometric arctangent function (invers tangent function) operating on an argument x,

x={x|x is any real number,−∞≤x≤∞}

a tan 2(y,x) The arctangent function with two arguments operating on arguments both y and x. y and x cannot be zero at the same time. The a tan 2 function is defined as:

$$atan 2 ( y , x ) = \{ \begin{matrix}{tan}^{- 1} ( \frac{y}{x} ) , & if x > 0 \\ {tan}^{- 1} ( \frac{y}{x} ) + π , & if x < 0 , y \geq 0 \\ {tan}^{- 1} ( \frac{y}{x} ) - π , & if x < 0 , y < 0 \\ \frac{π}{2} , & if x = 0 , y > 0 \\ - \frac{π}{2} , & if x = 0 , y < 0 \\ 0 , & if x = 0 and y = 0\end{matrix}$$

It should be noted that with respect to the equations used herein, the following logical operators may be used:
x && y Boolean logical “and” of x and y
x∥y Boolean logical “or” of x and y
! Boolean logical “not”
x ? y:z If x is TRUE or not equal to 0, evaluates to the value of y; otherwise, evaluates to the value of z.

It should be noted that with respect to the equations used herein, the following relational operators may be used:
> Greater than
>= Greater than or equal to
< Less than
<= Less than or equal to
== Equal to
!= Not equal to

It should be noted in the syntax used herein, unsigned int(n) refers to an unsigned integer having n-bits. Further, bit(n) refers to a bit value having n-bits.

As described above, Choi specifies how to store omnidirectional media and the associated metadata using the International Organization for Standardization (ISO) base media file format (ISOBMFF). As described above, tile tracks may be formed from a motion-constrained tile set sequence. Choi specifies sub-picture composition track grouping. With respect to a track group type box, Choi provides the following definition, syntax, and semantics in clause 7.1.1:

Definition

TrackGroupTypeBox with track_group_type equal to ‘spco’ indicates that this track belongs to a composition of tracks that can be spatially arranged to obtain composition pictures. The visual tracks mapped to this grouping (i.e. the visual tracks that have the same value of track_group_id within TrackGroupTypeBox with track_group_type equal to ‘spco’) collectively represent visual content that can be presented. Each individual visual track mapped to this grouping may or may not be intended to be presented alone without other visual tracks, while composition pictures are suitable to be presented.

NOTE 1: Content authors can use CompositionRestrictionBox, as specified in clause 7.1.2 [of Choi], to indicate that a visual track alone is not intended to be presented alone without other visual tracks.

NOTE 2: When an HEVC video bitstream is carried in a set of tile tracks and the associated tile base track, as specified in ISO/IEC 14496-15 [ISO/IEC 14496-15:2017 “Information technology—Coding of audio-visual objects—Part 15: Carriage of network abstraction layer (NAL) unit structured video in the ISO base media file format, which is incorporated by reference], and the bitstream represents a sub-picture indicated by a sub-picture composition track group, only the tile base track contains the SubPictureCompositionBox.

A composition picture can be derived by spatially arranging the decoding outputs of the time-parallel samples of all tracks of the same sub-picture composition track group as indicated by the syntax elements of the track group.

Syntax

```
aligned(8) class SubPictureCompositionBox extends
TrackGroupTypeBox(‘spco’) {
  unsigned int(16) track_x;
  unsigned int(16) track_y;
  unsigned int(16) track_width;
  unsigned int(16) track_height;
  unsigned int(16) composition_width;
  unsigned int(16) composition_height;
}
```

Semantics

track_x specifies, in luma sample units, the horizontal position of the top-left corner of the samples of this track on the composition picture. The value of track_x shall be in the range of 0 to composition_width−1, inclusive.

track_y specifies, in luma sample units, the vertical position of the top-left corner of the samples of this track on the composition picture. The value of track_y shall be in the range of 0 to composition_height−1, inclusive.

track_width specifies, in luma sample units, the width of the samples of this track on the composition picture. The value of track_width shall be in the range of 1 to composition_width−1, inclusive.

track_height specifies, in luma sample units, the height of the samples of this track on the composition picture. The value of track_height shall be in the range of 1 to composition_height−1, inclusive.

composition_width specifies, in luma sample units, the width of the composition picture.

composition_height specifies, in luma sample units, the height of the composition picture.

For each value of i in the range of 0 to track_width−1, inclusive, the i-th column of luma samples of the samples of this track is the colComposedPic-th column of luma samples of the composition picture, where colComposedPic is equal to (i+track_x) % composition_width.

For each value of j in the range of 0 to track_height−1, inclusive, the j-th row of luma samples of the samples of this track is the rowComposedPic-th row of luma samples of the composition picture, where rowComposedPic is equal to (j+track_y) % composition_height.

With respect to a composition restriction box, Choi provides the following definition and syntax:

Definition

Box Type: ‘core’

Container: VisualSampleEntry

Mandatory: No

Quantity: Zero or one

The presence of this box indicates that the track is not intended to be presented alone without other visual tracks. When this box is not present, the track may or may not be intended to be presented alone without other visual tracks.

Syntax

aligned(8) class CompositionRestrictionBox extends FullBox(‘core’,
version, flags)
{
}

With respect to a timed metadata tracks Choi provides the following in clause 7.1.3:

When a timed metadata track is linked to one or more media tracks with a ‘cdsc’ track reference, it describes each media track individually.

When a timed metadata track is linked to several media tracks with a ‘cdtg’ track reference, the media tracks shall belong to the same track group and the track reference describes the track group collectively.

When a timed metadata track is linked to several media tracks with a ‘cdtg’ track reference and the media tracks belong to the same sub-picture composition track group, which is identified by the track grouping type ‘spco’, the ‘cdtg’ track reference shall refer to all the tracks belonging to the same sub-picture composition track group, and the timed metadata track describes the composition pictures, derived as specified in clause 7.1.1 [of Choi].

NOTE: When a timed metadata is used to describe an HEVC video bitstream carried in a set of tile tracks and the associated tile base track, as specified in ISO/IEC 14496-15, only the tile base track is the referenced media track.

Further, Choi specifies where the file format supports the following types of boxes: a scheme type box (SchemeTypeBox), a scheme information box (SchemeInformationBox), a projected omnidirectional video box (ProjectedOmnidirectionalVideoBox), a stereo video box (StereoVideoBox), a fisheye omnidirectional video box (FisheyeOmnidirectionalVideoBox), a region-wise packing box (RegionWisePackingBox), and a projection orientation box (ProjectionOrientationBox). It should be noted that Choi specifies additional types boxes, for the sake of brevity, a complete description of all the type of boxes specified in Choi are not described herein. With respect to SchemeTypeBox, SchemeInformationBox, ProjectedOmnidirectionalVideoBox, StereoVideoBox, and RegionWisePackingBox, Choi provides the following:
The use of the projected omnidirectional video scheme for the restricted video sample entry type ‘resv’ indicates that the decoded pictures are packed pictures containing either monoscopic or stereoscopic content. The use of the projected omnidirectional video scheme is indicated by scheme_type equal to ‘podv’ (projected omnidirectional video) within the SchemeTypeBox.
The use of the fisheye omnidirectional video scheme for the restricted video sample entry type ‘resv’ indicates that the decoded pictures are fisheye video pictures. The use of the fisheye omnidirectional video scheme is indicated by scheme_type equal to ‘fodv’ (fisheye omnidirectional video) within the SchemeTypeBox.
The format of the projected monoscopic pictures is indicated with the ProjectedOmnidirectionalVideoBox contained within the SchemeInformationBox. The format of fisheye video is indicated with the FisheyeOmnidirectionalVideoBox contained within the SchemeInformationBox. One and only one ProjectedOmnidirectionalVideoBox shall be present in the SchemeInformationBox when the scheme type is ‘podv’. One and only one FisheyeOmnidirectionalVideoBox shall be present in the SchemeInformationBox when the scheme type is ‘fodv’.
When the ProjectedOmnidirectionalVideoBox is present in the SchemeInformationBox, StereoVideoBox and RegionWisePackingBox may be present in the same SchemeInformationBox. When FisheyeOmnidirectionalVideoBox is present in the SchemeInformationBox, StereoVideoBox and RegionWisePackingBox shall not be present in the same SchemeInformationBox.
For stereoscopic video, the frame packing arrangement of the projected left and right pictures is indicated with the StereoVideoBox contained within the SchemeInformationBox. The absence of StereoVideoBox indicates that the omnidirectionally projected content of the track is monoscopic. When StereoVideoBox is present in the SchemeInformationBox for the omnidirectional video scheme, stereo_scheme shall be equal to 4 and stereo_indication_type shall indicate that either the top-bottom frame packing or the side-by-side frame packing is in use and that quincunx sampling is not in use.
Optional region-wise packing is indicated with the RegionWisePackingBox contained within the SchemeInformationBox. The absence of RegionWisePackingBox indicates that no region-wise packing is applied, i.e., that the packed picture is identical to the projected picture.

With respect to the projected omnidirectional video box, Choi provides the following definition, syntax and semantics:

Definition

Box Type: ‘povd’

Container: Scheme Information box (‘schi’)

Mandatory: Yes, when scheme_type is equal to ‘podv’

Quantity: Zero or one

The properties of the projected frames are indicated with the following:
the projection format of a monoscopic projected frame (C for monoscopic video contained in the track, C_{L} and C_{R} for left and right view of stereoscopic video);
the orientation of the projection structure relative to the global coordinate system; and
the spherical coverage of the projected omnidirectional video.

Syntax

```
aligned(8) class ProjectedOmnidirectionalVideoBox extends
Box(‘povd’) {
  ProjectionFormatBox( ); // mandatory
  // optional boxes
}
aligned(8) class ProjectionFormatBox( ) extends
FullBox(‘prfr’, 0, 0) {
  ProjectionFormatStruct( );
}
aligned(8) class ProjectionFormatStruct( ) {
  bit(3) reserved = 0;
  unsigned int(5) projection_type;
}
```

Semantics

projection_type indicates the particular mapping of the rectangular decoder picture output samples onto the spherical coordinate system specified in [Clause 5.1 Projection structure and coordinate system of Choi]. projection_type equal to 0 indicates the equirectangular projection as specified in [Clause 5.2 Omnidirectional projection formats of Choi] Other values of projection_type are reserved.

With respect to the Region-wise packing box, Choi provides the following definition, syntax, and semantics:

Definition

Box Type: ‘rwpk’

Container: Scheme Information box (‘schi’)

Mandatory: No

Quantity: Zero or one

RegionWisePackingBox indicates that projected frames are packed region-wise and require unpacking prior to rendering. The size of the projected picture is explicitly signalled in this box. The size of the packed picture is indicated by the width and height syntax elements of VisualSampleEntry, denoted as PackedPicWidth and PackedPicHeight, respectively.

NOTE 1: When the pictures are field pictures instead of frame pictures, the actual height of the packed pictures would be only half of PackedPicHeight.

Syntax

```
aligned(8) class RegionWisePackingBox extends
FullBox(‘rwpk’, 0, 0) {
  RegionWisePackingStruct( );
}
aligned(8) class Region WisePackingStruct {
  unsigned int(8) num_regions;
  unsigned int(16) proj_picture_width;
  unsigned int(16) proj_picture_height;
  for (i = 0; i < num_regions; i++) {
    bit(3) reserved = 0;
    unsigned int(1) guard_band_flag[i];
    unsigned int(4) packing_type[i];
    if (packing_type[i] == 0) {
      RectRegionPacking(i);
      if (guard_band_flag[i]) {
        unsigned int(8) left_gb_width[i];
        unsigned int(8) right_gb_width[i];
        unsigned int(8) top_gb_height[i];
        unsigned int(8) bottom_gb_height[i];
        unsigned int(1) gb_not_used_for_pred_flag[i];
        unsigned int(3) gb_type[i];
        bit(4) reserved = 0;
      }
    }
  }
}
aligned(8) class RectRegionPacking(i) {
  unsigned int(16) proj_reg_width[i];
  unsigned int(16) proj_reg_height[i];
  unsigned int(16) proj_reg_top[i];
  unsigned int(16) proj_reg_left[i];
  unsigned int(3) transform_type[i];
  bit(5) reserved = 0;
  unsigned int(16) packed_reg_width[i];
  unsigned int(16) packed_reg_height[i];
  unsigned int(16) packed_reg_top[i];
  unsigned int(16) packed_reg_left[i];
}
```

Semantics

num_regions specifies the number of packed regions. Value 0 is reserved.

proj_picture_width and proj_picture_height specify the width and height, respectively, of the projected picture. proj_picture_width and proj_picture_height shall be greater than 0.

guard_band_flag[i] equal to 0 specifies that the i-th packed region does not have a guard band.

guard_band_flag[i] equal to 1 specifies that the i-th packed region has a guard band.

packing_type[i] specifies the type of region-wise packing. packing_type[i] equal to 0 indicates rectangular region-wise packing. Other values are reserved.

left_gb_width[i] specifies the width of the guard band on the left side of the i-th region in units of two luma samples.

right_gb_width[i] specifies the width of the guard band on the right side of the i-th region in units of two luma samples.

top_gb_height[i] specifies the height of the guard band above the i-th region in units of two luma samples.

bottom_gb_height[i] specifies the height of the guard band below the i-th region in units of two luma samples.

When guard_band_flag[i] is equal to 1, left_gb_width[i], right_gb_width[i], top_gb_height[i], or bottom_gb_height[i] shall be greater than 0.

The i-th packed region as specified by this RegionWisePackingStruct shall not overlap with any other packed region specified by the same RegionWisePackingStruct or any guard band specified by the same RegionWisePackingStruct.

The guard bands associated with the i-th packed region, if any, as specified by this RegionWisePackingStruct shall not overlap with any packed region specified by the same RegionWisePackingStruct or any other guard bands specified by the same RegionWisePackingStruct.

gb_not_used_for_pred_flag[i] equal to 0 specifies that the guard bands may or may not be used in the inter prediction process. gb_not_used_for_pred_flag[i] equal to 1 specifies that the sample values of the guard bands are not in the inter prediction process.

NOTE 1: When gb_not_used_for_pred_flag[i] is equal to 1, the sample values within guard bands in decoded pictures can be rewritten even if the decoded pictures were used as references for inter prediction of subsequent pictures to be decoded. For example, the content of a packed region can be seamlessly expanded to its guard band with decoded and re-projected samples of another packed region.

gb_type[i] specifies the type of the guard bands for the i-th packed region as follows:
gb_type[i] equal to 0 specifies that the content of the guard bands in relation to the content of the packed regions is unspecified. gb_type shall not be equal to 0, when gb_not_used_for_pred_flag is equal to 0.
gb_type[i] equal to 1 specifies that the content of the guard bands suffices for interpolation of sub-pixel values within the packed region and less than one pixel outside of the boundary of the packed region.

NOTE 2: gb_type equal to 1 can be used when the boundary samples of a packed region have been copied horizontally or vertically to the guard band.
gb_type[i] equal to 2 specifies that the content of the guard bands represents actual image content at quality that gradually changes from the picture quality of the packed region to that of the spherically adjacent packed region.
gb_type[i] equal to 3 specifies that the content of the guard bands represents actual image content at the picture quality of the packed region.
gb_type[i] values greater than 3 are reserved.

proj_reg_width[i], proj_reg_height[i], proj_reg_top[i] and proj_reg_left[i] are indicated in units of pixels in a projected picture with width and height equal to proj_picture_width and proj_picture_height, respectively.

proj_reg_width[i] specifies the width of the i-th projected region proj_reg_width[i] shall be greater than 0.

proj_reg_height[i] specifies the height of the i-th projected region proj_reg_height[i] shall be greater than 0.

proj_reg_top[i] and proj_reg_left[i] specify the top sample row and the left-most sample column in the projected picture. The values shall be in the range from 0, inclusive, indicating the top-left corner of the projected picture, to proj_picture_height−2, inclusive, and proj_picture_width−2, inclusive, respectively.

proj_reg_width[i] and proj_reg_left[i] shall be constrained such that proj_reg_width[i]+proj_reg_left[i] is less than proj_picture_width.

proj_reg_height[i] and proj_reg_top[i] shall be constrained such that proj_reg_height[i]+proj_reg_top[i] is less than proj_picture_height.

When the projected picture is stereoscopic, proj_reg_width[i], proj_reg_height[i], proj_reg_top[i] and proj_reg_left[i] shall be such that the projected region identified by these fields is within a single constituent picture of the projected picture.

transform_type[i] specifies the rotation and mirroring that has been applied to the i-th projected region to map it to the packed picture before encoding. When transform_type[i] specifies both rotation and mirroring, rotation has been applied after mirroring in the region-wise packing from the projected picture to the packed picture before encoding. The following values are specified and other values are reserved:
0: no transform
1: mirroring horizontally
2: rotation by 180 degrees (counter-clockwise)
3: rotation by 180 degrees (counter-clockwise) after mirroring horizontally
4: rotation by 90 degrees (counter-clockwise) after mirroring horizontally
5: rotation by 90 degrees (counter-clockwise)
6: rotation by 270 degrees (counter-clockwise) after mirroring horizontally
7: rotation by 270 degrees (counter-clockwise)

NOTE 3: [Clause 5.4 Conversion of sample locations for rectangular region-wise packing of Choi] specifies the semantics of transform_type[i] for converting a sample location of a packed region in a packed picture to a sample location of a projected region in a projected picture.

packed_reg_width[i], packed_reg_height[i], packed_reg_top[i], and packed_reg_left[i] specify the width, height, the top sample row, and the left-most sample column, respectively, of the packed region in the packed picture.

The values of packed_reg_width[i], packed_reg_height[i], packed_reg_top[i], and packed_reg_left[i] are constrained as follows:

packed_reg_width[i] and packed_reg_height[i] shall be greater than 0.

packed_reg_top[i] and packed_reg_left[i] shall in the range from 0, inclusive, indicating the top-left corner of the packed picture, to PackedPicHeight−2, inclusive, and PackedPicWidth−2, inclusive, respectively.

The sum of packed_reg_width[i] and packed_reg_left[i] shall be less than PackedPicWidth.

The sum of packed_reg_height[i] and packed_reg_top[i] shall be less than PackedPicHeight.

The rectangle specified by packed_reg_width[i], packed_reg_height[i], packed_reg_top[i], and packed_reg_left[i] shall be non-overlapping with the rectangle specified by packed_reg_width[j], packed_reg_height[j], packed_reg_top[j], and packed_reg_left[j] for any value of j in the range of 0 to i−1, inclusive.

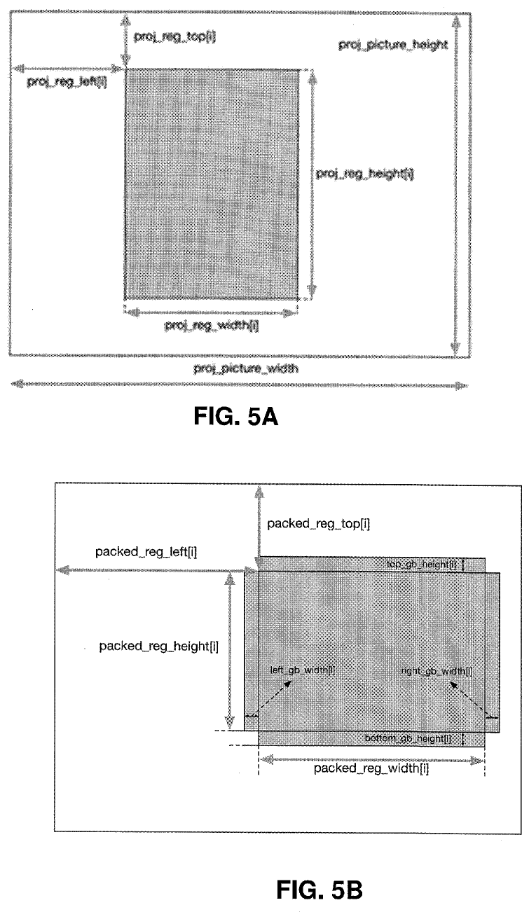

FIG. 5A illustrates the position and size of a projected region within a projected picture and FIG. 5B illustrates that of a packed region within a packed picture with guard bands.

With respect to the Projection orientation box, Choi provides the following definition, syntax, and semantics:

Definition

Box Type: ‘pror’

Container: Projected omnidirectional video box (‘povd’)

Mandatory: No

Quantity: Zero or one

When the projection format is the equirectangular projection, the fields in this box provides the yaw, pitch, and roll angles, respectively, of the center point of the projected picture when projected to the spherical surface. In the case of stereoscopic omnidirectional video, the fields apply to each view individually. When the ProjectionOrientationBox is not present, the fields orientation_yaw, orientation_pitch, and orientation_roll are all considered to be equal to 0.

Syntax

```
aligned(8) class ProjectionOrientationBox extends FullBox(′pror′, version =
0, flags) {
  signed int(32) orientation_yaw;
  signed int(32) orientation_pitch;
  signed int(32) orientation_roll;
}
```

Semantics

orientation_yaw, orientation_pitch, and orientation_roll specify the yaw, pitch, and roll angles, respectively, of the center point of the projected picture when projected to the spherical surface, in units of 2⁻¹⁶ degrees relative to the global coordinate axes. orientation_yaw shall be in the range of −180*2¹⁶ to 180*2¹⁶−1, inclusive. orientation_pitch shall be in the range of −90*2¹⁶ to 90*2¹⁶, inclusive. orientation_roll shall be in the range of −180*2¹⁶ to 180*2¹⁶−1, inclusive.

With respect to the Global coverage information box, Choi provides the following definition, syntax, and semantics:

Definition

Box Type: ‘covi’

Container: Projected omnidirectional video box (‘povd’)

Mandatory: No

Quantity: Zero or one

This box provides information on the area on the sphere covered by the entire content. If this track belongs to a sub-picture composition track group, the entire content refers to the content represented by all tracks belonging to the same sub-picture composition track group, and a composition picture composed from these tracks is referred to as a packed picture of the entire content. Otherwise, the entire content refers to the content represented by this track itself, and the picture of a sample in this track is referred to as a packed picture of the entire content.

GlobalCoverageInformationBox indicates the spherical area covered by the packed pictures of the entire content. The absence of this box indicates that the entire content covers the entire sphere.

The fields in this box are relative to the local coordinate axes, i.e. the coordinate system specified through the ProjectionOrientationBox.

NOTE: In the content authoring process, the semantics of the fields of this box apply after the application of the ProjectionOrientationBox, when present.

Syntax

```
aligned(8) class GlobalCoverageInformationBox extends FullBox(′covi′, version = 0, flags) {
  unsigned int(8) global_coverage_shape_type;
  SphereRegionStruct(1); //[Specified in Clause 7.4.2 Sample Entry of Choi].
}
```

Semantics

global_coverage_shape_type specifies the shape of the sphere region covered by the entire content. global_coverage_shape_type has the same semantics as shape_type specified in [Clause 7.4.2 Sample Entry of Choi].

When SphereRegionStruct(1) is included in the GlobalCoverageInformationBox, the following applies:

center_yaw, center_pitch, and center_roll specify the center point of the sphere region represented by the packed pictures of the entire content, in units of 2⁻¹⁶ degrees, relative to the coordinate system specified through the ProjectionOrientationBox. center_yaw shall be in the range of −180*2¹⁶ to 180*2¹⁶−1, inclusive. center_pitch shall be in the range of −90*2¹⁶ to 90*2¹⁶, inclusive. center_roll shall be in the range of −180*2¹⁶ to 180*2¹⁶−1, inclusive.

hor_range and ver_range specify the horizontal and vertical range, respectively, of the sphere region represented by the packed pictures of the entire content, in units of 2⁻¹⁶ degrees. hor_range and ver_range specify the range through the center point of the sphere region. hor_range shall be in the range of 1 to 720*2¹⁶, inclusive. ver_range shall be in the range of 1 to 180*2¹⁶, inclusive.

interpolate shall be equal to 0.

With respect to timed metadata for sphere Choi provides the following in Clause 7.4.1:

This clause specifies a generic timed metadata track syntax for indicating sphere regions. The purpose for the timed metadata track is indicated by the sample entry type. The sample format of all metadata tracks specified in this clause starts with a common part and may be followed by an extension part that is specific to the sample entry of the metadata track. Each sample specifies a sphere region.

When a sphere region timed metadata track is linked to one or more media tracks with a ‘cdsc’ track reference, it describes each media track individually. When a sphere region timed metadata track is linked to several media tracks with a ‘cdtg’ track reference, each of the media tracks shall have a sample entry type equal to ‘resv’ and scheme_type equal to ‘podv’ in the SchemeTypeBox included in the sample entry.

NOTE: The syntax allows for one sample to specify multiple sphere regions on a sphere. However, there is a semantic restriction that limits the samples to have only one sphere region.

With respect to a sample entry Choi and Choi_1 provide the following definition, syntax, and semantics in Clauses 7.4.2 and 7.5.2, respectively:

Definition

Exactly one SphereRegionConfigBox shall be present in the sample entry. SphereRegionConfigBox specifies the shape of the sphere region specified by the samples. When the horizontal and vertical ranges of the sphere region in the samples do not change, they can be indicated in the sample entry.

Syntax

```
class SphereRegionSampleEntry(type) extends MetaDataSampleEntry
(type) {
  RegionOnSphereSphereRegionConfigBox( ); // mandatory
  Box[ ] other_boxes; // optional
}
class SphereRegionConfigBox extends FullBox(′rosc′, version = 0, flags) {
  unsigned int(8) shape_type;
  bit(7) reserved = 0;
  unsigned int(1) dynamic_range_flag;
  if (dynamic_range_flag == 0) {
    unsigned int(32) static_hor_range;
    unsigned int(32) static_ver_range;
  }
  unsigned int(8) num_regions;
}
```

Semantics

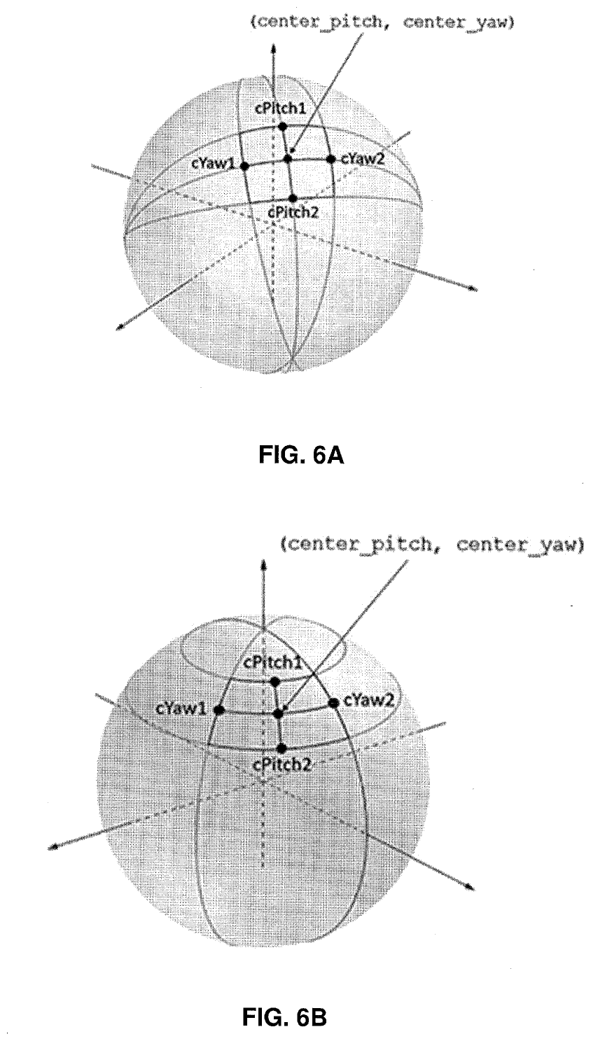

shape_type equal to 0 specifies that the sphere region is specified by four great circles as illustrated in [FIG. 6A].

shape_type equal to 1 specifies that the sphere region is specified by four great circles as illustrated in [FIG. 6B].

shape_type values greater than 1 are reserved.

dynamic_range_flag equal to 0 specifies that the horizontal and vertical ranges of the sphere region remain unchanged in all samples referring to this sample entry. dynamic_range_flag equal to 1 specifies that the horizontal and vertical ranges of the sphere region are indicated in the sample format.

static_hor_range and static_ver_range specify the horizontal and vertical ranges, respectively, of the sphere region for each sample referring to this sample entry in units of 2⁻¹⁶ degrees. static_hor_range and static_ver_rnge specify the ranges through the center point of the sphere region, as illustrated by [FIG. 6A] or [FIG. 6B]. static_hor_range shall be in the range of 0 to 720*2¹⁶, inclusive. static_ver range shall be in the range of 0 to 180*2¹⁶, inclusive. When both static_hor_range and static_ver range are equal to 0, the sphere region for each sample referring to this sample entry is a point on a spherical surface.

num_regions specifies the number of sphere regions in the samples referring to this sample entry. num_regions shall be equal to 1. Other values of num_regions are reserved.

With respect to a sample format Choi provides the following definition, syntax, and semantics in Clause 7.4.3:

Definition

Each sample specifies a sphere region. The SphereRegionSample structure may be extended in derived track formats.

Syntax

```
aligned(8) SphereRegionStruct(range_included_flag) {
  signed int(32) center_yaw;
  signed int(32) center_pitch;
  singed int(32) center_roll;
  if (range_included_flag) {
    unsigned int(32) hor_range;
    unsigned int(32) ver_range;
  }
  unsigned int(1) interpolate;
  bit(7) reserved = 0;
}
aligned(8) SphereRegionSample( ) {
  for (i = 0; i < num_regions; i++)
    SphereRegionStruct(dynamic_range_flag)
}
```

Semantic

When SphereRegionStruct( ) is included in the SphereRegionSample( )structure, the following applies:

center_yaw, center_pitch, and center_roll specify the viewport orientation in units of 2-16 degrees relative to the global coordinate axes. center_yaw and center_pitch indicate the center of the viewport, and center_roll indicates the roll angle of the viewport. center_yaw shall be in the range of −180*216 to 180*216-1, inclusive. center_pitch shall be in the range of −90*216 to 90*216, inclusive. center_roll shall be in the range of −180*216 to 180*216-1, inclusive.

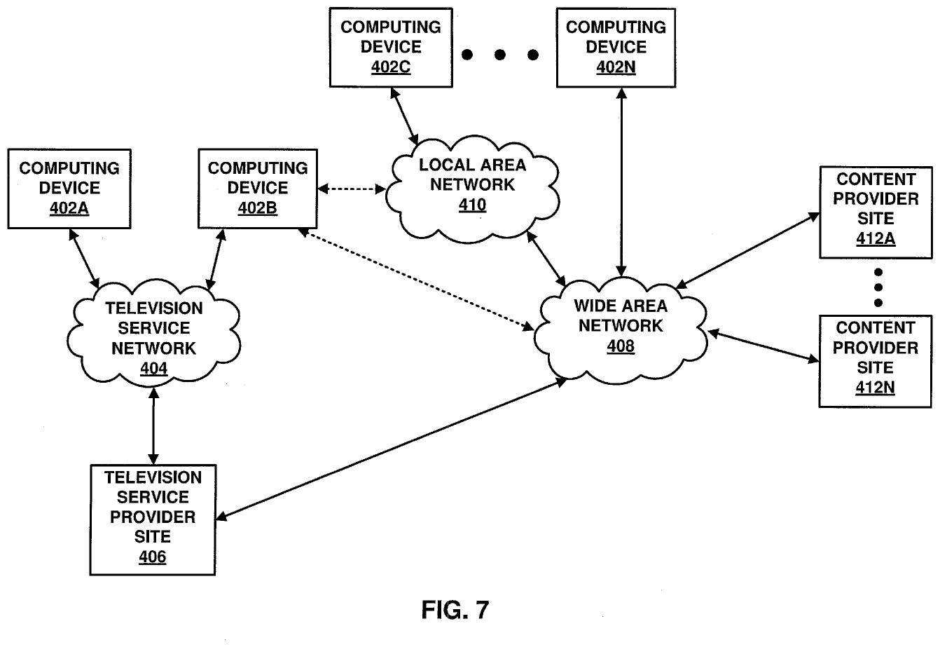

hor_range and ver_range, when present, specify the horizontal and vertical ranges, respectively, of the sphere region specified by this sample in units of 2-16 degrees. hor_range and ver_range specify the range through the center point of the sphere region, as illustrated by FIG. 7 3 or FIG. 7 4. hor_range shall be in the range of 0 to 720*216, inclusive. ver_range shall be in the range of 0 to 180*216, inclusive.

The sphere region specified by this sample is derived as follows:
If both hor_range and ver_range are equal to 0, the sphere region specified by this sample is a point on a spherical surface.
Otherwise, the sphere region is defined using variables cYaw1, cYaw2, cPitch1, and cPitch2 derived as follows:

cYaw1=(center_yaw−(range_included_flag?hor_range:static_hor_range)÷2)÷65536

cYaw2=(center_yaw+(range_included_flag?hor_range:static_hor_range)÷2)÷65536

cPitch1=(center_pitch−(range_included_flag?ver_range:static_ver_range)÷2)÷65536

cPitch2=(center_pitch+(range_included_flag?ver_range:static_ver_range)÷2)÷65536

The sphere region is defined as follows:
When shape_type is equal to 0, the sphere region is specified by four great circles defined by four points cYaw1, cYaw2, cPitch1, cPitch2 and the center point defined by center_pitch and center_yaw and as shown in [FIG. 6A].
When shape_type is equal to 1, the sphere region is specified by two yaw circles and two pitch circles defined by four points cYaw1, cYaw2, cPitch1, cPitch2 and the center point defined by center_pitch and center_yaw and as shown in [FIG. 6B].

Let the target media samples be the media samples in the referenced media tracks with composition times greater than or equal to the composition time of this sample and less than the composition time of the next sample.

interpolate equal to 0 specifies that the values of center_yaw, center_pitch, center_roll, hor_range (if present), and ver_range (if present) in this sample apply to the target media samples. interpolate equal to 1 specifies that the values of center_yaw, center_pitch, center_roll, hor_range (if present), and ver_range (if present) that apply to the target media samples are linearly interpolated from the values of the corresponding fields in this sample and the previous sample.

The value of interpolate for a sync sample, the first sample of the track, and the first sample of a track fragment shall be equal to 0.

With respect to a sample format Choi_1 provides the following definition, syntax, and semantics in Clause 7.5.3:

Definition

Each sample specifies a sphere region. The SphereRegionSample structure may be extended in derived track formats.

Syntax

```
aligned(8) SphereRegionStruct(range_included_flag) {
  signed int(32) center_azimuth;
  signed int(32) center_elevation;
  singed int(32) center_tilt;
  if (range_included_flag) {
    unsigned int(32) hor_range;
    unsigned int(32) ver_range;
  }
  unsigned int(1) interpolate;
  bit(7) reserved = 0;
}
aligned(8) SphereRegionSample( ) {
  for (i = 0; i < num regions; i++)
    SphereRegionStruct(dynamic_range_flag)
}
```

Semantic

When SphereRegionStruct( ) is included in the SphereRegionSample( )structure, the following applies:

center_azimuth and center_elevation specify the center of the sphere region.

center_azimuth shall be in the range of −180*2¹⁶ to 180*2¹⁶−1, inclusive.

center_elevation shall be in the range of −90*2¹⁶ to 90*2¹⁶, inclusive.
center_tilt specifies the tilt angle of the sphere region. center_tilt shall be in the range of −180*2¹⁶ to 180*2¹⁶−1, inclusive.
hor_range and ver_range, when present, specify the horizontal and vertical ranges, respectively, of the sphere region specified by this sample in units of 2⁻¹⁶ degrees. hor_range and ver_range specify the range through the center point of the sphere region, as illustrated by [FIG. 6A] or [FIG. 6B]. hor_range shall be in the range of 0 to 720*2¹⁶, inclusive. ver_range shall be in the range of 0 to 180*2¹⁶, inclusive.

The sphere region specified by this sample is derived as follows:
If both hor_range and ver_range are equal to 0, the sphere region specified by this sample is a point on a spherical surface.
Otherwise, the sphere region is defined using variables cAzimuth1, cAzimuth, cElevation1, and cElevation2 derived as follows:

cAzimuth1=(center azimuth−(range_included_flag?hor_range:static_hor_range)÷2)÷65536

cAzimuth2=(center_azimuth+(range_included_flag?hor_range:static_hor_range)÷2)÷65536

cElevation1=(center_elevation−(range_included_flag?ver_range:static_ver_range)÷2)÷65536

cElevation2=(center_elevation+(range_included_flag?ver_range:static_ver_range)÷2)÷65536

The sphere region is defined as follows:
When shape_type is equal to 0, the sphere region is specified by four great circles defined by four points cAzimuth1, cAzimuth2, cElevation1, cElevation2 and the center point defined by center_azimuth and center_elevation and as shown in [FIG. 6A].
When shape_type is equal to 1, the sphere region is specified by two azimuth circles and two elevation circles defined by four points cAzimuth1, cAzimuth2, cElevation1, cElevation2 and the center point defined by center_azimuth and center_elevation and as shown in [FIG. 6B].

Let the target media samples be the media samples in the referenced media tracks with composition times greater than or equal to the composition time of this sample and less than the composition time of the next sample.

interpolate equal to 0 specifies that the values of center azimuth, center_elevation, center_tilt, hor_range (if present), and ver_range (if present) in this sample apply to the target media samples. interpolate equal to 1 specifies that the values of center_azimuth, center_elevation, center_tilt, hor_range (if present), and ver_range (if present) that apply to the target media samples are linearly interpolated from the values of the corresponding fields in this sample and the previous sample.

The value of interpolate for a sync sample, the first sample of the track, and the first sample of a track fragment shall be equal to 0.

It should be noted that with respect to a StereoVideoBox, ISO/IEC 14496-12:2015 “Information technology—Coding of audio-visual objects—Part 12: ISO Base Media File Format, provides the following definition, syntax, and semantics:

Definition

Box Type: ‘stvi’

Container: Scheme Information box (‘schi’)

Mandatory: Yes (when SchemeType is ‘stvi’)

Quantity: One

The Stereo Video box is used to indicate that decoded frames either contain a representation of two spatially packed constituent frames that form a stereo pair or contain one of two views of a stereo pair. The Stereo Video box shall be present when the SchemeType is ‘stvi’.

Syntax

aligned(8) class StereoVideoBox extends extends FullBox(′stvi′,
version = 0, 0)
{
template unsigned int(30) reserved = 0;
unsigned int(2) single_view_allowed;
unsigned int(32) stereo_scheme;
unsigned int(32) length;
unsigned int(8)[length] stereo_indication_type;
Box[ ] any_box; // optional
}

Semantics

single_view_allowed is an integer. A zero value indicates that the content may only be displayed on stereoscopic displays. When (single_view_allowed& 1) is equal to 1, it is allowed to display the right view on a monoscopic single-view display. When (single_view_allowed & 2) is equal to 2, it is allowed to display the left view on a monoscopic single-view display.

stereo_scheme is an integer that indicates the stereo arrangement scheme used and the stereo indication type according to the used scheme. The following values for stereo_scheme are specified:

−1: the frame packing scheme as specified by the Frame packing arrangement Supplemental

Enhancement Information message of [ITU-T H.265]

length indicates the number of bytes for the stereo_indication_type field.

stereo_indication_type indicates the stereo arrangement type according to the used stereo

indication scheme. The syntax and semantics of stereo_indication_type depend on the

value of stereo_scheme. The syntax and semantics for stereo_indication_type for the following values of stereo_scheme are specified as follows:
stereo_scheme equal to 1: The value of length shall be 4 and stereo_indication_type shall be unsigned int(32) which contains the frame_packing_arrangement_type value from Table D-8 of [ITU-T H.265] (‘Definition of frame_packing_arrangement_type’).

Table D-8 of ITU-T H.265 is illustrated in Table 1:

TABLE 1

| Value | Interpretation |
|---|---|
| 3 | Each component plane of the decoded frames contains |
| | a side-by-side packing arrangement of corresponding |
| | planes of two constituent frames . . . |
| 4 | Each component plane of the decoded frames contains |
| | corresponding a top-bottom packing arrangement of |
| | planes of two constituent frames . . . |
| 5 | The component planes of the decoded frames in output |
| | alternating first order form a temporal interleaving of |
| | and second constituent frames . . . |

With respect to a Frame packing item property, Choi provides the following definition, syntax, and semantics:

Definition

Box type: ‘stvi’

Property type: Descriptive item property

Container: ItemPropertyContainerBox

Mandatory (per an item): No

Quantity (per an item): Zero or one

FramePackingProperty indicates that the reconstructed image contains a representation of two spatially packed constituent pictures.

essential shall be equal to 1 for a ‘stvi’ item property.

Syntax

FramePackingProperty has the same syntax as StereoVideoBox specified in ISO/IEC 14496-12.

Semantics

The semantics of the syntax elements within the FramePackingProperty are the same as those specified for the syntax elements of StereoVideoBox as defined in ISO/IEC 14496-12.

With respect to the region-wise quality rankings, Choi and Choi_1 provide the following in Clause 7.6.1:

Quality ranking values of quality ranking regions relative to other quality ranking regions of the same track or quality ranking regions of other tracks can be indicated by using the SphereRegionQualityRankingBox or the 2DRegionQualityRankingBox. When neither SphereRegionQualityRankingBox nor 2DRegionQualityRankingBox is present in a visual sample entry, the quality ranking value for the visual track is not defined. Quality ranking values indicate a relative quality order of quality ranking regions. When quality ranking region A has a non-zero quality ranking value less than that of quality ranking region B, quality ranking region A has a higher quality than quality ranking region B. When the quality ranking value is non-zero, the picture quality within the entire indicated quality ranking region is approximately constant. The boundaries of the quality ranking sphere regions specified by the SphereRegionQualityRankingBox may or may not match with the boundaries of the quality ranking 2D regions specified by the 2DRegionQualityRankingBox. The boundaries of the quality ranking sphere or 2D regions may or may not match with the boundaries of the packed regions or the boundaries of the projected regions specified by RegionWisePackingBox.

With respect to the Sphere region quality ranking box, Choi and Choi_1 provide the following definition, syntax, and semantics:

Definition

Box type: ‘srqr’

Container: VisualSampleEntry

Mandatory (per an item): No

Quantity (per an item): At most one for each region_definition_type value

Syntax

```
aligned(8) class SphereRegionQualityRankingBox extends
FullBox(′srqr′, 0, 0) {
  unsigned int(8) region_definition_type;
  unsigned int(8) num_regions;
  unsigned int(1) remaining_area_flag;
  unsigned int(1) view_idc_presence_flag;
  bit(6) reserved = 0;
  if (view_idc_presence_flag == 0) {
    unsigned int(2) default_view_idc;
    bit(6) reserved = 0;
  }
  for (i = 0; i < num_regions; i++) {
    unsigned int(8) quality_ranking;
    if (view_idc_presence_flag == 1) {
      unsigned int(2) view_idc;
      bit(6) reserved = 0;
    }
    if ((i < (num_regions − 1)) ∥ (remaining_area_flag == 0))
      SphereRegionStruct(1);
  }
}
```

Semantics

region_definition_type has identical semantics to shape_type of SphereRegionConfigBox.

num_regions specifies the number of quality ranking regions for which the quality ranking information is given in this box. Value 0 is reserved. There shall be no point on the sphere that is contained in more than one of these quality ranking sphere regions.

remaining_area_flag equal to 0 specifies that all the quality ranking regions are defined by the SphereRegionStruct(1) structures. remaining_area_flag equal to 1 specifies that the first num_regions−1 quality ranking regions are defined by SphereRegionStruct(1) structure and the last remaining quality ranking region is the sphere region within coverage area, not covered by the union of the quality ranking regions defined by the first num_regions−1 SphereRegionStruct(1) structures.

SphereRegionStruct(1) specifies the spherical location and size of the quality ranking region relative to the global coordinate axes, while the shape of the quality ranking regions is indicated by region_definition_type. The value of interpolate in SphereRegionStruct(1) shall be equal to 0.

view_idc_presence_flag equal to 0 specifies that view_idc is not present. view_idc_presence_flag equal to 1 specifies that view_idc is present and indicates the association of quality ranking region with particular (left or right or both) views or monoscopic content.

default_view_idc equal to 0 indicates that the quality ranking region is monoscopic, 1 indicates that the quality ranking region is on the left view of stereoscopic content, 2 indicates that the quality ranking region is on the right view of stereoscopic content, 3 indicates that the quality ranking region is on both the left and right views.

quality_ranking specifies a quality ranking value of the quality ranking region. quality_ranking equal to 0 indicates that the quality ranking value is not defined. The semantics of non-zero quality ranking values are specified in [Clause 7.6.1 of Choi].

view_idc equal to 0 indicates that the quality ranking region is monoscopic, 1 indicates that the quality ranking region is on the left view of stereoscopic content, 2 indicates that the quality ranking region is on the right view of stereoscopic content, 3 indicates that the quality ranking region is on both the left and right views. When not present, the value of view_idc is inferred to be equal to the value of default_view_idc.

With respect to the 2D region quality ranking box, Choi provides the following definition, syntax, and semantics:

Definition

Box type: ‘2dqr’

Container: VisualSampleEntry

Mandatory (per an item): No

Quantity (per an item): Zero or one

Syntax

```
aligned(8) class 2DRegionQualityRankingBox extends FullBox(′2dqr′,
0, 0) {
  unsigned int(8) num_regions;
    unsigned int(1) remaining_area_flag;
  unsigned int(1) view_idc_presence_flag;
  bit(6) reserved = 0;
  for (i = 0; i < num_regions; i++) {
    unsigned int(8) quality_ranking;
    if (view_idc_presence_flag == 1) {
      unsigned int(2) view_idc;
      bit(6) reserved = 0;
    }
    if ((i < (num_regions - 1)) ∥ (remaining_area_flag == 0)) {
      unsigned int(16) left_offset;
      unsigned int(16) top_offset;
      unsigned int(16) region_width;
      unsigned int(16) region_height;
    }
  }
}
```

Semantics

quality_ranking and view_idc are specified identically to the syntax elements with the same names in SphereRegionQualityRankingBox.

num_regions specifies the number of quality ranking 2D regions for which the quality ranking information is given in this box. Value 0 is reserved. There shall be no pixel of the decoded picture that is contained in more than one of these quality ranking 2D regions.

remaining_area_flag equal to 0 specifies that all the quality ranking 2D regions are defined by the left_offset, top_offset, region_width, and region_height.

remaining_area_flag equal to 1 specifies that the first num_regions−1 quality ranking 2D regions are defined by left_offset, top_offset, region_width, and region_height and the last remaining quality ranking 2D region is the area in the picture with width equal to width of VisualSampleEntry and height equal to height of VisualSampleEntry, not covered by the union of the first num_regions−1 quality ranking 2D regions.

left_offset, top_offset, region_width, and region_height are integer values that indicate the position and size of the quality ranking 2D region. left_offset and top_offset indicate the horizontal and vertical coordinates, respectively, of the upper left corner of the quality ranking 2D region within the picture in visual presentation size of 2D representation. region_width and region_height indicate the width and height, respectively, of the quality ranking 2D region within the picture in visual presentation size of 2D representation. left_offset+region_width shall be less than width of TrackHeaderBox. top_offset+region_height shall be less than height of TrackHeaderBox.

region_width shall be greater than 0.

region_height shall be greater than 0.

With respect to the 2D region quality ranking box, Choi_1 provides the following

definition, syntax, and semantics:

Definition

Box type: ‘2dqr’

Container: VisualSampleEntry

Mandatory (per an item): No

Quantity (per an item): Zero or one

Syntax

```
aligned(8) class 2DRegionQualityRankingBox extends FullBox(′2dqr′,
0, 0) {
  unsigned int(8) num_regions;
  unsigned int(1) remaining_area_flag;
  unsigned int(1) view_idc_presence_flag;
  if (view_idc_presence_flag == 0) {
    unsigned int(2) default_view_idc;
    bit(4) reserved = 0;
  } else
    bit(6) reserved = 0;
  for (i = 0; i < num_regions; i++) {
    unsigned int(8) quality_ranking;
    if (view_idc_presence_flag == 1) {
      unsigned int(2) view_idc;
      bit(6) reserved = 0;
    }
    if ((i < (num_regions - 1)) ∥ (remaining_area_flag == 0)) {
      unsigned int(16) left_offset;
      unsigned int(16) top_offset;
      unsigned int(16) region_width;
      unsigned int(16) region_height;
    }
  }
}
```

Semantics

quality_ranking, view_idc_presence_flag, default_view_idc, and view_idc are specified identically to the syntax elements with the same names in SphereRegionQualityRankingBox.

num_regions specifies the number of quality ranking 2D regions for which the quality ranking information is given in this box. Value 0 is reserved. There shall be no pixel of the decoded picture that is contained in more than one of these quality ranking 2D regions.

remaining_area_flag equal to 0 specifies that all the quality ranking 2D regions are defined by the left_offset, top_offset, region_width, and region_height.

remaining_area_flag equal to 1 specifies that the first num_regions−1 quality ranking 2D regions are defined by left_offset, top_offset, region_width, and region_height and the last remaining quality ranking 2D region is the area in the picture with width equal to width of VisualSampleEntry and height equal to height of VisualSampleEntry, not covered by the union of the first num_regions−1 quality ranking 2D regions.

left_offset, top_offset, region_width, and region_height are integer values that indicate the position and size of the quality ranking 2D region. left_offset and top_offset indicate the horizontal and vertical coordinates, respectively, of the upper left corner of the quality ranking 2D region within the picture in visual presentation size of the 2D representation. region_width and region_height indicate the width and height, respectively, of the quality ranking 2D region within the picture in visual presentation size of the 2D representation. left_offset+region_width shall be less than width of TrackHeaderBox. top_offset+region_height shall be less than height of TrackHeaderBox.

region_width shall be greater than 0.

region_height shall be greater than 0.

As described above, Choi specifies how to encapsulate, signal, and stream omnidirectional media using dynamic adaptive streaming over Hypertext Transfer Protocol (HTTP) (DASH). DASH is described in ISO/IEC: ISO/IEC 23009-1:2014, “Information technology—Dynamic adaptive streaming over HTTP (DASH)—Part 1: Media presentation description and segment formats,” International Organization for Standardization, 2nd Edition, May 15, 2014 (hereinafter, “ISO/IEC 23009-1:2014”), which is incorporated by reference herein. A DASH media presentation may include data segments, video segments, and audio segments. In some examples, a DASH Media Presentation may correspond to a linear service or part of a linear service of a given duration defined by a service provider (e.g., a single TV program, or the set of contiguous linear TV programs over a period of time). According to DASH, a Media Presentation Description (MPD) is a document that includes metadata required by a DASH Client to construct appropriate HTTP-URLs to access segments and to provide the streaming service to the user. A MPD document fragment may include a set of eXtensible Markup Language (XML)-encoded metadata fragments. The contents of the MPD provide the resource identifiers for segments and the context for the identified resources within the Media Presentation. The data structure and semantics of the MPD fragment are described with respect to ISO/IEC 23009-1:2014. Further, it should be noted that draft editions of ISO/IEC 23009-1 are currently being proposed. Thus, as used herein, a MPD may include a MPD as described in ISO/IEC 23009-1:2014, currently proposed MPDs, and/or combinations thereof. In ISO/IEC 23009-1:2014, a media presentation as described in a MPD may include a sequence of one or more Periods, where each Period may include one or more Adaptation Sets. It should be noted that in the case where an Adaptation Set includes multiple media content components, then each media content component may be described individually. Each Adaptation Set may include one or more Representations. In ISO/IEC 23009-1:2014 each Representation is provided: (1) as a single Segment, where Subsegments are aligned across Representations with an Adaptation Set; and (2) as a sequence of Segments where each Segment is addressable by a template-generated Universal Resource Locator (URL). The properties of each media content component may be described by an AdaptationSet element and/or elements within an Adaption Set, including for example, a ContentComponent element.

With respect to signaling of projection type information in DASH, Choi provides the following projection format descriptor. It should be noted that in the tables below, for Use, M=Mandatory, CM=Conditionally Mandatory and O=Optional.

A projection format (PF) EssentialProperty element with a @schemeIdUri attribute equal to “urn:mpeg:mpegB:cicp:PF” may be present at MPD level (i.e., directly in the MPD element) and/or at adaptation set level (i.e., directly in an AdaptationSet element) and/or at representation level (i.e., directly in a Representation element). The presence of the PF descriptor at MPD level indicates that all the representations of the media presentation carry projected omnidirectional video. The presence of the PF descriptor at adaptation set level indicates that all the representations of the adaptation set carry projected omnidirectional video. The @ value of the PF descriptor with @ schemeIdUri equal to “urn:mpeg:mpegB:cicp:PF” is a comma separated list of values as specified in

[Table 2]:

TABLE 2

| @value parameter | | |
|---|---|---|
| for PF descriptor | Use | Description |
| projection_type | M | Specifies a comma separated list of projection |
| | | type values of the projected picture. |
| | | For ISO base media file format Segments, each |
| | | value in the list projection_type |
| | | shall be equal to projection_type |
| | | in ProjectionFormatBox in sample entries of |
| | | the Initialization Segment. |

With respect to signaling of region-wise packing information in DASH, Choi provides the following region-wise packing format descriptor.

A region-wise packing format (RWPK) EssentialProperty element with a @schemeIdUri attribute equal to “urn:mpeg:omaf:rwpk:2017” may be present at MPD level (i.e., directly in the MPD element) and/or at adaptation set level (i.e., directly in an AdaptationSet element) and/or at representation level (i.e., directly in a Representation element). The @value of the RWPK descriptor with @schemeIdUri equal to “urn:mpeg:omaf:rwpk:2017” is a comma separated list of values as specified in

[Table 3]:

TABLE 3

| @value parameter | | |
|---|---|---|
| for RWPK | | |
| descriptor | Use | Description |
| packing_type | O | Specifies a comma separated list of the packing |
| | | type value of the picture. |
| | | For ISO base media file format Segments, |
| | | packing_type shall be equal to |
| | | packing_type in RegionWisePackingBox |
| | | in sample entries of the Initialization |
| | | Segment. When this @value parameter is not |
| | | present or does not include any values in a |
| | | RWPK descriptor, packing_type is |
| | | inferred to be equal to 1. |

The absence of a RWPK descriptor indicates that no region-wise packing has been applied.

With respect to signaling of a sphere region covered by the content in DASH, Choi provides the following content coverage descriptor.

A content coverage (CC) SupplementalProperty element with a @schemeIdUri attribute equal to “urn:mpeg:omaf:cc:2017” may be present at adaptation set level (i.e., directly in an AdaptationSet element) and shall not be present in other levels (i.e., shall not be present at MPD level or directly in any Representation element). The @ value of the CC descriptor with @schemeIdUri equal to “urn:mpeg:omaf:cc:2017” is a comma separated list of values as specified in

[Table 4]. The CC descriptor indicates that each Representation covers the sphere region as specified in clause 7.4 [of Choi] by shape_type and syntax elements center_yaw, center_pitch, center_roll, hor_range, and ver_range in SphereRegionStruct as included in the CC descriptor.

TABLE 4

| @value parameter | | |
|---|---|---|
| for CC descriptor | Use | Description |
| shape_type | M | Specifies the shape type of the sphere region, as specified in 7.4.2.3 [of |
| | | Choi], that is covered by each Representation |
| center_yaw | M | Specifies the yaw of the center point the sphere region in degrees relative to |
| | | the global coordinate axes. |
| center_pitch | M | Specifies the pitch of the center point the sphere region in degrees relative to |
| | | the global coordinate axes. |
| center_roll | M | Specifies the roll of the sphere region in degrees relative to the global |
| | | coordinate axes. |
| hor_range | M | Specifies the horizontal range of the sphere region through the center point of |
| | | the sphere region. |
| ver_range | M | Specifies the vertical range of the sphere region through the center point of |
| | | the sphere region. |

The absence of the CC descriptor indicates that each Representation covers the entire sphere when a PF descriptor is present, either in the Representation or the containing Adaptation Set.

With respect to signaling of region-wise quality ranking information in DASH, Choi provides the following region-wise packing format descriptor.

A region-wise quality ranking (RWQR) SupplementalProperty element with a @schemeIdUri attribute equal to “urn:mpeg:omaf:rwqr:2017” may be present at adaptation set level (i.e., directly in an AdaptationSet element) and shall not be present in other levels (i.e. shall not be present at MPD level or directly in any Representation element). The @value of the RWQR descriptor with @schemeIdUri equal to “urn:mpeg:omaf:rwqr:2017” is a comma separated list of values as specified in

[Table 5]. The RWQR descriptor indicates a quality ranking value of a quality ranking sphere region relative to other quality ranking sphere regions in the same Adaptation Set and relative to RWQR descriptors and @qualityRanking values in all Adaptation Sets that have the same @ value in the DASH Viewpoint element as the Adaptation Set containing this RWQR descriptor. The sphere region for the quality-ranking is specified as specified in clause 7.4 [of Choi] by syntax elements shape_type, center_yaw, center_pitch, center_roll, hor_range, ver_range in SphereRegionStruct. When the quality ranking value is non-zero, the picture quality within the entire indicated quality ranking sphere region is approximately constant.

TABLE 5

| @value parameter for | | |
|---|---|---|
| RWQR descriptor | Use | Description |
| shape_type | M | Value 0 specifies that the quality ranking sphere region is indicated through |
| | | four great circles as specified in clause 7.3 [of Choi]. Value 1 specifies that |
| | | the quality ranking sphere region is indicated through two yaw and two |
| | | pitch circles as specified in clause 7.3 [of Choi]. |
| quality_ranking | M | specifies a quality ranking value of the quality ranking sphere region. |
| | | quality_ranking equal to 0 indicates that the quality ranking is not defined. |
| | | When quality ranking sphere region A has a non-zero quality_ranking |
| | | value less than the quality_ranking value of quality ranking sphere region |
| | | B, quality ranking sphere region A has a higher quality than quality ranking |
| | | sphere region B. When quality ranking sphere region A partly or entirely |
| | | overlaps with quality ranking sphere region B, quality_ranking of region A |
| | | shall be equal to quality_ranking of region B. |
| view_idc | M | 0 indicates that the content is monoscopic, 1 indicates that the quality |
| | | ranking sphere region is on the left view of stereoscopic content, 2 |
| | | indicates that the quality ranking sphere region is on the right view of |
| | | stereoscopic content, 3 indicates that the quality ranking sphere region is |
| | | on both the left and right views. |
| remaining_area_flag | M | Value 0 specifies that center_yaw, center_pitch, center_roll, hor_range, and |
| | | ver_range are present. Value 1 specifies that the quality ranking sphere |
| | | region is the area not covered by any other quality ranking sphere regions |
| | | defined by RWQR descriptors included in the same element. |
| | | remaining_area_flag shall not be equal to 1 in more than one RWQR |
| | | descriptor in the same element. |
| center_yaw | CM | Specifies the yaw of the center point the quality ranking sphere region in |
| | | degrees relative to the global coordinate axes. |
| center_pitch | CM | Specifies the pitch of the center point the quality ranking sphere region in |
| | | degrees relative to the global coordinate axes. |
| center_roll | CM | Specifies the roll angle for the quality ranking sphere region. |
| hor_range | CM | Specifies the horizontal range of the quality ranking sphere region through |
| | | its center point. |
| ver_range | CM | Specifies the vertical range of the quality raking sphere region through its |
| | | center point. |

With respect to signaling of stereoscopic framing packing in DASH Choi provides the following:

A DASH FramePacking element with a @ schemeIdUri attribute equal to urn:mpeg:mpegB:cicp:VideoFramePackingType may be present at adaptation set level and shall not be present (i.e., directly in an AdaptationSet element) and shall not be present at other levels (i.e., shall not be present at MPD level or directly in any Representation element). When used with omnidirectional projected video (i.e., when the PF descriptor is present), this essential property descriptor indicates that the projected picture consists of spatially packed constituent pictures of the left and right views.

With respect to the carriage of timed metadata in DASH Choi provides the following:

A timed metadata track, e.g., of sample entry type ‘invp’ or ‘rcvp’ as specified in clause 7.4 [of Choi], may be encapsulated in a DASH representation. The @ associationId attribute of this metadata representation shall contain the value of the attribute @id of the representation containing the omnidirectional media carried by the media track(s) that are associated with the timed metadata track as specified in clause 7.1.3.1 [of Choi]. The @associationType attribute of this metadata representation shall be equal to the track reference type through which the timed metadata track is associated with the media track(s) as specified in clause 7.1.3.1 [of Choi].

The techniques for omnidirectional media encapsulation and signaling in DASH provided in Choi may be less than ideal.

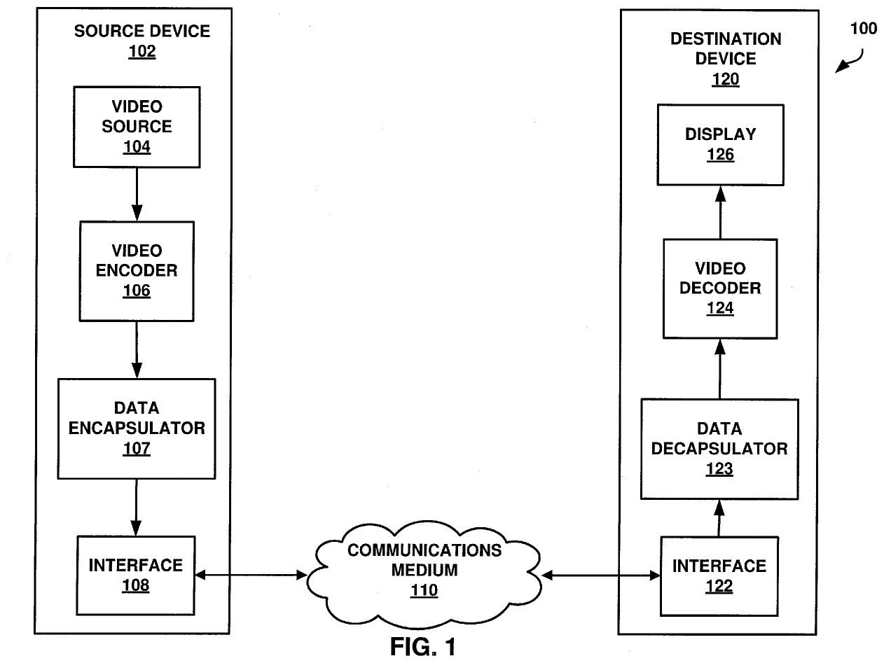

FIG. 1 is a block diagram illustrating an example of a system that may be configured to code (i.e., encode and/or decode) video data according to one or more techniques of this disclosure. System 100 represents an example of a system that may encapsulate video data according to one or more techniques of this disclosure. As illustrated in FIG. 1, system 100 includes source device 102, communications medium 110, and destination device 120. In the example illustrated in FIG. 1, source device 102 may include any device configured to encode video data and transmit encoded video data to communications medium 110. Destination device 120 may include any device configured to receive encoded video data via communications medium 110 and to decode encoded video data. Source device 102 and/or destination device 120 may include computing devices equipped for wired and/or wireless communications and may include, for example, set top boxes, digital video recorders, televisions, desktop, laptop or tablet computers, gaming consoles, medical imagining devices, and mobile devices, including, for example, smartphones, cellular telephones, personal gaming devices.

Communications medium 110 may include any combination of wireless and wired communication media, and/or storage devices. Communications medium 110 may include coaxial cables, fiber optic cables, twisted pair cables, wireless transmitters and receivers, routers, switches, repeaters, base stations, or any other equipment that may be useful to facilitate communications between various devices and sites. Communications medium 110 may include one or more networks. For example, communications medium 110 may include a network configured to enable access to the World Wide Web, for example, the Internet. A network may operate according to a combination of one or more telecommunication protocols. Telecommunications protocols may include proprietary aspects and/or may include standardized telecommunication protocols. Examples of standardized telecommunications protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, Global System Mobile Communications (GSM) standards, code division multiple access (CDMA) standards, 3rd Generation Partnership Project (3GPP) standards, European Telecommunications Standards Institute (ETSI) standards, Internet Protocol (IP) standards, Wireless Application Protocol (WAP) standards, and Institute of Electrical and Electronics Engineers (IEEE) standards.

Storage devices may include any type of device or storage medium capable of storing data. A storage medium may include a tangible or non-transitory computer-readable media. A computer readable medium may include optical discs, flash memory, magnetic memory, or any other suitable digital storage media. In some examples, a memory device or portions thereof may be described as non-volatile memory and in other examples portions of memory devices may be described as volatile memory. Examples of volatile memories may include random access memories (RAM), dynamic random access memories (DRAM), and static random access memories (SRAM). Examples of non-volatile memories may include magnetic hard discs, optical discs, floppy discs, flash memories, or forms of electrically programmable memories (EPROM) or electrically erasable and programmable (EEPROM) memories. Storage device(s) may include memory cards (e.g., a Secure Digital (SD) memory card), internal/external hard disk drives, and/or internal/external solid state drives. Data may be stored on a storage device according to a defined file format.

FIG. 7 is a conceptual drawing illustrating an example of components that may be included in an implementation of system 100. In the example implementation illustrated in FIG. 7, system 100 includes one or more computing devices 402A-402N, television service network 404, television service provider site 406, wide area network 408, local area network 410, and one or more content provider sites 412A-412N. The implementation illustrated in FIG. 7 represents an example of a system that may be configured to allow digital media content, such as, for example, a movie, a live sporting event, etc., and data and applications and media presentations associated therewith to be distributed to and accessed by a plurality of computing devices, such as computing devices 402A-402N. In the example illustrated in FIG. 7, computing devices 402A-402N may include any device configured to receive data from one or more of television service network 404, wide area network 408, and/or local area network 410. For example, computing devices 402A-402N may be equipped for wired and/or wireless communications and may be configured to receive services through one or more data channels and may include televisions, including so-called smart televisions, set top boxes, and digital video recorders. Further, computing devices 402A-402N may include desktop, laptop, or tablet computers, gaming consoles, mobile devices, including, for example, “smart” phones, cellular telephones, and personal gaming devices.

Television service network 404 is an example of a network configured to enable digital media content, which may include television services, to be distributed. For example, television service network 404 may include public over-the-air television networks, public or subscription-based satellite television service provider networks, and public or subscription-based cable television provider networks and/or over the top or Internet service providers. It should be noted that although in some examples television service network 404 may primarily be used to enable television services to be provided, television service network 404 may also enable other types of data and services to be provided according to any combination of the telecommunication protocols described herein. Further, it should be noted that in some examples, television service network 404 may enable two-way communications between television service provider site 406 and one or more of computing devices 402A-402N. Television service network 404 may comprise any combination of wireless and/or wired communication media. Television service network 404 may include coaxial cables, fiber optic cables, twisted pair cables, wireless transmitters and receivers, routers, switches, repeaters, base stations, or any other equipment that may be useful to facilitate communications between various devices and sites. Television service network 404 may operate according to a combination of one or more telecommunication protocols. Telecommunications protocols may include proprietary aspects and/or may include standardized telecommunication protocols. Examples of standardized telecommunications protocols include DVB standards, ATSC standards, ISDB standards, DTMB standards, DMB standards, Data Over Cable Service Interface Specification (DOCSIS) standards, HbbTV standards, W3C standards, and UPnP standards.

Referring again to FIG. 7, television service provider site 406 may be configured to distribute television service via television service network 404. For example, television service provider site 406 may include one or more broadcast stations, a cable television provider, or a satellite television provider, or an Internet-based television provider. For example, television service provider site 406 may be configured to receive a transmission including television programming through a satellite uplink/downlink. Further, as illustrated in FIG. 7, television service provider site 406 may be in communication with wide area network 408 and may be configured to receive data from content provider sites 412A-412N. It should be noted that in some examples, television service provider site 406 may include a television studio and content may originate therefrom.

Wide area network 408 may include a packet based network and operate according to a combination of one or more telecommunication protocols. Telecommunications protocols may include proprietary aspects and/or may include standardized telecommunication protocols. Examples of standardized telecommunications protocols include Global System Mobile Communications (GSM) standards, code division multiple access (CDMA) standards, 3^{rd} Generation Partnership Project (3GPP) standards, European Telecommunications Standards Institute (ETSI) standards, European standards (EN), IP standards, Wireless Application Protocol (WAP) standards, and Institute of Electrical and Electronics Engineers (IEEE) standards, such as, for example, one or more of the IEEE 802 standards (e.g., Wi-Fi). Wide area network 408 may comprise any combination of wireless and/or wired communication media. Wide area network 480 may include coaxial cables, fiber optic cables, twisted pair cables, Ethernet cables, wireless transmitters and receivers, routers, switches, repeaters, base stations, or any other equipment that may be useful to facilitate communications between various devices and sites. In one example, wide area network 408 may include the Internet. Local area network 410 may include a packet based network and operate according to a combination of one or more telecommunication protocols. Local area network 410 may be distinguished from wide area network 408 based on levels of access and/or physical infrastructure. For example, local area network 410 may include a secure home network.

Referring again to FIG. 7, content provider sites 412A-412N represent examples of sites that may provide multimedia content to television service provider site 406 and/or computing devices 402A-402N. For example, a content provider site may include a studio having one or more studio content servers configured to provide multimedia files and/or streams to television service provider site 406. In one example, content provider sites 412A-412N may be configured to provide multimedia content using the IP suite. For example, a content provider site may be configured to provide multimedia content to a receiver device according to Real Time Streaming Protocol (RTSP), HTTP, or the like. Further, content provider sites 412A-412N may be configured to provide data, including hypertext based content, and the like, to one or more of receiver devices computing devices 402A-402N and/or television service provider site 406 through wide area network 408. Content provider sites 412A-412N may include one or more web servers. Data provided by data provider site 412A-412N may be defined according to data formats.

Referring again to FIG. 1, source device 102 includes video source 104, video encoder 106, data encapsulator 107, and interface 108. Video source 104 may include any device configured to capture and/or store video data. For example, video source 104 may include a video camera and a storage device operably coupled thereto. Video encoder 106 may include any device configured to receive video data and generate a compliant bitstream representing the video data. A compliant bitstream may refer to a bitstream that a video decoder can receive and reproduce video data therefrom.

Aspects of a compliant bitstream may be defined according to a video coding standard. When generating a compliant bitstream video encoder 106 may compress video data. Compression may be lossy (discernible or indiscernible to a viewer) or lossless.

Referring again to FIG. 1, data encapsulator 107 may receive encoded video data and generate a compliant bitstream, e.g., a sequence of NAL units according to a defined data structure. A device receiving a compliant bitstream can reproduce video data therefrom. It should be noted that the term conforming bitstream may be used in place of the term compliant bitstream. It should be noted that data encapsulator 107 need not necessary be located in the same physical device as video encoder 106. For example, functions described as being performed by video encoder 106 and data encapsulator 107 may be distributed among devices illustrated in FIG. 7.

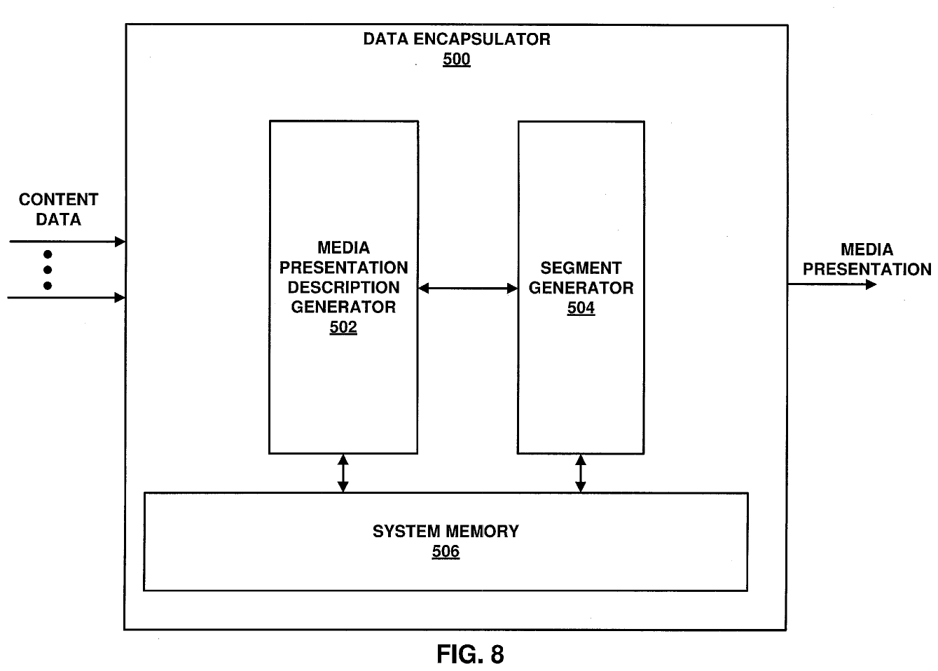

In one example, data encapsulator 107 may include a data encapsulator configured to receive one or more media components and generate media presentation based on DASH. FIG. 8 is a block diagram illustrating an example of a data encapsulator that may implement one or more techniques of this disclosure. Data encapsulator 500 may be configured to generate a media presentation according to the techniques described herein. In the example illustrated in FIG. 8, functional blocks of component encapsulator 500 correspond to functional blocks for generating a media presentation (e.g., a DASH media presentation). As illustrated in FIG. 8, component encapsulator 500 includes media presentation description generator 502, segment generator 504, and system memory 506. Each of media presentation description generator 502, segment generator 504, and system memory 506 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although data encapsulator 500 is illustrated as having distinct functional blocks, such an illustration is for descriptive purposes and does not limit data encapsulator 500 to a particular hardware architecture. Functions of data encapsulator 500 may be realized using any combination of hardware, firmware and/or software implementations.

Media presentation description generator 502 may be configured to generate media presentation description fragments. Segment generator 504 may be configured to receive media components and generate one or more segments for inclusion in a media presentation. System memory 506 may be described as a non-transitory or tangible computer-readable storage medium. In some examples, system memory 506 may provide temporary and/or long-term storage. In some examples, system memory 506 or portions thereof may be described as non-volatile memory and in other examples portions of system memory 506 may be described as volatile memory. System memory 506 may be configured to store information that may be used by data encapsulator during operation.

As described above, the techniques for omnidirectional media encapsulation and signaling in DASH provided in Choi may be less than ideal. For example, rules are not described for the number of DASH descriptors that can be present at various DASH MPD levels.

In one example, according to the techniques described herein, media presentation description generator 502 may be configured to generate a projection format (PF) descriptor including projection type information. In one example, a projection format descriptor may be based on the following example definition.

A projection format (PF) EssentialProperty element with a @schemeIdUri attribute equal to “urn:mpeg:mpegB:cicp:PF” may be present at MPD level (i.e., directly in the MPD element) and/or at adaptation set level (i.e. directly in an AdaptationSet element) and/or at representation level (i.e. directly in a Representation element). The presence of the PF descriptor at MPD level indicates that all the representations of the media presentation carry projected omnidirectional video. The presence of the PF descriptor at adaptation set level indicates that all the representations of the adaptation set carry projected omnidirectional video. The @ value of the PF descriptor with @ schemeIdUri equal to “urn:mpeg:mpegB:cicp:PF” is a comma separated list of values as specified in Table 6.

TABLE 6

| @value parameter for PF | | |
|---|---|---|
| SupplementalProperty/ | | |
| EssentialProperty | Use | Description |
| projection_type | M | Specifies a comma separated |
| | | list of projection type values of the |
| | | projected picture. |
| | | For ISO base media file format |
| | | Segments, each value in the list |
| | | projection_type shall be |
| | | equal to projection_type in |
| | | ProjectionFormatBox in sample entries |
| | | of the Initialization Segment. |

In one example, the PF descriptor may be subject to the following:

When the PF descriptor is present on Adaptation Set level, it indicates that all the Representations of the Adaptation Set are projected omnidirectional video.

At most one PF descriptor may be present at MPD level (i.e., directly in the MPD element) and/or adaptation set level (i.e. directly in an AdaptationSet element) and/or representation level (i.e. directly in a Representation element).

When a PF descriptor element is included at MPD level (i.e. in a MPD element) and/or at adaptation set level (i.e. in a AdaptationSet element) and/or at a representation (i.e. in a Representation element), the @value signaled in the PF descriptor at the hierarchically lower level shall take precedence over the @ value signaled at higher level.

In one example, according to the techniques described herein, media presentation description generator 502 may be configured to generate a region-wise packing format descriptor. In one example, a region-wise packing format descriptor may be based on the following example definition:

A region-wise packing format (RWPK) EssentialProperty element with a @schemeIdUri attribute equal to “urn:mpeg:omaf:rwpk:2017” may be present at MPD level (i.e., directly in the MPD element) and/or at adaptation set level (i.e. directly in an AdaptationSet element) and/or at representation level (i.e. directly in a Representation element). The @value of the RWPK descriptor with @schemeIdUri equal to “urn:mpeg:omaf:rwpk:2017” is a comma separated list of values as specified in Table 7:

TABLE 7

| @value parameter for | | |
|---|---|---|
| RWPK descriptor | Use | Description |
| packing_type | 0 | Specifies a comma separated list of |
| | | the packing type value of the picture. |
| | | For ISO base media file format Segments, |
| | | packing_type shall be equal to |
| | | packing_type in RegionWisePackingBox |
| | | in sample entries of the Initialization |
| | | Segment. When this @value parameter is |
| | | not present or does not include any values |
| | | in a RWPK descriptor, packing_type |
| | | is inferred to be equal to 0. |

In one example, the RWPK descriptor may be subject to the following:

The absence of a RWPK descriptor indicates that no region-wise packing has been applied.

At most one RWPK descriptor may be present at MPD level (i.e., directly in the MPD element) and/or adaptation set level (i.e. directly in an AdaptationSet element) and/or representation level (i.e. directly in a Representation element).

When a RWPK descriptor element is included at MPD level (i.e. directly in a MPD element) and/or at adaptation set level (i.e. directly in a AdaptationSet element) and/or at a representation (i.e. directly in a Representation element), the @ value signaled in the RWPK descriptor at the hierarchically lower level shall take precedence over the @ value signaled at higher level.

In one example according to the techniques described herein, media presentation description generator 502 may be configured to signal a region-wise packing box based on the following definition, syntax, and semantics:

Definition

Box Type: ‘rwpk’

Container: Scheme Information box (‘schi’)

Mandatory: No

Quantity: Zero or one

RegionWisePackingBox indicates that projected frames are packed region-wise and require unpacking prior to rendering. The size of the projected picture is explicitly signalled in this box. The size of the packed picture is indicated by the width and height syntax elements of VisualSampleEntry, denoted as PackedPicWidth and PackedPicHeight, respectively.

NOTE 1: When the pictures are field pictures instead of frame pictures, the actual height of the packed pictures would be only half of PackedPicHeight.

Syntax

```
aligned(8) class RegionWisePackingBox extends FullBox(′rwpk′, 0, 0) {
  RegionWisePackingStruct( );
}
aligned(8) class RegionWisePackingStruct {
  unsigned int(8) num_regions;
  unsigned int(16) proj_picture_width;
  unsigned int(16) proj_picture_height;
  for (i = 0; i < num_regions; i++) {
    bit(3) reserved = 0;
    unsigned int(1) guard_band_flag[i];
    unsigned int(4) packing_type[i];
    if (packing_type[i] == 0) {
      unsigned int(16) proj_reg_width[i];
      unsigned int(16) proj_reg_height[i];
      unsigned int(16) proj_reg_top[i];
      unsigned int(16) proj_reg_left[i];
      unsigned int(16) packed_reg_width[i];
      unsigned int(16) packed_reg_height[i];
      unsigned int(16) packed_reg_top[i];
      unsigned int(16) packed_reg_left[i];
      unsigned int(3) transform_type[i];
      if (guard_band_flag[i]) {
          unsigned int(1) gb_not_used_for_pred_flag[i];
          unsigned int(3) gb_type[i];
          bit(1) reserved = 0;
          unsigned int(8) left_gb_width[i];
          unsigned int(8) right_gb_width[i];
          unsigned int(8) top_gb_height[i];
          unsigned int(8) bottom_gb_height[i];
      }
      else {
        bit(5) reserved = 0;
      }
    }
  }
}
```

Semantics

num_regions specifies the number of packed regions. Value 0 is reserved.

proj_picture_width and proj_picture_height specify the width and height, respectively, of the projected picture. proj_picture_width and proj_picture_height shall be greater than 0.

guard_band_flag[i] equal to 0 specifies that the i-th packed region does not have a guard band.

guard_band_flag[i] equal to 1 specifies that the i-th packed region has a guard band.

packing_type[i] specifies the type of region-wise packing. packing_type[i] equal to 0 indicates rectangular region-wise packing. Other values are reserved.

left_gb_width[i] specifies the width of the guard band on the left side of the i-th region in units of two luma samples.

right_gb_width[i] specifies the width of the guard band on the right side of the i-th region in units of two luma samples.

top_gb_height[i] specifies the height of the guard band above the i-th region in units of two luma samples.

bottom_gb_height[i] specifies the height of the guard band below the i-th region in units of two luma samples.

When guard_band_flag[i] is equal to 1, left_gb_width[i], right_gb_width[i], top_gb_height[i], or bottom_gb_height[i] shall be greater than 0.

The i-th packed region as specified by this RegionWisePackingStruct shall not overlap with any other packed region specified by the same RegionWisePackingStruct or any guard band specified by the same RegionWisePackingStruct.

The guard bands associated with the i-th packed region, if any, as specified by this RegionWisePackingStruct shall not overlap with any packed region specified by the same RegionWisePackingStruct or any other guard bands specified by the same RegionWisePackingStruct.

gb_not_used_for_pred_flag[i] equal to 0 specifies that the guard bands may or may not be used in the inter prediction process. gb_not_used_for_pred_flag[i] equal to 1 specifies that the sample values of the guard bands are not in the inter prediction process.

NOTE 1: When gb_not_used_for_pred_flag[i] is equal to 1, the sample values within guard bands in decoded pictures can be rewritten even if the decoded pictures were used as references for inter prediction of subsequent pictures to be decoded. For example, the content of a packed region can be seamlessly expanded to its guard band with decoded and re-projected samples of another packed region.

gb_type[i] specifies the type of the guard bands for the i-th packed region as follows:
gb_type[i] equal to 0 specifies that the content of the guard bands in relation to the content of the packed regions is unspecified. gb_type shall not be equal to 0, when gb_not_used_for_pred_flag is equal to 0.
gb_type[i] equal to 1 specifies that the content of the guard bands suffices for interpolation of sub-pixel values within the packed region and less than one pixel outside of the boundary of the packed region.

NOTE 2: gb_type equal to 1 can be used when the boundary samples of a packed region have been copied horizontally or vertically to the guard band.
gb_type[i] equal to 2 specifies that the content of the guard bands represents actual image content at quality that gradually changes from the picture quality of the packed region to that of the spherically adjacent packed region.
gb_type[i] equal to 3 specifies that the content of the guard bands represents actual image content at the picture quality of the packed region.
gb_type[i] values greater than 3 are reserved.

proj_reg_width[i], proj_reg_height[i], proj_reg_top[i] and proj_reg_left[i] are indicated in units of pixels in a projected picture with width and height equal to proj_picture_width and proj_picture_height, respectively.

proj_reg_width[i] specifies the width of the i-th projected region proj_reg_width[i] shall be greater than 0.

proj_reg_height[i] specifies the height of the i-th projected region proj_reg_height[i] shall be greater than 0.

proj_reg_top[i] and proj_reg_left[i] specify the top sample row and the left-most sample column in the projected picture. The values shall be in the range from 0, inclusive, indicating the top-left corner of the projected picture, to proj_picture_height-2, inclusive, and proj_picture_width −2, inclusive, respectively.

proj_reg_width[i] and proj_reg_left[i] shall be constrained such that proj_reg_width[i]+proj_reg_left[i] is less than proj_picture_width.

proj_reg_height[i] and proj_reg_top[i] shall be constrained such that proj_reg_height[i]+proj_reg_top[i] is less than proj_picture_height.

When the projected picture is stereoscopic, proj_reg_width[i], proj_reg_height[i], proj_reg_top[i] and proj_reg_left[i] shall be such that the projected region identified by these fields is within a single constituent picture of the projected picture.

transform_type[i] specifies the rotation and mirroring that has been applied to the i-th projected region to map it to the packed picture before encoding. When transform_type[i] specifies both rotation and mirroring, rotation has been applied after mirroring in the region-wise packing from the projected picture to the packed picture before encoding. The following values are specified and other values are reserved:

0: no transform

1: mirroring horizontally

2: rotation by 180 degrees (counter-clockwise)

3: rotation by 180 degrees (counter-clockwise) after mirroring horizontally

4: rotation by 90 degrees (counter-clockwise) after mirroring horizontally

5: rotation by 90 degrees (counter-clockwise)

6: rotation by 270 degrees (counter-clockwise) after mirroring horizontally

7: rotation by 270 degrees (counter-clockwise)

NOTE 3: [Clause 5.4 Conversion of sample locations for rectangular region-wise packing of Choi] specifies the semantics of transform_type[i] for converting a sample location of a packed region in a packed picture to a sample location of a projected region in a projected picture.

packed_reg_width[i], packed_reg_height[i], packed_reg_top[i], and packed_reg_left[i] specify the width, height, the top sample row, and the left-most sample column, respectively, of the packed region in the packed picture.

The values of packed_reg_width[i], packed_reg_height[i], packed_reg_top[i], and packed_reg_left[i] are constrained as follows:

packed_reg_width[i] and packed_reg_height[i] shall be greater than 0.

packed_reg_top[i] and packed_reg_left[i] shall in the range from 0, inclusive, indicating the top-left corner of the packed picture, to PackedPicHeight−2, inclusive, and PackedPicWidth−2, inclusive, respectively.

The sum of packed_reg_width[i] and packed_reg_left[i] shall be less than PackedPicWidth.

The sum of packed_reg_height[i] and packed_reg_top[i] shall be less than PackedPicHeight.

The rectangle specified by packed_reg_width[i], packed_reg_height[i], packed_reg_top[i], and packed_reg_left[i] shall be non-overlapping with the rectangle specified by packed_reg_width[j], packed_reg_height[j], packed_reg_top[j], and packed_reg_left[j] for any value of j in the range of 0 to i−1, inclusive.

In one example, according to the techniques described herein, media presentation description generator 502 may be configured to generate a content coverage descriptor. In one example, a content coverage descriptor may be based on the following example definition:

A content coverage (CC) SupplementalProperty element with a @schemeIdUri attribute equal to “urn:mpeg:omaf:cc:2017” may be present at adaptation set level (i.e. directly in an AdaptationSet element) and shall not be present in other levels (i.e. shall not be present at the MPD level or directly in any Representation element). The @value of the CC descriptor with @schemeIdUri equal to “urn:mpeg:omaf:cc:2017” is a comma separated list of values as specified in Table 8A. The CC descriptor indicates that each Representation covers the sphere region as specified in clause 7.4.2 of Choi by shape_type and syntax elements center_yaw, center_pitch, center_roll, hor_range, and ver_range in SphereRegionStruct as included in the CC descriptor.

TABLE 8A

| @value parameter | | |
|---|---|---|
| for CC descriptor | Use | Description |
| shape_type | O | Specifies the shape type of the sphere region, as specified in 7.4.2.3 of Choi, |
| | | that is covered by each Representation. |
| | | When not present shape_type is inferred to be equal to 0. |
| | | In an alternative example: When not present shape_type is inferred to be equal |
| | | to 1. |
| center_yaw | O | Specifies the yaw of the center point of the sphere region in degrees relative to |
| | | the global coordinate axes. |
| | | When not present center_yaw is inferred to be equal to 0. |
| center_pitch | O | Specifies the pitch of the center point of the sphere region in degrees relative |
| | | to the global coordinate axes. |
| | | When not present center_pitch is inferred to be equal to 0. |
| center_roll | O | Specifies the roll of the sphere region in degrees relative to the global |
| | | coordinate axes. |
| | | When not present center_roll is inferred to be equal to 0. |
| hor_range | O | Specifies the horizontal range of the sphere region through the center point of |
| | | the sphere region. |
| | | When not present hor_range is inferred to be equal to 360 * 2¹⁶. |
| | | In an alternative example: When not present hor_range is inferred to be equal |
| | | to 180 * 2¹⁶. |
| | | In an alternative example: When not present hor_range is inferred to be equal |
| | | to 720 * 2¹⁶. |
| ver_range | O | Specifies the vertical range of the sphere region through the center point of the |
| | | sphere region. |
| | | When not present ver_range is inferred to be equal to 180 * 2¹⁶. |
| | | In an alternative example: When not present ver_range is inferred to be equal |
| | | to 90 * 2¹⁶. |
| | | In an alternative example: When not present ver_range is inferred to be equal |
| | | to 360 * 2¹⁶. |

In one example, the CC descriptor may be subject to the following constraints:

At most one CC descriptor may be present at adaptation set level (i.e. directly in an AdaptationSet element).

The absence of a CC descriptor or absence of @value in CC descriptor indicates that each Representation covers the entire sphere when a PF descriptor is present either in the MPD level or the Representation or the containing Adaptation Set.

In one example, the @ value of the CC descriptor with @ schemeIdUri equal to “urn:mpeg:omaf:cc:2017” is a comma separated list of values as specified in Table 8B.

TABLE 8B

| @value parameter | | |
|---|---|---|
| for CC descriptor | Use | Description |
| shape_type | M | Specifies the shape type of the sphere region, as specified in 7.4.2.3 of Choi, |
| | | that is covered by each Representation. |
| center_yaw | M | Specifies the yaw of the center point of the sphere region in degrees relative |
| | | to the global coordinate axes. |
| center_pitch | M | Specifies the pitch of the center point of the sphere region in degrees relative |
| | | to the global coordinate axes. |
| center_roll | M | Specifies the roll of the sphere region in degrees relative to the global |
| | | coordinate axes. |
| hor_range | M | Specifies the horizontal range of the sphere region through the center point of |
| | | the sphere region. |
| ver_range | M | Specifies the vertical range of the sphere region through the center point of |
| | | the sphere region. |
| view_idc | O | 0 indicates that the sphere region is monoscopic, 1 indicates that the sphere |
| | | region is on the left view of stereoscopic content, 2 indicates the sphere |
| | | region is on the right view of stereoscopic content, 3 indicates that the sphere |
| | | region is on both the left and right views. When not present view_idc is |
| | | inferred to be equal to 0. |
| | | In another example: when not present view_idc is inferred to be equal to 3. |
| | | In another example: when not present view_idc is inferred to be unknown. |

In one example, the @ value of the CC descriptor with @ schemeIdUri equal to “urn:mpeg:omaf:cc:2017” is a comma separated list of values as specified in Table 8C.

TABLE 8C

| @value parameter | | |
|---|---|---|
| for CC descriptor | Use | Description |
| shape_type | O | Specifies the shape type of the sphere region, as specified in 7.4.2.3 of Choi, |
| | | that is covered by each Representation. When not present shape_type is |
| | | inferred to be equal to 0. |
| | | In an alternative example: When not present shape_type is inferred to be equal |
| | | to 1. |
| center_yaw | O | Specifies the yaw of the center point of the sphere region in degrees relative to |
| | | the global coordinate axes. When not present center_yaw is inferred to be |
| | | equal to 0. |
| center_pitch | O | Specifies the pitch of the center point of the sphere region in degrees relative |
| | | to the global coordinate axes. When not present center_pitch is inferred to be |
| | | equal to 0. |
| center_roll | O | Specifies the roll of the sphere region in degrees relative to the global |
| | | coordinate axes. When not present center_roll is inferred to be equal to 0. |
| hor_range | O | Specifies the horizontal range of the sphere region through the center point of |
| | | the sphere region. When not present hor_range is inferred to be equal to |
| | | 360 * 2¹⁶. |
| | | In an alternative example: When not present hor_range is inferred to be equal |
| | | to 180 * 2¹⁶. |
| | | In an alternative example: When not present hor_range is inferred to be equal |
| | | to 720 * 2¹⁶. |
| ver_range | O | Specifies the vertical range of the sphere region through the center point of the |
| | | sphere region. When not present ver_range is inferred to be equal to 180 * 2¹⁶. |
| | | In an alternative example: When not present ver_range is inferred to be equal |
| | | to 90 * 2¹⁶. |
| | | In an alternative example: When not present ver_range is inferred to be equal |
| | | to 360 * 2¹⁶. |
| view_idc | O | 0 indicates that the sphere region is monoscopic, 1 indicates that the sphere |
| | | region is on the left view of stereoscopic content, 2 indicates the sphere region |
| | | is on the right view of stereoscopic content, 3 indicates that the sphere region |
| | | is on both the left and right views. When not present view_idc is inferred to be |
| | | equal to 0. |
| | | In another example: when not present view_idc is inferred to be equal to 3. |
| | | In another example: when not present view_idc is inferred to be unknown. |

In one example, according to the techniques described herein, media presentation description generator 502 may be configured to generate a region-wise quality ranking descriptor. In one example, a region-wise quality ranking descriptor may be based on the following example definition. It should be noted that the following example definition includes the following aspects: A constraint is proposed that shape_type shall be the same for each RWQR descriptor in an adaptation set; Parameters: center_yaw, center_pitch, center_roll, hor_range, ver_range be not present when ra_flag is equal to 1; and one or more RWQR descriptor to be present at adaptation set level.

A region-wise quality ranking (RWQR) SupplementalProperty element with a @schemeIdUri attribute equal to “urn:mpeg:omaf:rwqr:2017” may be present at adaptation set level (i.e. directly in an AdaptationSet element) and shall not be present in other levels (i.e. shall not be present at the MPD level or directly in any Representation element). The @value of the RWQR descriptor with @schemeIdUri equal to “urn:mpeg:omaf:rwqr:2017” is a comma separated list of values as specified in Table 9. The RWQR descriptor indicates a quality ranking value of a quality ranking sphere region relative to other quality ranking sphere regions in the same Adaptation Set and relative to RWQR descriptors and @qualityRanking values in all Adaptation Sets that have the same @ value in the DASH Viewpoint element as the Adaptation Set containing this RWQR descriptor. The sphere region for the quality-ranking is specified as specified in clause 7.4 of Choi by syntax elements shape_type, center_yaw, center_pitch, center_roll, hor_range, ver_range in SphereRegionStruct. When the quality ranking value is non-zero, the picture quality within the entire indicated quality ranking sphere region is approximately constant.

TABLE 9

| @value parameter for | | |
|---|---|---|
| RWQR descriptor | Use | Description |
| shape_type | M | Value 0 specifies that the quality ranking sphere region is indicated |
| | | through four great circles as specified in clause 7.4 of Choi. Value 1 |
| | | specifies that the quality ranking sphere region is indicated through two |
| | | yaw and two pitch circles as specified in clause 7.4 of Choi. |
| | | shape_type shall have the same value in each RWQR descriptor in an |
| | | adaptation set (i.e. in an AdaptationSet element). |
| quality_ranking | M | specifies a quality ranking value of the quality ranking sphere region. |
| | | quality_ranking equal to 0 indicates that the quality ranking is not defined. |
| | | When quality ranking sphere region A has a non-zero quality_ranking |
| | | value less than the quality_ranking value of quality ranking sphere region |
| | | B, quality ranking sphere region A has a higher quality than quality |
| | | ranking sphere region B. When quality ranking sphere region A partly or |
| | | entirely overlaps with quality ranking sphere region B, quality_ranking of |
| | | quality ranking sphere region A shall be equal to quality_ranking of quality |
| | | ranking sphere region B. |
| view_idc | M | 0 indicates that the content is monoscopic, 1 indicates that the quality |
| | | ranking sphere region is on the left view of stereoscopic content, 2 |
| | | indicates that the quality ranking sphere region is on the right view of |
| | | stereoscopic content, 3 indicates that the quality ranking sphere region is |
| | | on both the left and right views. |
| ra_flag | M | Value 0 specifies that center_yaw, center_pitch, center_roll, hor_range, |
| | | and ver_range are present. Value 1 specifies that center_yaw, center_pitch, |
| | | center_roll, hor_range, and ver_range are not present and that the quality |
| | | ranking sphere region is the area not covered by any other quality ranking |
| | | sphere regions defined by RWQR descriptors included in the same |
| | | element. ra_flag shall not be equal to 1 in more than one RWQR |
| | | descriptor in the same element. |
| center_yaw | CM | Specifies the yaw of the center point the quality ranking sphere region in |
| | | degrees relative to the global coordinate axes. center_yaw shall be present |
| | | when ra_flag is equal to 0. center_yaw shall be absent when ra_flag is |
| | | equal to 1. |
| center_pitch | CM | Specifies the pitch of the center point the quality ranking sphere region in |
| | | degrees relative to the global coordinate axes. center_pitch shall be present |
| | | when ra_flag is equal to 0. center_pitch shall be absent when ra_flag is |
| | | equal to 1. |
| center_roll | CM | Specifies the roll angle for the quality ranking sphere region in degrees |
| | | relative to the global coordinate axes. center_roll shall be present when |
| | | ra_flag is equal to 0. center_roll shall be absent when ra_flag is equal to 1. |
| hor_range | CM | Specifies the horizontal range of the quality ranking sphere region through |
| | | its center point. hor_range shall be present when ra_flag is equal to 0. |
| | | hor_range shall be absent when ra_flag is equal to 1. |
| ver_range | CM | Specifies the vertical range of the quality ranking sphere region through its |
| | | center point. ver_range shall be present when ra_flag is equal to 0. |
| | | ver_range shall be absent when ra_flag is equal to 1. |

In one example, the RWQR descriptor may be subject to the following:

One or more RWQR descriptor may be present at adaptation set level (i.e. directly in an AdaptationSet element).

It should be noted that with respect to Table 9 the flag ra_flag may be instead called remaining_area_flag. In that case the semantics of other elements in Table 9 (e.g. shape_type, quality_ranking, view_idc, center_yaw, center_pitch, center_roll, hor_range, ver_range) will be changed to use and refer to the remaining_area_flag instead of ra_flag.

In one example, according to the techniques described herein, a region-wise quality ranking descriptor may be based on the following example definition:

A region-wise quality ranking (RWQR) SupplementalProperty element with a @schemeIdUri attribute equal to “urn:mpeg:omaf:rwqr:2017” may be present at adaptation set level (i.e., directly in an AdaptationSet element) and shall not be present in other levels (i.e. shall not be present at MPD level or directly in any Representation element). The @value of the RWQR descriptor with @schemeIdUri equal to “urn:mpeg:omaf:rwqr:2017” is a comma separated list of values as specified in Table 10. The RWQR descriptor indicates a quality ranking value of all quality ranking sphere regions relative to each other and relative to @qualityRanking values in all Adaptation Sets that have the same @ value in the DASH Viewpoint element as the Adaptation Set containing this RWQR descriptor. The sphere region for the quality-ranking is specified as specified in clause 7.4 of Choi by syntax elements shape_type, center_yaw, center_pitch, center_roll, hor_range, ver_range in SphereRegionStruct. When the quality ranking value is non-zero, the picture quality within the entire indicated quality ranking sphere region is approximately constant.

TABLE 10

| @value parameter for | | |
|---|---|---|
| RWQR descriptor | Use | Description |
| shape_type | M | Value 0 specifies that the quality ranking sphere region is indicated |
| | | through four great circles as specified in clause 7.4 of Choi. Value 1 |
| | | specifies that the quality ranking sphere region is indicated through two |
| | | yaw and two pitch circles as specified in clause 7.4 of Choi. |
| remaining_area_flag | M | Value 0 specifies that all the quality ranking sphere regions are defined by |
| | | signaled center_yaw, center_pitch, center_roll, hor_range, and ver_range. |
| | | Value 1 specifies that the all except the last (i.e. first num_regions−1) |
| | | quality ranking sphere regions are defined by signaled center_yaw, |
| | | center_pitch, center_roll, hor_range, ver_range and the last remaining |
| | | quality ranking sphere region is the sphere region within coverage area, not |
| | | covered by union of quality ranking sphere regions defined by signaled |
| | | center_yaw, center_pitch, center_roll, hor_range, and ver_range. |
| view_idc_presence_flag | M | Value 0 specifies that view_idc is not signaled. Value 1 specifies that |
| | | view_idc is signaled and indicates the association of region with particular |
| | | (left or right or both) views or monoscopic content. |
| default_view_idc | CM | Value 0 indicates that all the regions are monoscopic. Value 1 indicates |
| | | that all the regions are on the left view of stereoscopic content. Value 2 |
| | | indicates that all the regions are on the right view of stereoscopic content |
| | | Value 3 indicates that all the regions are on both the left and right views. |
| | | default_view_idc shall be present when view_idc_presence_flag is equal to |
| | | 0. default_view_idc shall be absent when view_idc_presence_flag is equal |
| | | to 1. |

Followed by a comma separated list of set of values specified below and which are comma separated and each
set of values is enclosed inside delimiters “{” (i.e. % x7B) and “}” (i.e. % x7D).

| | | |
|---|---|---|
| quality_ranking | M | specifies a quality ranking value of the quality ranking sphere region. |
| | | quality_ranking equal to 0 indicates that the quality ranking is not defined. |
| | | When quality ranking sphere region A has a non-zero quality_ranking |
| | | value less than the quality_ranking value of quality ranking sphere region |
| | | B, quality ranking sphere region A has a higher quality than quality |
| | | ranking sphere region B. When quality ranking sphere region A partly or |
| | | entirely overlaps with quality ranking sphere region B, quality_ranking of |
| | | quality ranking sphere region A shall be equal to quality_ranking of |
| | | quality ranking sphere region B. |
| view_idc | CM | 0 indicates that the content is monoscopic, 1 indicates that the quality |
| | | ranking sphere region is on the left view of stereoscopic content, 2 |
| | | indicates that the quality ranking sphere region is on the right view of |
| | | stereoscopic content, 3 indicates that the quality ranking sphere region is |
| | | on both the left and right views. view_idc shall be present when |
| | | view_idc_presence_flag is equal to 1. view_idc shall be absent when |
| | | view_idc_presence_flag is equal to 0. |
| center_yaw | CM | Specifies the yaw of the center point the quality ranking sphere region in |
| | | degrees relative to the global coordinate axes. center_yaw shall be present |
| | | when remaining_area_flag is equal to 0. center_yaw shall be absent from |
| | | only the last set of values enclosed inside the delimiters “{” and “}” and |
| | | shall be present in all the other set of values when remaining_area_flag is |
| | | equal to 1. |
| center_pitch | CM | Specifies the pitch of the center point the quality ranking sphere region in |
| | | degrees relative to the global coordinate axes. center_pitch shall be present |
| | | when remaining_area_flag is equal to 0. center_pitch shall be absent from |
| | | only the last set of values enclosed inside the delimiters “{” and “}” and |
| | | shall be present in all the other set of values when remaining_area_flag is |
| | | equal to 1. |
| center_roll | CM | Specifies the roll angle for the quality ranking sphere region. center_roll |
| | | shall be present when remaining_area_flag is equal to 0. center_roll shall |
| | | be absent from only the last set of values enclosed inside the delimiters “{” |
| | | and “}” and shall be present in all the other set of values when |
| | | remaining_area_flag is equal to 1. |
| hor_range | CM | Specifies the horizontal range of the quality ranking sphere region through |
| | | its center point. hor_range shall be present when remaining_area_flag is |
| | | equal to 0. hor_range shall be absent from only the last set of values |
| | | enclosed inside the delimiters “{” and “}” and shall be present in all the |
| | | other set of values when remaining_area_flag is equal to 1. |
| ver_range | CM | Specifies the vertical range of the quality ranking sphere region through its |
| | | center point. ver_range shall be present when remaining_area_flag is equal |
| | | to 0. ver_range shall be absent from only the last set of values enclosed |
| | | inside the delimiters “{” and “}” and shall be present in all the other set of |
| | | values when remaining_area_flag is equal to 1. |

In one example, the RWQR descriptor may be subject to the following:

At most one RWQR descriptor may be present at adaptation set level (i.e. directly in an AdaptationSet element).

With respect to table 10 (and Table 11) it should be noted that instead of the delimiters “{” (i.e. %×7B) and “}” (i.e. %×7D) some other delimiters could be used. For example delimiters “(” and “)” or delimiters “[” and “]” may be used.

For ISO base media file format Segments:

shape_type, shall be equal to region_definition_type of SphereRegionQualityRankingBox when present in the sample entries of the Initialization Segment,

remaining_area_flag, shall be equal to remaining_area_flag of SphereRegionQualityRankingBox when present in the sample entries of the Initialization Segment,

view_idc_presence_flag, shall be equal to view_idc_presence_flag of SphereRegionQualityRankingBox when present in the sample entries of the Initialization Segment,

default_view_idc, shall be equal to default_view_idc of SphereRegionQualityRankingBox when present in the sample entries of the Initialization Segment,

and the values of quality_ranking, view_idc, center_yaw, center_pitch, center_roll hor_range, ver_range in set of values enclosed inside delimiters “{” and “}” shall be equal to quality_ranking, view_idc, center_yaw, center_pitch, center_roll, hor_range, ver_range respectively for each value of i in SphereRegionQualityRankingBox when present in the sample entries of the Initialization Segment.

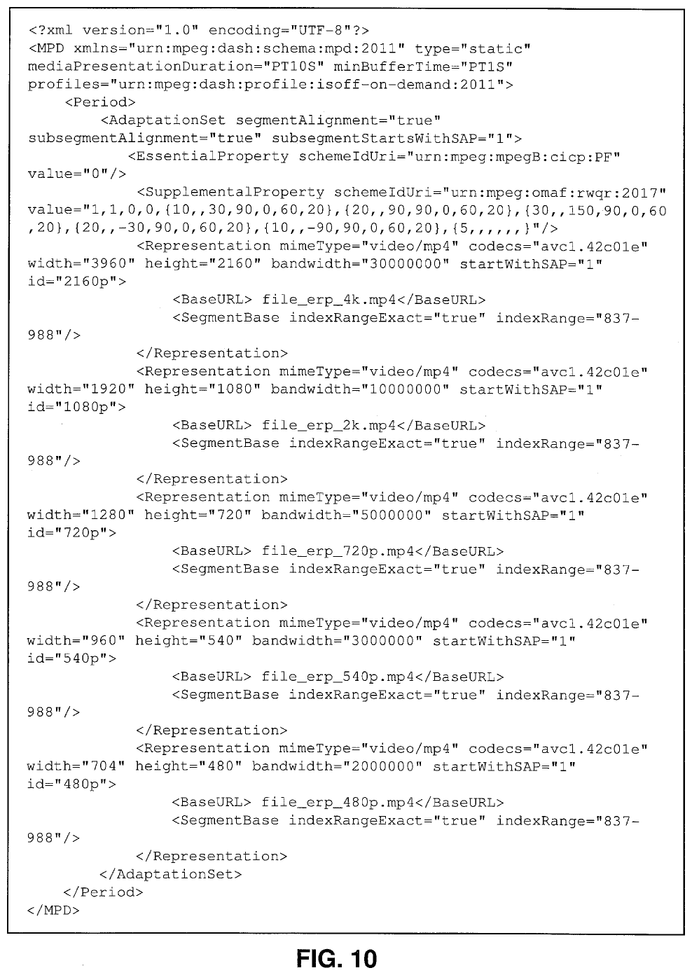

FIG. 10 is a computer program listing illustrating an example of signaling metadata according to one or more techniques of this disclosure. FIG. 10 illustrates MPD example snippets including a RWQR descriptor according to the techniques described herein. It should be noted that with respect to FIG. 10 that enclosing comma separated values inside delimiters provides for compact and efficient coding.

With respect to Table 10, it should be noted that in one example, center_roll may be signaled as a single parameter applicable to all the quality ranking sphere regions. This results in bit savings as compared to signaling center_roll separately for each quality ranking sphere region, as provide in Choi as described above with respect to Table 5. Table 11 below illustrates a modification to Table 10 where center_roll is signaled as a single parameter applicable to all the quality ranking sphere regions.

TABLE 11

| @value parameter for | | |
|---|---|---|
| RWQR descriptor | Use | Description |
| shape_type | M | Value 0 specifies that the quality ranking sphere region is indicated |
| | | through four great circles as specified in clause 7.3. Value 1 specifies that |
| | | the quality ranking sphere region is indicated through two yaw and two |
| | | pitch circles as specified in clause 7.3. |
| remaining_area_flag | M | Value 0 specifies that all the quality ranking sphere regions are defined by |
| | | signaled center_yaw, center_pitch, center_roll, hor_range, and ver_range. |
| | | Value 1 specifies that the all except the last (i.e. first num_regions−1) |
| | | quality ranking sphere regions are defined by signaled center_yaw, |
| | | center_pitch, center_roll, hor_range, ver_range and the last remaining |
| | | quality ranking sphere region is the sphere region within coverage area, not |
| | | covered by union of quality ranking sphere regions defined by signaled |
| | | center_yaw, center_pitch, center_roll, hor_range, and ver_range. |
| center_roll | CM | Specifies the roll angle for the quality ranking sphere regions. center_roll |
| | | shall be present and applies to all quality ranking sphere regions when |
| | | remaining_area_flag is equal to 0. center_roll shall be absent when |
| | | remaining_area_flag is equal to 1. |
| view_idc_presence_flag | M | Value 0 specifies that view_idc is not signaled. Value 1 specifies that |
| | | view_idc is signaled and indicates the association of region with particular |
| | | (left or right or both) views or monoscopic content. |
| default_view_idc | CM | Value 0 indicates that all the regions are monoscopic. Value 1 indicates |
| | | that all the regions are on the left view of stereoscopic content. Value 2 |
| | | indicates that all the regions are on the right view of stereoscopic content |
| | | Value 3 indicates that all the regions are on both the left and right views. |
| | | default_view_idc shall be present when view_idc_presence_flag is equal to |
| | | 0. default_view_idc shall be absent when view idc_presence_flag is equal |
| | | to 1. |

Followed by a comma separated list of set of values specified below and which are comma separated and each
set of values is enclosed inside delimiters “{” (i.e. % x7B) and “}” (i.e. % x7D).

| | | |
|---|---|---|
| quality_ranking | M | specifies a quality ranking value of the quality ranking sphere region. |
| | | quality_ranking equal to 0 indicates that the quality ranking is not defined. |
| | | When quality ranking sphere region A has a non-zero quality_ranking |
| | | value less than the quality_ranking value of quality ranking sphere region |
| | | B, quality ranking sphere region A has a higher quality than quality |
| | | ranking sphere region B. When quality ranking sphere region A partly or |
| | | entirely overlaps with quality ranking sphere region B, quality_ranking of |
| | | quality ranking sphere region A shall be equal to quality_ranking of |
| | | quality ranking sphere region B. |
| view_idc | CM | 0 indicates that the content is monoscopic, 1 indicates that the quality |
| | | ranking sphere region is on the left view of stereoscopic content, 2 |
| | | indicates that the quality ranking sphere region is on the right view of |
| | | stereoscopic content, 3 indicates that the quality ranking sphere region is |
| | | on both the left and right views. view_idc shall be present when |
| | | view_idc_presence_flag is equal to 1. view_idc shall be absent when |
| | | view_idc_presence_flag is equal to 0. |
| center_yaw | CM | Specifies the yaw of the center point the quality ranking sphere region in |
| | | degrees relative to the global coordinate axes. center_yaw shall be present |
| | | when remaining_area_flag is equal to 0. center_yaw shall be absent from |
| | | only the last set of values enclosed inside the delimiters “{” and “}” and |
| | | shall be present in all the other set of values when remaining_area_flag is |
| | | equal to 1. |
| center_pitch | CM | Specifies the pitch of the center point the quality ranking sphere region in |
| | | degrees relative to the global coordinate axes. center_pitch shall be present |
| | | when remaining_area_flag is equal to 0. center_pitch shall be absent from |
| | | only the last set of values enclosed inside the delimiters “{” and “}” and |
| | | shall be present in all the other set of values when remaining_area_flag is |
| | | equal to 1. |
| hor_range | CM | Specifies the horizontal range of the quality ranking sphere region through |
| | | its center point. hor_range shall be present when remaining_area_flag is |
| | | equal to 0. hor_range shall be absent from only the last set of values |
| | | enclosed inside the delimiters “{” and “}” and shall be present in all the |
| | | other set of values when remaining_area_flag is equal to 1. |
| ver_range | CM | Specifies the vertical range of the quality ranking sphere region through its |
| | | center point. ver_range shall be present when remaining_area_flag is equal |
| | | to 0. ver_range shall be absent from only the last set of values enclosed |
| | | inside the delimiters “{” and “}” and shall be present in all the other set of |
| | | values when remaining_area_flag is equal to 1. |

In one example according to the techniques described herein, media presentation description generator 502 may be configured to signal spherical region-wise quality ranking based on the following definition, syntax, and semantics:

Definition

Box type: ‘srqr’

Container: VisualSampleEntry

Mandatory (per an item): No

Quantity (per an item): At most one for each region_definition_type value

Syntax

```
aligned(8) class SphereRegionQualityRankingBox extends
FullBox(′srqr′, 0, 0) {
  unsigned int(8) region_definition_type;
  unsigned int(8) num_regions;
  unsigned int(1) remaining_area_flag;
  unsigned int(1) view_idc_presence_flag;
  if (view_idc_presence_flag == 0) {
    unsigned int(2) default_view_idc;
    bit(4) reserved = 0;
  }
  else {
    bit(6) reserved = 0;
  }
  for (i = 0; i < num_regions; i++) {
    unsigned int(8) quality ranking;
    if (view_idc_presence_flag == 1) {
      unsigned int(2) view_idc;
      bit(6) reserved = 0;
    }
    if ((i < (num_regions − 1)) ∥ (remaining_area_flag == 0))
      SphereRegionStruct(1);
  }
}
```

Semantics

region_definition_type has identical semantics to shape_type of SphereRegionConfigBox.

num_regions specifies the number of quality ranking regions for which the quality ranking information is given in this box. Value 0 is reserved. There shall be no point on the sphere that is contained in more than one of these quality ranking sphere regions.

remaining_area_flag equal to 0 specifies that all the quality ranking regions are defined by the SphereRegionStruct(1) structures. remaining_area_flag equal to 1 specifies that the first num_regions−1 quality ranking regions are defined by SphereRegionStruct(1) structure and the last remaining quality ranking region is the sphere region within coverage area, not covered by the union of the quality ranking regions defined by the first num_regions−1 SphereRegionStruct(1) structures.

SphereRegionStruct(1) specifies the spherical location and size of the quality ranking region relative to the global coordinate axes, while the shape of the quality ranking regions is indicated by region_definition_type. The value of interpolate in SphereRegionStruct(1) shall be equal to 0.

view_idc_presence_flag equal to 0 specifies that view_idc is not present. view_idc_presence_flag equal to 1 specifies that view_idc is present and indicates the association of quality ranking region with particular (left or right or both) views or monoscopic content.

default_view_idc equal to 0 indicates that the quality ranking region is monoscopic, 1 indicates that the quality ranking region is on the left view of stereoscopic content, 2 indicates that the quality ranking region is on the right view of stereoscopic content, 3 indicates that the quality ranking region is on both the left and right views.

quality_ranking specifies a quality ranking value of the quality ranking region. quality_ranking equal to 0 indicates that the quality ranking value is not defined. The semantics of non-zero quality ranking values are specified in [Clause 7.6.1 of Choi].

view_idc equal to 0 indicates that the quality ranking region is monoscopic, 1 indicates that the quality ranking region is on the left view of stereoscopic content, 2 indicates that the quality ranking region is on the right view of stereoscopic content, 3 indicates that the quality ranking region is on both the left and right views. When not present, the value of view_idc is inferred to be equal to the value of default view_idc.

In one example according to the techniques described herein, media presentation description generator 502 may be configured to signal 2D region-wise quality ranking based on the following definition, syntax, and semantics:

Definition

Box type: ‘2dqr’

Container: VisualSampleEntry

Mandatory (per an item): No

Quantity (per an item): Zero or one

Syntax

```
aligned(8) class 2DRegionQualityRankingBox extends FullBox(′2dqr′,
0, 0) {
  unsigned int(8) num_regions;
  unsigned int(1) remaining_area_flag;
  unsigned int(1) view_idc_presence_flag;
  if (view_idc_presence_flag == 0) {
    unsigned int(2) default_view_idc;
    bit(4) reserved = 0;
  }
  else {
  bit(6) reserved = 0;
  for (i = 0; i < num_regions; i++) {
    unsigned int(8) quality_ranking;
    if (view_idc_presence_flag == 1) {
      unsigned int(2) view_idc;
      bit(6) reserved = 0;
    }
    if ((i < (num_regions - 1)) ∥ (remaining_area_flag == 0)) {
      unsigned int(16) left_offset;
      unsigned int(16) top_offset;
      unsigned int(16) region_width;
      unsigned int(16) region_height;
    }
  }
}
```

Semantics

quality_ranking and default_view_idc, and view_idc are specified identically to the syntax elements with the same names in SphereRegionQualityRankingBox. Thus, the semantics of these may be as follows:
quality_ranking specifies a quality ranking value of the quality ranking region. quality_ranking equal to 0 indicates that the quality ranking value is not defined. The semantics of non-zero quality ranking values are specified in 7.6.1 of Choi.

default_view_idc equal to 0 indicates that the quality ranking region is monoscopic, 1 indicates that the quality ranking region is on the left view of stereoscopic content, 2 indicates that the quality ranking region is on the right view of stereoscopic content, 3 indicates that the quality ranking region is on both the left and right views.

view_idc equal to 0 indicates that the quality ranking region is monoscopic, 1 indicates that the quality ranking region is on the left view of stereoscopic content, 2 indicates that the quality ranking region is on the right view of stereoscopic content, 3 indicates that the quality ranking region is on both the left and right views. When not present, the value of view_idc is inferred to be equal to the value of default_view_idc.

num_regions specifies the number of quality ranking 2D regions for which the quality ranking information is given in this box. Value 0 is reserved. There shall be no pixel of the decoded picture that is contained in more than one of these quality ranking 2D regions.

remaining_area_flag equal to 0 specifies that all the quality ranking 2D regions are defined by the left_offset, top_offset, region_width, and region_height. remaining_area_flag equal to 1 specifies that the first num_regions−1 quality ranking 2D regions are defined by left_offset, top_offset, region_width, and region_height and the last remaining quality ranking 2D region is the area in the picture with width equal to width of VisualSampleEntry and height equal to height of VisualSampleEntry, not covered by the union of the first num_regions−1 quality ranking 2D regions.

left_offset, top_offset, region_width, and region_height are integer values that indicate the position and size of the quality ranking 2D region. left_offset and top_offset indicate the horizontal and vertical coordinates, respectively, of the upper left corner of the quality ranking 2D region within the picture in visual presentation size of 2D representation. region_width and region_height indicate the width and height, respectively, of the quality ranking 2D region within the picture in visual presentation size of 2D representation. left_offset+region_width shall be less than width of TrackHeaderBox. top_offset+region_height shall be less than height of TrackHeaderBox.

region_width shall be greater than 0.

region_height shall be greater than 0.

In one example, according to the techniques described herein, media presentation description generator 502 may be configured to signal stereo frame packing information based on the following definition:

A DASH FramePacking element with a @ schemeIdUri attribute equal to urn:mpeg:mpegB:cicp:VideoFramePackingType may be present at adaptation set level (i.e., directly in an AdaptationSet element) and shall not be present (i.e., directly in an AdaptationSet element) and shall not be present at other levels (i.e., shall not be present at MPD level or directly in any Representation element). When used with omnidirectional projected video (i.e., when the PF descriptor is present), this essential property descriptor indicates that the projected picture consists of spatially packed constituent pictures of the left and right views.

The @value of the FramePacking element specifies the frame packing type for the stereoscopic video. This value shall be equal to 3 or 4 with the meaning of those values as defined for VideoFramePackingType in ISO/IEC 23001-8.

It should be noted that ISO/IEC 23001-8, Part 8, “Coding-independent code points,” 2013 Jul. 1, which is incorporated by reference, includes a VideoFramePackingType having values 3 and 4 with a similar meaning to like values in Table D-8 of ITU-T H.265.

In one example, according to the techniques described herein, media presentation description generator 502 may be configured to signal timed metadata based on the following definition:

A timed metadata track, e.g., of sample entry type ‘invp’ or ‘rcvp’ as specified in clause 7.4 of Choi, may be encapsulated in a DASH representation. The @associationId attribute of this metadata representation shall contain the value of the attribute @id of the representation containing the omnidirectional media carried by the media track(s) that are associated with the timed metadata track as specified in clause 7.1.3.1 of Choi. The @associationType attribute of this metadata representation shall be equal to the track reference type through which the timed metadata track is associated with the media track(s) as specified in clause 7.1.3.1 of Choi.

In one example, according to the techniques described herein, media presentation description generator 502 may be configured to signal a track group type box based on the following definition, syntax, and semantics:

Definition

TrackGroupTypeBox with track_group_type equal to ‘spco’ indicates that this track belongs to a composition of tracks that can be spatially arranged to obtain composition pictures. The visual tracks mapped to this grouping (i.e. the visual tracks that have the same value of track_group_id within TrackGroupTypeBox with track_group_type equal to ‘spco’) collectively represent visual content that can be presented. Each individual visual track mapped to this grouping may or may not be intended to be presented alone without other visual tracks, while composition pictures are suitable to be presented.

NOTE 1: Content authors can use CompositionRestrictionBox, as specified in clause 7.1.2 [of Choi], to indicate that a visual track alone is not intended to be presented alone without other visual tracks.

NOTE 2: When an HEVC video bitstream is carried in a set of tile tracks and the associated tile base track, as specified in ISO/IEC 14496-15], and the bitstream represents a sub-picture indicated by a sub-picture composition track group, only the tile base track contains the SubPictureCompositionBox.

A composition picture can be derived by spatially arranging the decoding outputs of the time-parallel samples of all tracks of the same sub-picture composition track group as indicated by the syntax elements of the track group.

Syntax

```
aligned(8) class SubPictureCompositionBox extends TrackGroupTypeBox
(′spco′) {
  unsigned int(16) track_x;
  unsigned int(16) track_y;
  unsigned int(16) track_width;
  unsigned int(16) track_height;
  unsigned int(16) composition_width;
  unsigned int(16) composition_height;
  bit(6) reserved = 0;
  unsigned_int(2) view_idc;
}
```

Semantics

track_x specifies, in luma sample units, the horizontal position of the top-left corner of the samples of this track on the composition picture. The value of track_x shall be in the range of 0 to composition_width−1, inclusive.

track_y specifies, in luma sample units, the vertical position of the top-left corner of the samples of this track on the composition picture. The value of track_y shall be in the range of 0 to composition_height−1, inclusive.

track_width specifies, in luma sample units, the width of the samples of this track on the composition picture. The value of track_width shall be in the range of 1 to composition_width−1, inclusive.

track_height specifies, in luma sample units, the height of the samples of this track on the composition picture. The value of track_height shall be in the range of 1 to composition_height−1, inclusive.

composition_width specifies, in luma sample units, the width of the composition picture.

composition_height specifies, in luma sample units, the height of the composition picture.

For each value of i in the range of 0 to track_width−1, inclusive, the i-th column of luma samples of the samples of this track is the colComposedPic-th column of luma samples of the composition picture, where colComposedPic is equal to (i+track_x) % composition_width.

For each value of j in the range of 0 to track_height−1, inclusive, the j-th row of luma samples of the samples of this track is the rowComposedPic-th row of luma samples of the composition picture, where rowComposedPic is equal to (j+track_y) % composition_height.

view_idc equal to 0 indicates that samples of this track belong to monoscopic content, 1 indicates that the samples of this track belong to the left view of stereoscopic content, 2 indicates that the the samples of this track belong to the right view of stereoscopic content, 3 indicates that the the samples of this track belong to both the left and right views of stereoscopic content.

In another example, when view_idc is not equal to 0 or 1 or 2 (i.e. when view_idc is equal to 3) additional information may be signalled about composition of left and right views on the samples of this track. This may include one or more of the following:
Spatial arrangement of left and right views (e.g. side-by-side or top-bottom).
Left and top co-ordinates of each views.
Height and width of each views.

In another example, whenever a view_idc syntax element is signaled another syntax element view_idc_presence_flag may be signaled before it and the syntax element view_idc may be signaled only when view_idc_presence_flag is equal to 1. An example syntax for this is shown below:

bit(5) reserved = 0;
unsigned int(1) view_idc_presence_flag;
if (view_idc_presence_flag==1) {
unsigned_int(2) view_idc;
}

In this case: When not present view_idc is inferred to be equal to 0.

In another example: when not present view_idc is inferred to be equal to 3.

In another example: when not present view_idc is inferred to be unknown.

In another example according to the techniques described herein, media presentation description generator 502 may be configured to signal a view_idc and view_idc_presence_flag as shown above in the TrackCoverageInformationBox ‘covt’ of Choi.

As described above, Choi provides descriptors for signaling projection type and packing type information. In a similar manner, Choi_1 describes signaling for projection type information as follows:

An EssentialProperty element with a @ schemeIdUri attribute equal to “urn:mpeg:mpegB:cicp:PF” is referred to as a projection format (PF) descriptor. At most one PF descriptor may be present at MPD level. At most one PF descriptor may be present at adaptation set level. At most one PF desciptor may be present at representation level. The presence of the PF descriptor at MPD level indicates that all the representations of the media presentation carry projected omnidirectional video. The presence of the PF descriptor at adaptation set level indicates that all the representations of the adaptation set carry projected omnidirectional video. The @value of a PF descriptor present at a hierarchically lower level overrides that of a PF descriptor present at a hierarchically higher level. For example, when both an AdaptationSet element and a Representation element in the AdaptationSet element have a PF descriptor present, the PF descriptor present in the Representation element applies to the Representation. The @value of the PF descriptor is a comma separated list of values as specified in the Table 11A.

TABLE 11A

| @value parameter | | |
|---|---|---|
| for PF descriptor | Use | Description |
| projection_type | M | Specifies a comma separated list of projection |
| | | type values of the projected picture. |
| | | For ISO base media file format Segments, |
| | | each value in the list projection_type |
| | | shall be equal to projection_type |
| | | in ProjectionFormatBox in sample entries |
| | | of the Initialization Segment. |

Further, Choi_1 describes signaling of packing type information as follows:

An EssentialProperty element with a @schemeIdUri attribute equal to “urn:mpeg:omaf:rwpk:2017” is referred to as a region-wise packing (RWPK) descriptor. At most one RWPK descriptor may be present at MPD level. At most one RWPK descriptor may be present at adaptation set level. At most one RWPK descriptor may be present at representation level. The @ value of a RWPK descriptor present present at a hierarchically lower level overrides that of a RWPK descriptor present present at a hierarchically higher level. For example, when both an AdaptationSet element and a Representation element in the AdaptationSet element have a RWPK descriptor present, the RWPK descriptor present in the Representation element applies to the Representation. The @ value of the RWPK descriptor is a comma separated list of values as specified in the Table 11B.

TABLE 11B

| @value parameter | | |
|---|---|---|
| for RWPK | | |
| descriptor | Use | Description |
| packing_type | O | Specifies a comma separated list of the packing |
| | | type value of the picture. |
| | | For ISO base media file format Segments, |
| | | packing_type shall be equal to |
| | | packing_type in RegionWisePackingBox |
| | | in sample entries of the Initialization |
| | | Segment. When this @value parameter is |
| | | not present or does not include any value |
| | | in a RWPK descriptor, packing_type |
| | | is inferred to be equal to 0. |

The absence of a RWPK descriptor indicates that no region-wise packing has been applied.

Further, Choi_1 describes signaling of content coverage information as follows:

A SupplementalProperty element with a @ schemeIdUri attribute equal to “urn:mpeg:omaf:cc:2017” is referred to as a spherical spatial relationship (SSR) descriptor. At most one SSR descriptor may be present at adaptation set level. A SSR descriptor shall not be present at MPD or representation level. The SSR descriptor indicates that each Representation covers the sphere region as specified in clause 7.5 [of Choi_1] by shape_type and syntax elements center azimuth, center_elevation, center_tilt, hor_range, and ver_range in SphereRegionStruct as included in the SSR descriptor. The @value of the SSR descriptor is a comma separated list of values as specified in Table 11C.

TABLE 11C

| @value parameter | | |
|---|---|---|
| for SSR descriptor | Use | Description |
| view_idc | O | 0 indicates that the coverage sphere region is monoscopic, 1 indicates that the |
| | | coverage sphere region is on the left view of stereoscopic content, 2 indicates |
| | | the the coverage sphere region is on the right view of stereoscopic content, |
| | | and 3 indicates that the coverage sphere region is on both the left and right |
| | | views. |
| shape_type | O | Specifies the shape type of the coverage sphere region, as specified in 7.5.2.3 |
| | | [of Choi_1] When not present, shape_type is inferred to be equal to 0. |
| center_azimuth | O | Specifies the azimuth of the center point of the coverage sphere region in |
| | | degrees relative to the global coordinate axes. When not present, |
| | | center_azimuth is inferred to be equal to 0. |
| center_elevation | O | Specifies the elevation of the center point of the coverage sphere region in |
| | | degrees relative to the global coordinate axes. When not present, |
| | | center_elevation is inferred to be equal to 0. |
| center_tilt | O | Specifies the tilt angle of the coverage sphere region, in degrees, relative to |
| | | the global coordinate axes. When not present, center_tilt is inferred to be |
| | | equal to 0. |
| hor_range | O | Specifies the horizontal range of the coverage sphere region through the |
| | | center point of the coverage sphere region. When not present hor_range is |
| | | inferred to be equal to 360 * 2¹⁶. |
| ver_range | O | Specifies the vertical range of the coverage sphere region through the center |
| | | point of the coverage sphere region. When not present ver_range is inferred |
| | | to be equal to 180 * 2¹⁶. |

The absence of the SSR descriptor or absence of @value in the SSR descriptor indicates that each Representation covers the entire sphere when a PF descriptor that applies to the Representation is present.

When a PF descriptor is not present directly in the MPD or in an AdaptationSet element, there shall be no SSR descriptor present in the AdaptationSet element.

Further, Choi_1 describes signaling of spherical region-wise quality ranking information as follows:

A SupplementalProperty element with a @ schemeIdUri attribute equal to “urn:mpeg:omaf:srqr:2017” is referred to as a spherical region-wise quality ranking (SRQR) descriptor. At most one SRQR descriptor for each shape_type may be present at adaptation set level. At most one SRQR descriptor for each shape_type may be present at representation level. A SRQR descriptor shall not be present at MPD level. The SRQR descriptor indicates a quality ranking value of a quality ranking sphere region relative to other quality ranking sphere regions in the same Adaptation Set and relative to SRQR descriptors and @qualityRanking values in all Adaptation Sets that have the same @ value in the DASH Viewpoint element as the Adaptation Set containing this SRQR descriptor or containing the Representation that contains this SRQR descriptor. The sphere region for the quality-ranking is specified by syntax elements shape_type, center azimuth, center_elevation, center_tilt, hor_range, ver_range in SphereRegionStruct as specified in clause 7.5 [of Choi_1] When the quality ranking value is non-zero, the picture quality within the entire indicated quality ranking sphere region is approximately constant. The @ value of the SRQR descriptor is a comma separated list of values as specified Table 11D.

TABLE 11D

| @value parameter for | | |
|---|---|---|
| SRQR descriptor | Use | Description |
| shape_type | M | Value 0 specifies that the quality ranking sphere region is indicated |
| | | through four great circles as specified in clause 7.5.2.3 [of Choi_1]. Value |
| | | 1 specifies that the quality ranking sphere region is indicated through two |
| | | azimuth and two elevation circles as specified in clause 7.5.2.3 [of |
| | | Choi_1]. |
| remaining_area_flag | M | Value 0 specifies that all the quality ranking sphere regions are specified |
| | | by the signalled center_azimuth, center_elevation, center_tilt, hor_range, |
| | | and ver_range. Value 1 specifies that all except the last quality ranking |
| | | sphere regions are specified by the signalled center_azimuth, |
| | | center_elevation, center_tilt, hor_range, and ver_range, and the last |
| | | remaining quality ranking sphere region is the sphere region within the |
| | | coverage sphere region, not covered by the union of the quality ranking |
| | | sphere regions specified by the signalled center_azimuth, center_elevation, |
| | | center_tilt, hor_range, and ver_range. |
| view_idc_presence_flag | M | Value 0 specifies that view_idc is not signalled. Value 1 specifies that |
| | | view_idc is signalled and indicates the association of quality ranking |
| | | sphere regions with particular (left or right or both) views or monoscopic |
| | | content. |
| default_view_idc | CM | Value 0 indicates that all the quality ranking sphere regions are |
| | | monoscopic. Value 1 indicates that all the quality ranking sphere regions |
| | | are on the left view of stereoscopic content. Value 2 indicates that all the |
| | | quality ranking sphere regions are on the right view of stereoscopic |
| | | content. Value 3 indicates that all the quality ranking sphere regions are on |
| | | both the left and right views. default_view_idc shall be present when |
| | | view_idc_presence_flag is equal to 0. default_view_idc shall be absent |
| | | when view_idc_presence_flag is equal to 1. |

Followed by a comma separated list of sets of values specified below, which are comma separated and each
set of values is enclosed inside delimiters “{” (i.e. % x7B) and “}” (i.e. % x7D).

| | | |
|---|---|---|
| quality_ranking | M | specifies a quality ranking value of the quality ranking sphere region. |
| | | quality_ranking equal to 0 indicates that the quality ranking is not defined. |
| | | When quality ranking sphere region A has a non-zero quality_ranking |
| | | value less than the quality_ranking value of quality ranking sphere region |
| | | B, quality ranking sphere region A has a higher quality than quality |
| | | ranking sphere region B. When quality ranking sphere region A partly or |
| | | entirely overlaps with quality ranking sphere region B, quality_ranking of |
| | | quality ranking sphere region A shall be equal to quality_ranking of quality |
| | | ranking sphere region B. |
| view_idc | M | 0 indicates that the content is monoscopic, 1 indicates that the quality |
| | | ranking sphere region is on the left view of stereoscopic content, 2 |
| | | indicates that the quality ranking sphere region is on the right view of |
| | | stereoscopic content, 3 indicates that the quality ranking sphere region is |
| | | on both the left and right views. view_idc shall be present when |
| | | view_idc_presence_flag is equal to 1. view_idc shall be absent when |
| | | view_idc_presence_flag is equal to 0. |
| center_azimuth | CM | Specifies the azimuth of the center point of the quality ranking sphere |
| | | region, in degrees, relative to the global coordinate axes, center_azimuth |
| | | shall be present when remaining_area_flag is equal to 0. center_azimuth |
| | | shall be absent in only the last set of values enclosed inside the delimiters |
| | | “{” and “}” and shall be present in all the other sets of values when |
| | | remaining_area_flag is equal to 1. |
| center_elevation | CM | Specifies the pitch of the center point of the quality ranking sphere region, |
| | | in degrees, relative to the global coordinate axes. center_elevation shall be |
| | | present when remaining_area_flag is equal to 0. center_elevation shall be |
| | | absent in only the last set of values enclosed inside the delimiters “{” and |
| | | “}” and shall be present in all the other sets of values when |
| | | remaining_area_flag is equal to 1. |
| center_tilt | CM | Specifies the tilt angle for the quality ranking sphere region, center_tilt |
| | | shall be present when remaining_area_flag is equal to 0. center_tilt shall be |
| | | absent in only the last set of values enclosed inside the delimiters “{” and |
| | | “}” and shall be present in all the other sets of values when |
| | | remaining_area_flag is equal to 1. |
| hor_range | CM | Specifies the horizontal range of the quality ranking sphere region through |
| | | its center point. hor_range shall be present when remaining_area_flag is |
| | | equal to 0. hor_range shall be absent in only the last set of values enclosed |
| | | inside the delimiters “{” and “}” and shall be present in all the other sets of |
| | | values when remaining_area_flag is equal to 1. |
| ver_range | CM | Specifies the vertical range of the quality raking sphere region through its |
| | | center point. ver range shall be present when remaining_area_flag is equal |
| | | to 0. ver_range shall be absent in only the last set of values enclosed inside |
| | | the delimiters “{” and “}” and shall be present in all the other sets of values |
| | | when remaining_area_flag is equal to 1. |

Further, Choi_1 describes signaling of 2D region-wise quality ranking information as follows:

A SupplementalProperty element with a @ schemeIdUri attribute equal to “urn:mpeg:omaf:2dqr:2017” is referred to as a 2D region-wise quality ranking (2DQR) descriptor. At most one 2DQR descriptor may be present at adaptation set level. At most one 2DQR descriptor may be present at representation level. A 2DQR descriptor shall not be present at MPD level. The 2DQR descriptor indicates a quality ranking value of a quality ranking 2D region relative to other quality ranking 2D regions in the same Adaptation Set and relative to 2DQR descriptors and @qualityRanking values in all Adaptation Sets that have the same @ value in the DASH Viewpoint element as the Adaptation Set containing this 2DQR descriptor or containing the Representation that contains this 2DQR descriptor. When the quality ranking value is non-zero, the picture quality within the entire indicated quality ranking 2D region is approximately constant. The @ value of the 2DQR descriptor is a comma separated list of values as specified in Table 11E:

TABLE 11E

| @value parameter for | | |
|---|---|---|
| 2DQR descriptor | Use | Description |
| remaining_area_flag | M | Value 0 specifies that all the quality ranking 2D regions are specified by |
| | | the signalled left_offset, top_offset, region_width, and region_height. |
| | | Value 1 specifies that all except the last quality ranking 2D regions are |
| | | specified by the signalled left_offset, top_offset, region_width, and |
| | | region_height, and the last remaining quality ranking 2D region is the 2D |
| | | region within the coverage sphere region, not covered by the union of the |
| | | quality ranking 2D regions specified by the signalled left_offset, |
| | | top_offset, region_width, and region_height. |
| view_idc_presence_flag | M | Value 0 specifies that view_idc is not signalled. Value 1 specifies that |
| | | view_idc is signalled and indicates the association of quality ranking 2D |
| | | regions with particular (left or right or both) views or monoscopic |
| | | content. |
| default_view_idc | CM | Value 0 indicates that all the quality ranking 2D regions are monoscopic. |
| | | Value 1 indicates that all the quality ranking 2D regions are on the left |
| | | view of stereoscopic content. Value 2 indicates that all the quality ranking |
| | | 2D regions are on the right view of stereoscopic content. Value 3 |
| | | indicates that all the quality ranking 2D regions are on both the left and |
| | | right views. default_view_idc shall be present when |
| | | view_idc_presence_flag is equal to 0. default_view_idc shall be absent |
| | | when view_idc_presence_flag is equal to 1. |

Followed by a comma separated list of sets of values specified below, which are comma separated and each
set of values is enclosed inside delimiters “{” (i.e. % x7B) and “}” (i.e. % x7D).

| | | |
|---|---|---|
| quality_ranking | M | specifies a quality ranking value of the quality ranking 2D region. |
| | | quality_ranking equal to 0 indicates that the quality ranking is not |
| | | defined. When quality ranking 2D region A has a non-zero |
| | | quality_ranking value less than the quality_ranking value of quality |
| | | ranking 2D region B, quality ranking 2D region A has a higher quality |
| | | than quality ranking 2D region B. When quality ranking 2D region A |
| | | partly or entirely overlaps with quality ranking 2D region B, |
| | | quality_ranking of quality ranking 2D region A shall be equal to |
| | | quality_ranking of quality ranking 2D region B. |
| view_idc | M | 0 indicates that the content is monoscopic, 1 indicates that the quality |
| | | ranking 2D region is on the left view of stereoscopic content, 2 indicates |
| | | that the quality ranking 2D region is on the right view of stereoscopic |
| | | content, 3 indicates that the quality ranking 2D region is on both the left |
| | | and right views. view_idc shall be present when view_idc_presence_flag |
| | | is equal to 1. view_idc shall be absent when view_idc_presence_flag is |
| | | equal to 0. |
| left_offset | CM | Specifies the horizontal coordinate of the upper left corner of the quality |
| | | ranking 2D region within the picture in visual presentation size of the 2D |
| | | representation. left_offset shall be present when remaining_area_flag is |
| | | equal to 0. left_offset shall be absent in only the last set of values |
| | | enclosed inside the delimiters “{” and “}” and shall be present in all the |
| | | other sets of values when remaining_area_flag is equal to 1. |
| top_offset | CM | Specifies the vertical coordinate of the upper left corner of the quality |
| | | ranking 2D region within the picture in visual presentation size of the 2D |
| | | representation. top_offset shall be present when remaining_area_flag is |
| | | equal to 0. top_offset shall be absent in only the last set of values enclosed |
| | | inside the delimiters “{” and “}” and shall be present in all the other sets |
| | | of values when remaining_area_flag is equal to 1. |
| region_width | CM | Specifies the width of the quality ranking 2D region within the picture in |
| | | visual presentation size of the 2D representation, region_width shall be |
| | | present when remaining_area_fiag is equal to 0. region_width shall be |
| | | absent in only the last set of values enclosed inside the delimiters “{” and |
| | | “}” and shall be present in all the other sets of values when |
| | | remaining_area_flag is equal to 1. |
| region_height | CM | Specifies the height of the quality ranking 2D region within the picture in |
| | | visual presentation size of the 2D representation, region_height shall be |
| | | present when remaining_area_flag is equal to 0. region_height shall be |
| | | absent in only the last set of values enclosed inside the delimiters “{” and |
| | | “}” and shall be present in all the other sets of values when |
| | | remaining_area_flag is equal to 1. |

As described above, the techniques for omnidirectional media encapsulation and signaling in DASH provided in Choi and Choi_1 may be less than ideal. For example, current XML elements and attributes which are defined and used for omnidirectional media encapsulation and signaling in DASH provided in Choi and Choi_1 may be inadequate. In one example, according to the techniques described herein, media presentation description generator 502 may be configured to generate descriptors based on the following definition of an XML namespace and schema:

XML namespace and schema:

A number of new XML elements and attributes are defined and used. These new XML elements are defined in a separate namespace “urn:mpeg:mpegB:omaf:2017”. These are defined in normative schema documents in each section. It should be noted that in some examples, the new XML elements are defined in a separate namespace “urn:mpeg:mpegI:omaf:2017”. Thus, “urn:mpeg:mpegB:omaf:2017” may be interchanged with “urn:mpeg:mpegI:omaf:2017” in the examples herein.

The namespace designator, “xs:” shall correspond to namespace http://www.w3.org/2001/XMLSchema as defined in XML Schema Part 1 (W3C: “XML Schema Part 1: Structures Second Edition” W3C Recommendation, 28 Oct. 2004. https://www.w3.org/TR/xmlschema-1/ which is incorporated by reference herein]).

Items in the “Data type” column of tables in this section use datatypes defined in XML Schema Part 2 (W3C: “XML Schema Part 2: Datatypes Second Edition” W3C Recommendation, 28 Oct. 2004. https://www.w3.org/TR/xmlschema-2/ which is incorporated by reference herein] and shall have the meaning as defined in XML Schema Part 2.

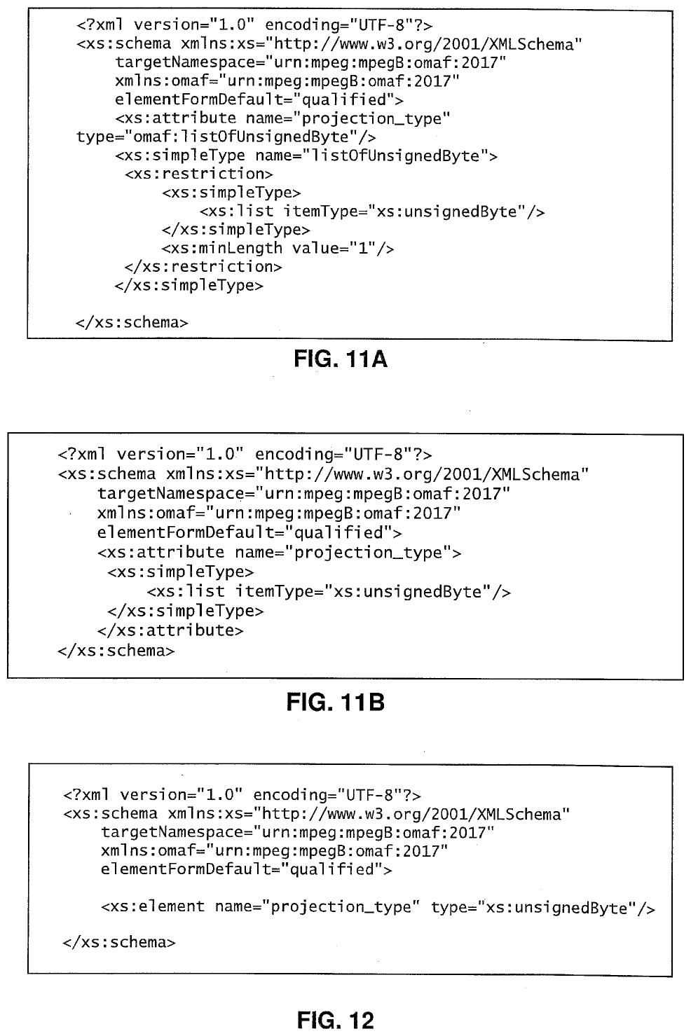

It should be noted that although the XML namespace used and described above and in various XML schema documents in FIG. 11A to FIG. 21 and sections in this document is “urn:mpeg:mpegB:omaf:2017”, instead some other namespace such as “urn:mpeg:mpegB:omaf:2018” or “urn:mpeg:mpegB:cicp:2017” or “urn:mpeg:omaf:2017” or “urn:mpeg:omaf:2017” or “org.mpeg.omaf.2017” or some such unique string—either as a urn or uri may be used instead.

In one example, according to the techniques described herein, media presentation description generator 502 may be configured to generate a projection format (PF) descriptor including projection type information. In one example, a projection format descriptor may be based on the following example definition:

An EssentialProperty element with a @ schemeIdUri attribute equal to “urn:mpeg:mpegB:cicp:PF” is referred to as a projection format (PF) descriptor. At most one PF descriptor may be present at MPD level. At most one PF descriptor may be present at adaptation set level. At most one PF descriptor may be present at representation level. The presence of the PF descriptor at MPD level indicates that all the representations of the media presentation carry projected omnidirectional video. The presence of the PF descriptor at adaptation set level indicates that all the representations of the adaptation set carry projected omnidirectional video. The omaf:@projection_type attribute of a PF descriptor present at a hierarchically lower level overrides omaf:@projection_type attribute of a PF descriptor present at a hierarchically higher level. For example, when both an AdaptationSet element and a Representation element in the AdaptationSet element have a PF descriptor present, the PF descriptor present in the Representation element applies to the Representation. The @ value attribute of the PF descriptor shall not be present. The PF descriptor shall include a omaf:@projection_type attribute whose value shall not be empty as specified in Table 12.

TABLE 12

| Attribute for PF | | | |
|---|---|---|---|
| descriptor | Use | Data type | Description |
| omaf: | M | omaf:listofUnsignedByte | Specifies a list of projection type values of the |
| @projection_type | | | projected picture. Each value in the list shall be |
| | | | in the range of 0 to 31, inclusive. The values 32 |
| | | | to 255 are reserved. Each value in the list shall be |
| | | | unique. |
| | | | For ISO base media file format Segments, each |
| | | | value in the list projection_type shall be equal to |
| | | | projection_type in ProjectionFormatBox in |
| | | | sample entries of the Initialization Segment. |

FIGS. 11A-11B are computer program listings illustrating examples of signaling metadata according to one or more techniques of this disclosure. FIGS. 11A-11B illustrate examples of defined XML schema corresponding to the example PF descriptor described with respect to Table 12. In one example, the schemas illustrated in FIGS. 11A-11B shall be represented in a XML schema that has namespaceurn:mpeg:mpegB:omaf:2017. It should be noted that in the example illustrated in FIG. 11B, an empty value is allowed for the projection_type attribute. It should be noted that in the example illustrated in FIG. 11A, an empty value is not allowed for the projection_type attribute. In one example the data type of elements and attributes in Table 12 will be as defined in the schema in FIG. 11A or 11B. In one example, the attribute use may be used for the attribute projection_type to indicate required presence of it as follows:

```
  <xs:attribute name=″projection_type″ use=″required″>
    <xs:simpleType>
      <xs:list itemType=″xs:unsignedByte″/>
    </xs:simpleType>
</xs:attribute>
```

In one example, a projection format descriptor may be based on the following example definition:

An EssentialProperty element with a @ schemeIdUri attribute equal to “urn:mpeg:mpegB:cicp:PF” is referred to as a projection format (PF) descriptor. At most one PF descriptor may be present at MPD level. At most one PF descriptor may be present at adaptation set level. At most one PF descriptor may be present at representation level. The presence of the PF descriptor at MPD level indicates that all the representations of the media presentation carry projected omnidirectional video. The presence of the PF descriptor at adaptation set level indicates that all the representations of the adaptation set carry projected omnidirectional video. The omaf:projection_type elements of a PF descriptor present at a hierarchically lower level overrides omaf:projection_type elements of a PF descriptor present at a hierarchically higher level. For example, when both an AdaptationSet element and a Representation element in the AdaptationSet element have a PF descriptor present, the PF descriptor present in the Representation element applies to the Representation. The @ value attribute of the PF descriptor shall not be present. The PF descriptor shall include one omaf:@projection_type attribute whose value shall not be empty as specified in Table 13.

TABLE 13

| Child element of | | | |
|---|---|---|---|
| PF descriptor | Use | Data type | Description |
| omaf: | 1 . . . N | xs: UnsignedByte | Each element specifies a comma separated list of |
| projection_type | | | projection type value of the projected picture. If more than |
| | | | one element is present each must have a unique value. |
| | | | Value of omaf:projection_type shall be in the range of 0 to |
| | | | 31, inclusive. The values 32 to 255 are reserved. |
| | | | For ISO base media file format Segments, each value of |
| | | | omaf:projection_type element shall be equal to |
| | | | projection_type in ProjectionFormatBox in sample entries |
| | | | of the Initialization Segment. |

It should be noted that in the example illustrated with respect to Table 13 compared to the example illustrated with respect to Table 12, instead of a new attribute to signal the list of projection type values, multiple child elements of the EssentialProperty descriptor are used, where each element can signal one projection type value. FIG. 12 is a computer program listing illustrating examples of signaling metadata according to one or more techniques of this disclosure. FIG. 12 illustrates an example of a defined XML schema corresponding to the example PF descriptor described with respect to Table 13. In one example the data type of elements and attributes in Table 13 will be as defined in the schema in FIG. 12. In one example, the schema illustrated in FIG. 12 shall be represented in a XML schema that has namespace-urn:mpeg:mpegB:omaf:2017. In one example, in a schema variant the attributes minOccurs and maxOccurs may be used for the element projection type to indicate allowed cardinality for this element as follows:
<xs:element name=“projection_type” type=“xs:unsignedByte” minOccurs=“1” maxOccurs=“unbounded”/>

In one example, a projection format descriptor may be based on the following example definition:

An EssentialProperty element with a @ schemeIdUri attribute equal to “urn:mpeg:mpegB:cicp:PF” is referred to as a projection format (PF) descriptor. At most one PF descriptor may be present at MPD level. At most one PF descriptor may be present at adaptation set level. At most one PF descriptor may be present at representation level. The presence of the PF descriptor at MPD level indicates that all the representations of the media presentation carry projected omnidirectional video. The presence of the PF descriptor at adaptation set level indicates that all the representations of the adaptation set carry projected omnidirectional video. The omaf:projection_type elements of a PF descriptor present at a hierarchically lower level overrides omaf:projection_type elements of a PF descriptor present at a hierarchically higher level. For example, when both an AdaptationSet element and a Representation element in the AdaptationSet element have a PF descriptor present, the PF descriptor present in the Representation element applies to the Representation. The @ value attribute of the PF descriptor shall not be present. The PF descriptor shall include one omaf:projection_type element whose value is a comma separated list of values as specified in Table 14:

TABLE 14

| Child element of | | | |
|---|---|---|---|
| PF descriptor | Use | Data type | Description |
| omaf: | 1 | xs: listOfUnsignedByte | This element value specifies a comma separated list |
| projection_type | | | of projection type values of the projected picture. |
| | | | Each value shall be in the range of 0 to 31, |
| | | | inclusive. The values 32 to 255 are reserved. |
| | | | For ISO base media file format Segments, each |
| | | | value in the list projection_type shall be equal to |
| | | | projection_type in ProjectionFormatBox in sample |
| | | | entries of the Initialization Segment. |

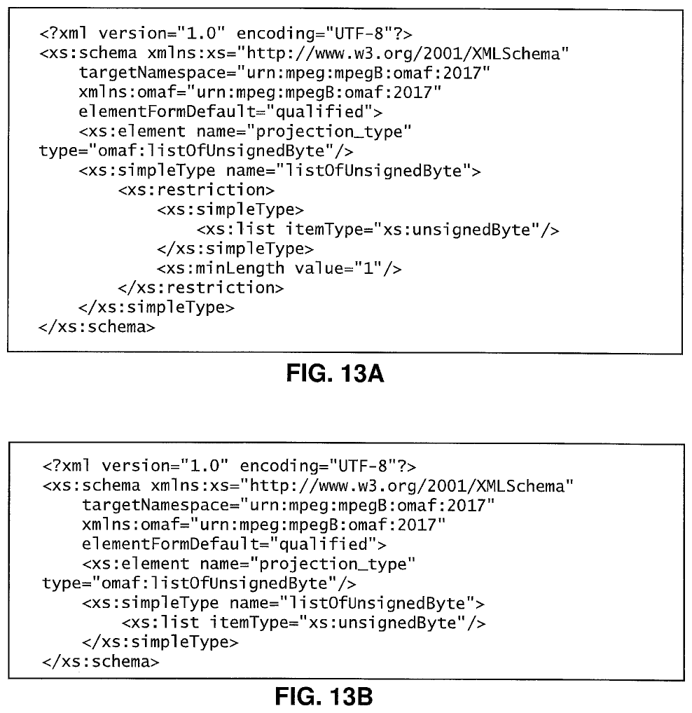

It should be noted that in the example illustrated with respect to Table 14 compared to the example illustrated with respect to Table 12, instead of a new attribute to signal the list of projection type values, a single child element can signal a list of projection type values. FIGS. 13A-13B are computer program listings illustrating examples of signaling metadata according to one or more techniques of this disclosure. FIGS. 13A-13B illustrate examples of defined XML schema corresponding to the example PF descriptor described with respect to Table 14. In one example, the schemas illustrated in FIGS. 13A-13B shall be represented in a XML schema that has namespace-urn:mpeg:mpegB:omaf:2017. In one example, the data type of elements and attributes in Table 14 will be as defined in the schema in FIG. 13A or 13B. It should be noted that in the example illustrated in FIG. 13B, an empty value is allowed for the projection_type element. It should be noted that in the example illustrated in FIG. 13A, an empty value is not allowed for the projection_type element. In one example, in a schema variant the attributes minOccurs and maxOccurs may be used for the element projection_type to indicate allowed cardinality for this element as follows:

```
<xs:element name=″projection_type″ type=″omaf:listOfUnsignedByte″ minOccurs=″1″
maxOccurs=″1″/>
  <xs:simpleType name=″listOfUnsignedByte″>
    <xs:list itemType=″xs:unsignedByte″/>
  </xs:simpleType>
```

In one example, in a schema variant the allowed values for projection_type attribute or element may be restricted by adding following restriction on those values using XML facet as follows:

<xs:minInclusive value=″0″/>
<xs:maxlnclusive value=″31″/>

In one example, according to the techniques described herein, media presentation description generator 502 may be configured to generate a region-wise packing format descriptor. In one example, a region-wise packing format descriptor may be based on the following example definition:

An EssentialProperty element with a @ schemeIdUri attribute equal to “urn:mpeg:omaf:rwpk:2017” is referred to as a region-wise packing (RWPK) descriptor. At most one RWPK descriptor may be present at MPD level. At most one RWPK descriptor may be present at adaptation set level. At most one RWPK descriptor may be present at representation level. The omaf:@packing_type attribute of a RWPK descriptor present at a hierarchically lower level overrides omaf:@packing_type attribute that of a RWPK descriptor present at a hierarchically higher level. For example, when both an AdaptationSet element and a Representation element in the AdaptationSet element have a RWPK descriptor present, the RWPK descriptor present in the Representation element applies to the Representation. The @value of the RWPK descriptor shall not be present. The RWPK descriptor may include a omaf:@packing_type attribute as specified in Table 15. The absence of a RWPK descriptor indicates that no region-wise packing has been applied.

TABLE 15

| Attribute for | | | |
|---|---|---|---|
| RWPK descriptor | Use | Data type | Description |
| omaf: | O | xs: OptionallistOfUnsignedByte | Specifies a list of the packing type value of |
| @packing_type | | | the picture. Each value in the list shall be in |
| | | | the range of 0 to 15, inclusive. The values |
| | | | 16 to 255 are reserved. Each value in the |
| | | | list shall be unique. |
| | | | For ISO base media file format Segments, |
| | | | packing_type shall be equal to |
| | | | packing_type in RegionWisePackingBox |
| | | | in sample entries of the Initialization |
| | | | Segment. When this omaf:@packing_type |
| | | | attribute does not include any value in a |
| | | | RWPK descriptor, omaf:@packing_type |
| | | | value is inferred to be equal to 0. |

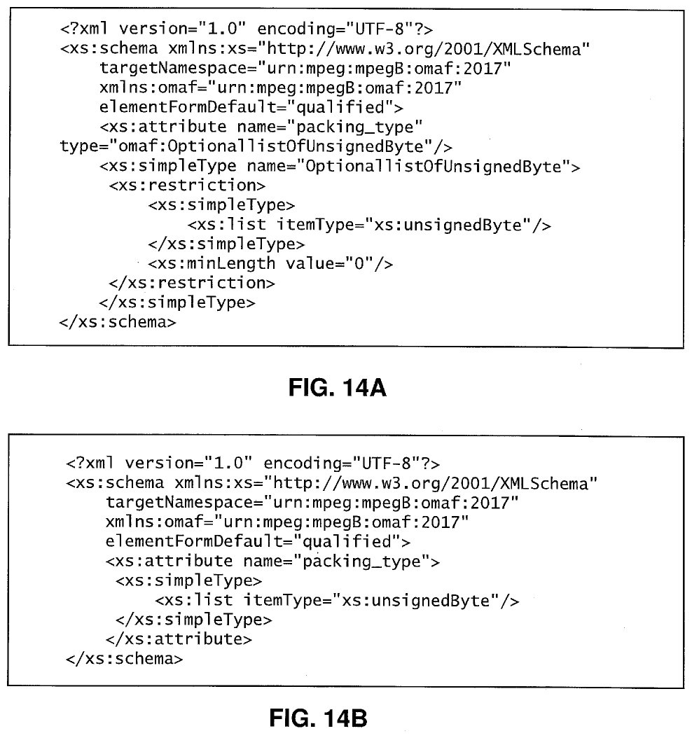

FIGS. 14A-14B are computer program listings illustrating examples of signaling metadata according to one or more techniques of this disclosure. FIGS. 14A-14B illustrate examples of defined XML schema corresponding to the example RWPK descriptor described with respect to Table 15. In one example, the data type of elements and attributes in Table 15 will be as defined in the schema in FIG. 14A or 14B. In one example, the schemas illustrated in FIGS. 14A-14B shall be represented in a XML schema that has namespace-urn:mpeg:mpegB:omaf:2017. In one example, the attribute use may be used for the attribute packing_type to indicate required presence of it as follows:

```
<xs:attribute name=″packing_type″ use=″optional″>
    <xs:simpleType>
      <xs:list itemType=″xs:unsignedByte″/>
    </xs:simpleType>
  </xs:attribute>
```

In one example, a region-wise packing format descriptor may be based on the following example definition:

An EssentialProperty element with a @schemeIdUri attribute equal to “urn:mpeg:omaf:rwpk:2017” is referred to as a region-wise packing (RWPK) descriptor. At most one RWPK descriptor may be present at MPD level. At most one RWPK descriptor may be present at adaptation set level. At most one RWPK descriptor may be present at representation level. The omaf:packing_type element of a RWPK descriptor present at a hierarchically lower level overrides omaf:packing_type element that of a RWPK descriptor present at a hierarchically higher level. For example, when both an AdaptationSet element and a Representation element in the AdaptationSet element have a RWPK descriptor present, the RWPK descriptor present in the Representation element applies to the Representation. The @value of the RWPK descriptor shall not be present. The RWPK descriptor may include zero or more omaf:packing_type element as specified in Table 16. The absence of a RWPK descriptor indicates that no region-wise packing has been applied.

TABLE 16

| Child element of | | | |
|---|---|---|---|
| RWPK descriptor | Use | Data type | Description |
| omaf: packing_type | 0 . . . 1 | omaf:listofUnsignedByte | Specifies a list of the packing type value of the |
| | | | picture. Each value in the list shall be in the range |
| | | | of 0 to 15, inclusive. The values 16 to 255 are |
| | | | reserved. Each value in the list shall be unique. |
| | | | For ISO base media file format Segments, |
| | | | omaf:packing_type value shall be equal to |
| | | | packing_type in RegionWisePackingBox in |
| | | | sample entries of the Initialization Segment. |
| | | | When this omaf:@packing_type element is not |
| | | | present in a RWPK descriptor or |
| | | | omaf:@packing_type element does not include |
| | | | any value in a RWPK descriptor, |
| | | | omaf:@packing_type value is inferred to be equal |
| | | | to 0. |

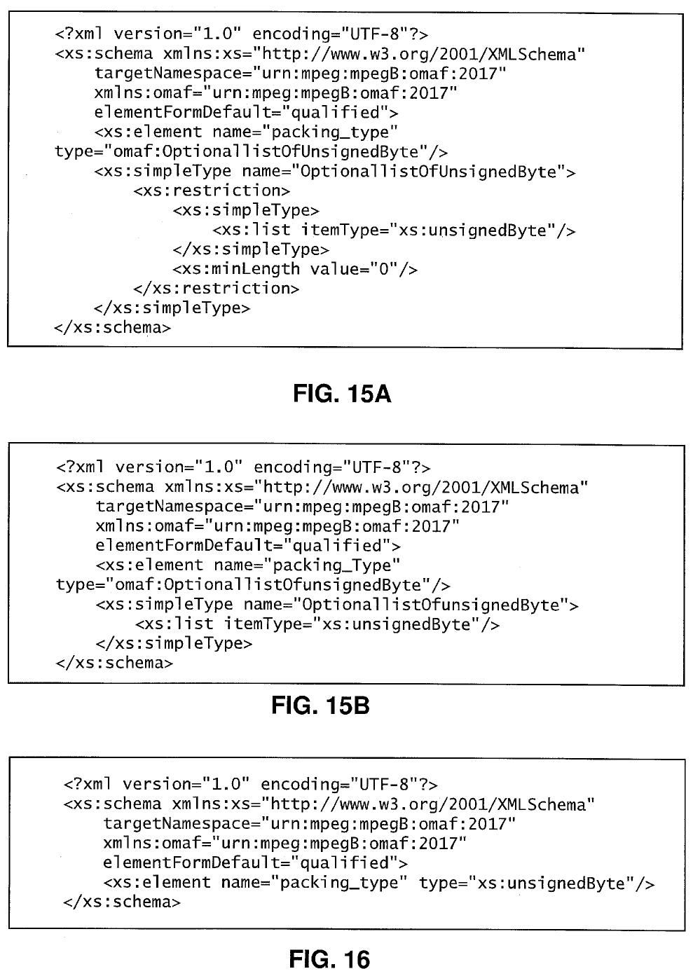

It should be noted that in the example illustrated with respect to Table 16 compared to the example illustrated with respect to Table 15, instead of a new attribute to signal the list of packing type values, multiple child elements of the EssentialProperty descriptor are used, where each element can signal one packing type value. FIGS. 15A-15B are computer program listings illustrating examples of signaling metadata according to one or more techniques of this disclosure. In one example, the data type of elements and attributes in Table 15 will be as defined in the schema in FIG. 15A or 15B. FIGS. 15A-15B illustrate examples of defined XML schema corresponding to the example RWPK descriptor described with respect to Table 16. In one example, the schemas illustrated in FIGS. 15A-15B shall be represented in a XML schema that has namespace-urn:mpeg:mpegB:omaf:2017.

In one example, a region-wise packing format descriptor may be based on the following example definition:

An EssentialProperty element with a @schemeIdUri attribute equal to “urn:mpeg:omaf:rwpk:2017” is referred to as a region-wise packing (RWPK) descriptor. At most one RWPK descriptor may be present at MPD level. At most one RWPK descriptor may be present at adaptation set level. At most one RWPK descriptor may be present at representation level. The omaf:packing_type elements of a RWPK descriptor present at a hierarchically lower level overrides omaf:packing_type elements that of a RWPK descriptor present at a hierarchically higher level. For example, when both an AdaptationSet element and a Representation element in the AdaptationSet element have a RWPK descriptor present, the RWPK descriptor present in the Representation element applies to the Representation. The @value attribute of the RWPK descriptor shall not be present. The RWPK descriptor may include zero or more omaf:packing_type elements as specified in Table 17. The absence of a RWPK descriptor indicates that no region-wise packing has been applied.

TABLE 17

| Child element of | | | |
|---|---|---|---|
| RWPK descriptor | Use | Data type | Description |
| omaf: packing_type | 0 . . . N | omaf:UnsignedByte | Each element specifies a packing type value of the |
| | | | picture. Each value in the list shall be in the range of 0 |
| | | | to 15, inclusive. The values 16 to 255 are reserved. |
| | | | Each value in the list shall be unique. |
| | | | For ISO base media file format Segments, |
| | | | packing_type shall be equal to packing_type in |
| | | | RegionWisePackingBox in sample entries of the |
| | | | Initialization Segment. When this omaf:packing_type |
| | | | element is not present in a RWPK descriptor, or |
| | | | omaf:packing_type element does not include any |
| | | | value in a RWPK descriptor, omaf:packing_type |
| | | | value is inferred to be equal to 0. |

It should be noted that in the example illustrated with respect to Table 17 compared to the example illustrated with respect to Table 15, instead of a new attribute to signal the list of packing type values, multiple child elements of the EssentialProperty descriptor are used, where each element can signal one packing type value. FIG. 16 is a computer program listing illustrating examples of signaling metadata according to one or more techniques of this disclosure. FIG. 16 illustrates an example of a defined XML schema corresponding to the example RWPK descriptor described with respect to Table 17. In one example, the data type of elements and attributes in Table 17 will be as defined in the schema in FIG. 16. In one example, the schema illustrated in FIG. 16 shall be represented in a XML schema that has namespaceurn:mpeg:mpegB:omaf:2017.

In one example, according to the techniques described herein, media presentation description generator 502 may be configured to generate a spherical spatial relationship (SSR) descriptor. In one example, a spherical spatial relationship descriptor may be based on the following example definition:

A SupplementalProperty element with a @ schemeIdUri attribute equal to “urn:mpeg:omaf:cc:2017” is referred to as a spherical spatial relationship (SSR) descriptor. At most one SSR descriptor may be present at adaptation set level. A SSR descriptor shall not be present at MPD or representation level. The SSR descriptor indicates that each Representation covers the sphere region as specified in clause 7.5 of Choi_1 by shape_type and syntax elements center azimuth, center_elevation, center_tilt, hor_range, and ver_range in SphereRegionStruct as included in the SSR descriptor. The @value attribute of the SSR descriptor shall not be present. The SSR descriptor shall include a ssr element with its attributes as specified in Table 18A:

TABLE 18A

| Elements and | | | |
|---|---|---|---|
| attributes for SSR | | | |
| descriptor | Use | Data type | Description |
| ssr | 0 . . . 1 | omaf:SSRType | Container element whose attributes specify sphere region |
| | | | coverage information. |
| ssr@view_idc | O | omaf:ViewType | 0 indicates that the coverage sphere region is monoscopic, 1 |
| | | | indicates that the coverage sphere region is on the left view of |
| | | | stereoscopic content, 2 indicates the the coverage sphere region is |
| | | | on the right view of stereoscopic content, and 3 indicates that the |
| | | | coverage sphere region is on both the left and right views. When |
| | | | not present, ssr@view_idc is inferred to be equal to 0. |
| ssr@shape_type | O | omaf:ShapeType | Specifies the shape type of the coverage sphere region, as |
| | | | specified in 7.5.2.3 When not present, ssr@shape_type is inferred |
| | | | to be equal to 0. |
| ssr@center_azimuth | O | omaf:Range1 | Specifies the azimuth of the center point of the coverage sphere |
| | | | region in degrees relative to the global coordinate axes. When not |
| | | | present, ssr@center_azimuth is inferred to be equal to 0. |
| ssr@center_elevation | O | omaf:Range2 | Specifies the elevation of the center point of the coverage sphere |
| | | | region in degrees relative to the global coordinate axes. When not |
| | | | present, ssr@center_elevation is inferred to be equal to 0. |
| ssr@center_tilt | O | omaf:Range1 | Specifies the tilt angle of the coverage sphere region, in degrees, |
| | | | relative to the global coordinate axes. When not present, |
| | | | ssr@center_tilt is inferred to be equal to 0. |
| ssr@hor_range | O | omaf:HRange | Specifies the horizontal range of the coverage sphere region |
| | | | through the center point of the coverage sphere region. When not |
| | | | present ssr@hor_range is inferred to be equal to 360 * 2¹⁶. |
| ssr@ver_range | O | omaf:VRange | Specifies the vertical range of the coverage sphere region through |
| | | | the center point of the coverage sphere region. When not present |
| | | | ssr@ver_range is inferred to be equal to 180 * 2¹⁶. |

The absence of the SSR descriptor or absence of ssr element in the SSR descriptor indicates that each Representation covers the entire sphere when a PF descriptor that applies to the Representation is present. When a PF descriptor is not present directly in the MPD or in an AdaptationSet element, there shall be no SSR descriptor present in the AdaptationSet element.

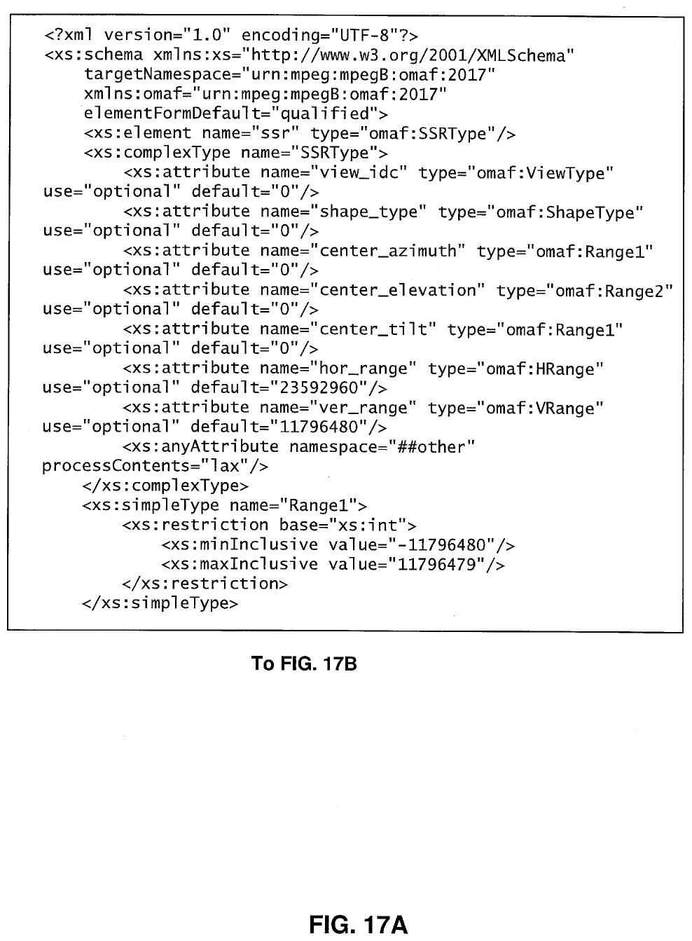

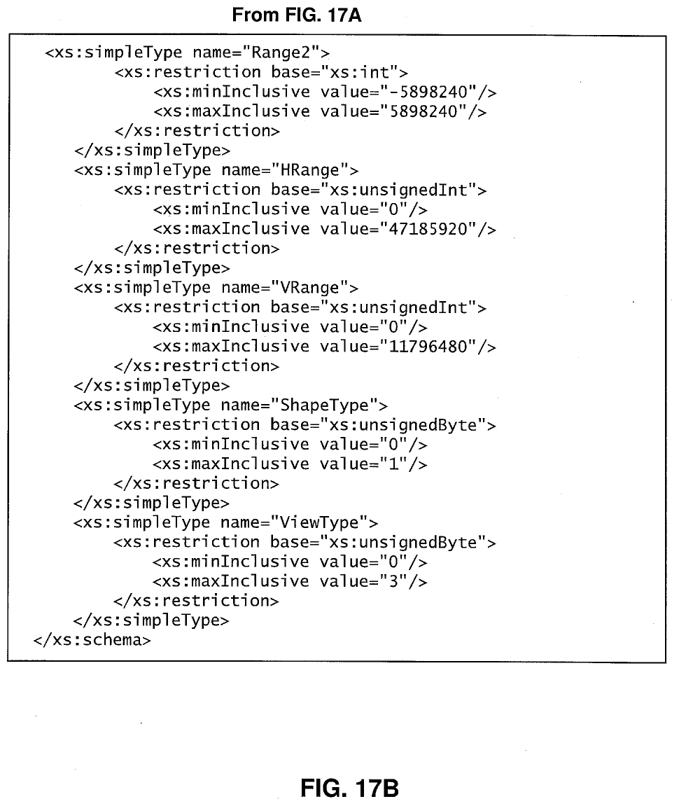

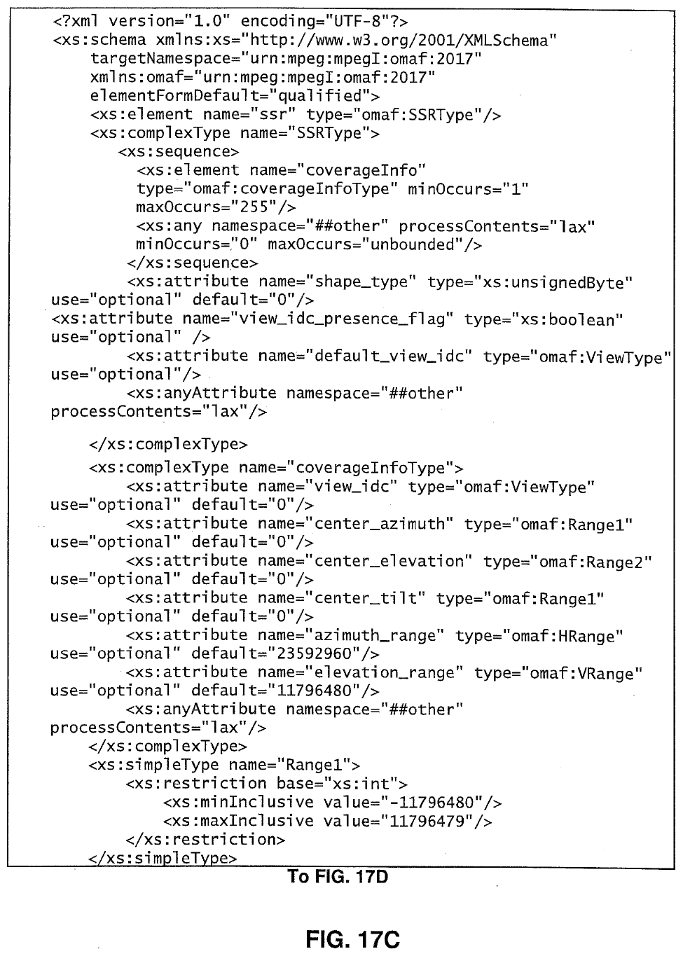

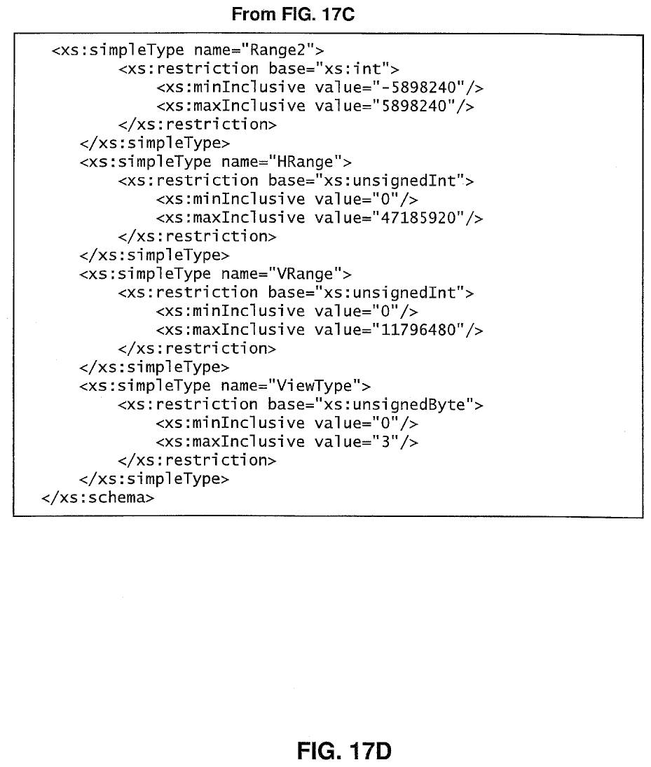

FIGS. 17A-17B is a computer program listing illustrating examples of signaling metadata according to one or more techniques of this disclosure. FIGS. 17A-17B illustrates an example of a defined XML schema corresponding to the example SSR descriptor described with respect to Table 18. In one example, the data type of elements and attributes in Table 18 will be as defined in the schema in FIGS. 17A-17B. In one example, the schema illustrated in FIGS. 17A-17B shall be represented in a XML schema that has namespace-urn:mpeg:mpegB:omaf:2017.

In one example, according to the techniques described herein, media presentation description generator 502 may be configured to generate a spherical spatial relationship (SSR) descriptor based on the following example definition:

A SupplementalProperty element with a @ schemeIdUri attribute equal to “urn:mpeg:omaf:cc:2017” is referred to as a spherical spatial relationship (SSR) descriptor. At most one SSR descriptor may be present at adaptation set level. A SSR descriptor shall not be present at MPD or representation level. The SSR descriptor indicates that each Representation covers the sphere region as specified in clause 7.5 of Choi_1 by shape_type and syntax elements center_azimuth, center_elevation, center_tilt, hor_range, and ver_range in SphereRegionStruct as included in the SSR descriptor. The @value attribute of the SSR descriptor shall not be present. The SSR descriptor shall include a ssr element with its attributes as specified in Table 18B:

TABLE 18B

| Elements and | | | |
|---|---|---|---|
| attributes for | | | |
| SRQR descriptor | Use | Data type | Description |
| ssr | 0 . . . 1 | omaf:SSRType | Container element whose attributes specify sphere region |
| | | | coverage information. |
| ssr@shape_type | O | xs: | Specifies the shape type of the sphere region, as specified in |
| | | unsignedByte | 7.5.2.3 of Choi_1. When not present, ssr@shape_type is inferred |
| | | | to be equal to 0. |
| ssr@view_idc_presence_flag | O | xs:boolean | Value 0 specifies that ssr.coverageInfo@view_idc is not signalled. |
| | | | Value 1 specifies that ssr.coverageInfo@view_idc is signalled and |
| | | | indicates the association of sphere regions with particular (left or |
| | | | right or both) views or monoscopic content. When not present, |
| | | | ssr@view_idc_presence_flag is inferred to be equal to 0. |
| ssr@default_view_idc | O | omaf:ViewType | Value 0 indicates that all the sphere regions are monoscopic. |
| | | | Value 1 indicates that all the sphere regions are on the left view of |
| | | | stereoscopic content. Value 2 indicates that all the sphere regions |
| | | | are on the right view of stereoscopic content. Value 3 indicates |
| | | | that all the sphere regions are on both the left and right views. |
| | | | ssr@default_view_idc shall be present when |
| | | | ssr@view_idc_presence_flag is equal to 0. ssr@default_view_idc |
| | | | shall be absent when ssr@view_ide_presence_flag is equal to 1. |
| ssr.coverageInfo | 1-255 | omaf:coverage | Element whose attribute ssr.coverageInfo@view_idc when present |
| | | InfoType | provides information about view(s) to which coverage specified |
| | | | by sphere region defined by attributes |
| | | | sphRegionQuality.qualityInfo@view_idc, |
| | | | sphRegionQuality.qualityInfo@center_azimuth, |
| | | | sphRegionQuality.qualityInfo@center_elevation, |
| | | | sphRegionQuality.qualityInfo@center_tilt, |
| | | | sphRegionQuality.qualityInfo@azimuth_range, |
| | | | sphRegionQuality.qualityInfo@elevation_range applies. |
| ssr.coverageInfo | O | omaf:ViewType | 0 indicates that the sphere region is monoscopic, 1 indicates that |
| @view_idc | | | the sphere region is on the left view of stereoscopic content, 2 |
| | | | indicates the sphere region is on the right view of stereoscopic |
| | | | content, and 3 indicates that the sphere region is on both the left |
| | | | and right views. view_idc shall be absent when |
| | | | view_idc_presence_flag is equal to 0. ssr.coverageInfo@view_idc |
| | | | shall be present when ssr@view_idc_presence_flag is equal to 1. |
| ssr.coverageInfo | O | omaf:Range1 | Specifies the azimuth of the center point of the coverage sphere |
| @center_azimuth | | | region in degrees relative to the global coordinate axes. When not |
| | | | present, ssr@center_azimuth is inferred to be equal to 0. |
| ssr@center_elevation | O | omaf:Range2 | Specifies the elevation of the center point of the coverage sphere |
| | | | region in degrees relative to the global coordinate axes. When not |
| | | | present, ssr@center_elevation is inferred to be equal to 0. |
| ssr.coverageInfo | O | omaf:Range1 | Specifies the tilt angle of the coverage sphere region, in degrees, |
| @center_tilt | | | relative to the global coordinate axes. When not present, |
| | | | ssr@center_tilt is inferred to be equal to 0. |
| ssr.coverageInfo | O | omaf.HRange | Specifies the horizontal range of the coverage sphere region |
| @azimuth_range | | | through the center point of the coverage sphere region. When not |
| | | | present ssr@azimuth_range is inferred to be equal to 360 * 2¹⁶. |
| ssr.coverageInfo | O | omaf.VRange | Specifies the vertical range of the coverage sphere region through |
| @elevation_range | | | the center point of the coverage sphere region. When not present |
| | | | ssr@elevation_range is inferred to be equal to 180 * 2¹⁶. |

The absence of the SSR descriptor or absence of ssr element in the SSR descriptor indicates that each Representation covers the entire sphere when a PF descriptor that applies to the Representation is present.

When a PF descriptor is not present directly in the MPD or in an AdaptationSet element, there shall be no SSR descriptor present in the AdaptationSet element.

FIGS. 17C-17D is a computer program listing illustrating examples of signaling metadata according to one or more techniques of this disclosure. FIGS. 17C-17D illustrates an example of a defined XML schema corresponding to the example SSR descriptor described with respect to Table 18B. In one example, the data type of elements and attributes in Table 18B will be as defined in the schema in FIG. 17C-17D.

In one example, according to the techniques described herein, media presentation description generator 502 may be configured to generate spherical region-wise quality ranking descriptor. In one example, spherical region-wise quality ranking descriptor may be based on the following example definition:

A SupplementalProperty element with a @ schemeIdUri attribute equal to “urn:mpeg:omaf:srqr:2017” is referred to as a spherical region-wise quality ranking (SRQR) descriptor. At most one SRQR descriptor for each sphRegionQuality @shape_type value of 0 and 1 may be present at adaptation set level. At most one SRQR descriptor for each sphRegionQuality @shape_type value of 0 and 1 may be present at representation level. A SRQR descriptor shall not be present at MPD level. The SRQR descriptor indicates a quality ranking value of a quality ranking sphere region relative to other quality ranking sphere regions in the same Adaptation Set and relative to SRQR descriptors and @qualityRanking values in all Adaptation Sets that have the same @ value in the DASH Viewpoint element as the Adaptation Set containing this SRQR descriptor or containing the Representation that contains this SRQR descriptor. The sphere region for the quality-ranking is specified by syntax elements shape_type, center_azimuth, center_elevation, center_tilt, hor_range, ver_range in SphereRegionStruct as specified in clause 7.5 of Choi_1. When the quality ranking value sphRegionQuality.qualityinfo@quality_ranking is non-zero, the picture quality within the entire indicated quality ranking sphere region is approximately constant. The @ value attribute of the SRQR descriptor shall not be present. The SRQR descriptor shall include a sphRegionQuality element with its sub-elements and attributes as specified in Table 19A:

TABLE 19A

| Elements and | | | |
|---|---|---|---|
| attributes for | | | |
| SRQR descriptor | Use | Data type | Description |
| sphRegionQuality | 1 | omaf:SphRegionQuality | Container element which includes one or more quality |
| | | Type | information elements (sphRegionQuality.qualityInfo) and |
| | | | common set of attributes (sphRegionQuality@shape_type, |
| | | | sphRegionQuality@remaining_area_flag, |
| | | | sphRegionQuality@view_idc_presence_flag, |
| | | | sphRegionQuality@default_view_idc) that apply to all |
| | | | those quality information elements. |
| sphRegionQuality | O | omaf:ShapeType | Value 0 specifies that the quality ranking sphere region is |
| @shape_type | | | indicated through four great circles as specified in clause |
| | | | 7.5.2.3 of Choi_1. Value 1 specifies that the quality ranking |
| | | | sphere region is indicated through two azimuth and two |
| | | | elevation circles as specified in clause 7.5.2.3 of Choi_1. |
| | | | When not present sphRegionQuality@shape_type is |
| | | | inferred to be equal to 0. |
| sphRegionQuality | 0 | xs:boolean | Value 0 specifies that all the quality ranking sphere regions |
| @remaining_area_flag | | | are specified by the signalled sphRegionQuality.qualityInfo |
| | | | elements. Value 1 specifies that all except the last quality |
| | | | ranking sphere regions are specified by the signalled |
| | | | sphRegionQuality.qualityInfo elements, and the last |
| | | | remaining quality ranking sphere region is the sphere |
| | | | region within the coverage sphere region, not covered by |
| | | | the union of the quality ranking sphere regions specified by |
| | | | the signalled sphRegionQuality.qualityInfo elements. When |
| | | | not present sphRegionQuality@remaining_area_flag is |
| | | | inferred to be equal to 0. |
| sphRegionQuality | O | xs:boolean | Value 0 specifies that |
| @view_idc_presence_flag | | | sphRegionQuality.qualityInfo@view_idc is not signalled in |
| | | | each sphRegionQuality.qualityInfo element. Value 1 |
| | | | specifies that sphRegionQuality.qualityInfo@view_idc is |
| | | | signalled and indicates the association of quality ranking |
| | | | sphere regions with particular (left or right or both) views |
| | | | or monoscopic content. When not present |
| | | | sphRegionQuality@view_idc_presence_flag is inferred to |
| | | | be equal to 0. |
| sphRegionQuality | CM | omaf:ViewType | Value 0 indicates that all the quality ranking sphere regions |
| @default_view_idc | | | are monoscopic. Value 1 indicates that all the quality |
| | | | ranking sphere regions are on the left view of stereoscopic |
| | | | content. Value 2 indicates that all the quality ranking sphere |
| | | | regions are on the right view of stereoscopic content. Value |
| | | | 3 indicates that all the quality ranlcing sphere regions are on |
| | | | both the left and right views. |
| | | | sphRegionQuality@default_view_idc shall be present when |
| | | | sphRegionQuality@view_idc_presence_flag is equal to 0. |
| | | | sphRegionQuality@default_view_idc shall be absent when |
| | | | sphRegionQuality@view_idc_presence_flag is equal to 1. |
| sphRegionQuality.quality | 1 . . . 255 | omaf:QualityInfoType | Element whose attribute |
| Info | | | sphRegionQuality.qualityinfo@quality_ranking provides |
| | | | quality ranking for one quality ranking sphere region |
| | | | described by its attributes |
| | | | sphRegionQuality.qualityInfo@view_idc, |
| | | | sphRegionQuality.qualityInfo@center_azimuth, |
| | | | sphRegionQuality.qualityInfo@center_elevation, |
| | | | sphRegionQuality.qualityInfo@center_tilt, |
| | | | sphRegionQuality.qualityInfo@hor_range, |
| | | | sphRegionQuality.qualityInfo@ver_range. |
| sphRegionQuality.quality | M | xs:unsignedByte | specifies a quality ranking value of the quality ranking |
| Info@quality_ranking | | | sphere region. |
| | | | sphRegionQuality.qualityinfo@quality_ranking equal to 0 |
| | | | indicates that the quality ranking is not defined. When |
| | | | quality ranking sphere region A has a non-zero |
| | | | sphRegionQuality.qualityinfo@quality_ranking value less |
| | | | than the sphRegionQuality.qualityinfo@quality_ranking |
| | | | value of quality ranking sphere region B, quality ranking |
| | | | sphere region A has a higher quality than quality ranking |
| | | | sphere region B. When quality ranking sphere region A |
| | | | partly or entirely overlaps with quality ranking sphere |
| | | | region B, sphRegionQuality.qualityinfo@quality_ranking of |
| | | | quality ranking sphere region A shall be equal to |
| | | | sphRegionQuality.qualityinfo@quality_ranking of quality |
| | | | ranking sphere region B. |
| sphRegionQuality.quality | O | omaf:ViewType | 0 indicates that the content is monoscopic, 1 indicates that |
| Info@view_idc | | | the quality ranking sphere region is on the left view of |
| | | | stereoscopic content, 2 indicates that the quality ranking |
| | | | sphere region is on the right view of stereoscopic content, 3 |
| | | | indicates that the quality ranking sphere region is on both |
| | | | the left and right views. |
| | | | sphRegionQuality.qualityInfo@view_idc shall be present |
| | | | when sphRegionQuality@view_idc_presence_flag is equal |
| | | | to 1. sphRegionQuality.qualityInfo@view_idc shall be |
| | | | absent when sphRegionQuality@view_idc_presence_flag is |
| | | | equal to 0. |
| sphRegionQuality.quality | CM | omaf:Range1 | Specifies the azimuth of the center point of the quality |
| Info@center_azimuth | | | ranking sphere region, in degrees, relative to the global |
| | | | coordinate axes. |
| | | | sphRegionQuality.qualityInfo@center_azimuth shall be |
| | | | present when sphRegionQuality@remaining_area_flag is |
| | | | equal to 0. sphRegionQuality.qualityInfo@center_azimuth |
| | | | shall be absent in only one sphRegionQuality.qualityInfo |
| | | | element and shall be present in all the other |
| | | | sphRegionQuality.qualityInfo elements when |
| | | | sphRegionQuality@remaining_area_flag is equal to 1. |
| sphRegionQuality.quality | CM | omaf:Range2 | Specifies the pitch of the center point of the quality ranking |
| Info@center_elevation | | | sphere region, in degrees, relative to the global coordinate |
| | | | axes. sphRegionQuality.qualityInfo@center_elevation shall |
| | | | be present when sphRegionQuality@remaining_area_flag is |
| | | | equal to 0. sphRegionQuality.qualityInfo@center_elevation |
| | | | shall be absent in only one sphRegionQuality.qualityInfo |
| | | | element and shall be present in all the other |
| | | | sphRegionQuality.qualityInfo elements when |
| | | | sphRegionQuality@remaining_area_flag is equal to 1. |
| sphRegionQuality.quality | CM | omaf:Range1 | Specifies the tilt angle for the quality ranking sphere region. |
| Info@center_tilt | | | sphRegionQuality.qualityInfo@center_tilt shall be present |
| | | | when sphRegionQuality@remaining_area_flag is equal to 0. |
| | | | sphRegionQuality.qualityInfo@center_tilt shall be absent in |
| | | | only one one sphRegionQuality.qualityInfo element and |
| | | | shall be present in all the other |
| | | | sphRegionQuality.qualityInfo elements when |
| | | | sphRegionQuality@remaining_area_flag is equal to 1. |
| sphRegionQuality.quality | CM | omaf:HRange | Specifies the horizontal range of the quality ranking sphere |
| Info@hor_range | | | region through its center point. |
| | | | sphRegionQuality.qualityInfo@hor_range shall be present |
| | | | when sphRegionQuality@remaining_area_flag is equal to 0. |
| | | | sphRegionQuality.qualityInfo@hor_range shall be absent in |
| | | | only one sphRegionQuality.qualityInfo element and shall be |
| | | | present in all the other sphRegionQuality.qualityInfo |
| | | | elements when sphRegionQuality@remaining_area_flag is |
| | | | equal to 1. |
| sphRegionQuality.quality | CM | omaf:VRange | Specifies the vertical range of the quality raking sphere |
| Info@ver_range | | | region through its center point. |
| | | | sphRegionQuality.qualityInfo@ver_range shall be present |
| | | | when sphRegionQuality@remaining_area_flag is equal to 0. |
| | | | sphRegionQuality.qualityInfo@ver_range shall be absent in |
| | | | only one sphRegionQuality.qualityInfo element and shall be |
| | | | present in all the other sphRegionQuality.qualityInfo |
| | | | elements when sphRegionQuality@remaining_area_fiag is |
| | | | equal to 1. |

It should be noted that the column “use” may instead be labelled as “cardinality”. Also, an entry 1 in that column may be changed to M (i.e mandatory or required) or vice versa. Also, an entry 0..1 in that column may be changed to O (i.e. optional) or CM (i.e. conditional mandatory) or vice versa.

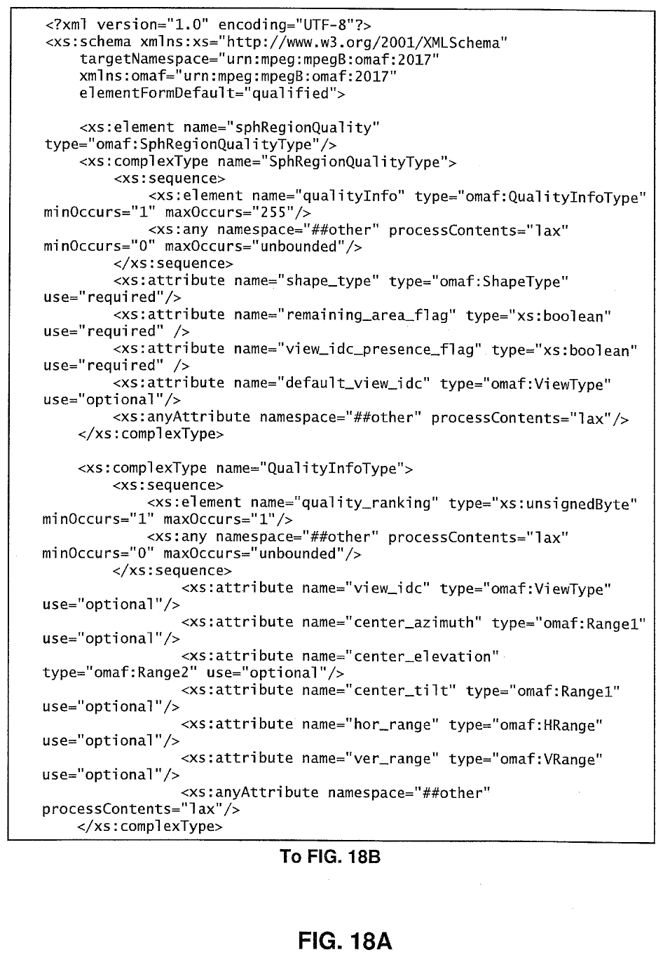

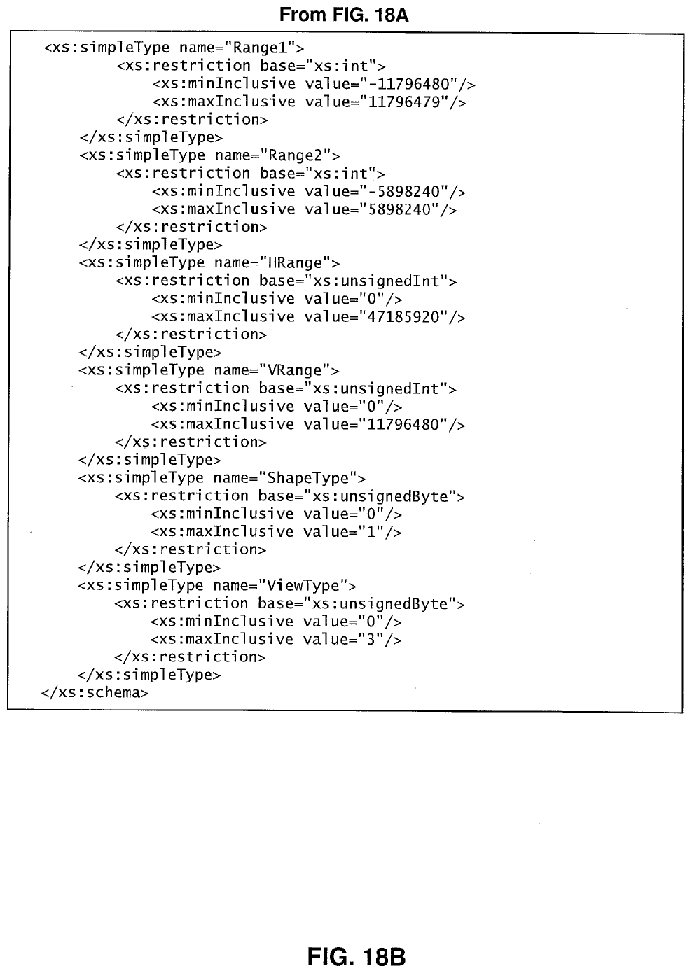

FIGS. 18A-18B is a computer program listing illustrating examples of signaling metadata according to one or more techniques of this disclosure. FIGS. 18A-18B illustrates an example of a defined XML schema corresponding to the example SRQR descriptor described with respect to Table 19A. In one example, the data type of elements and attributes in Table 19A will be as defined in the schema in FIGS. 18A-18B. In one example, the schema illustrated in FIGS. 18A-18B shall be represented in a XML schema that has namespace-urn:mpeg:mpegB:omaf:2017.

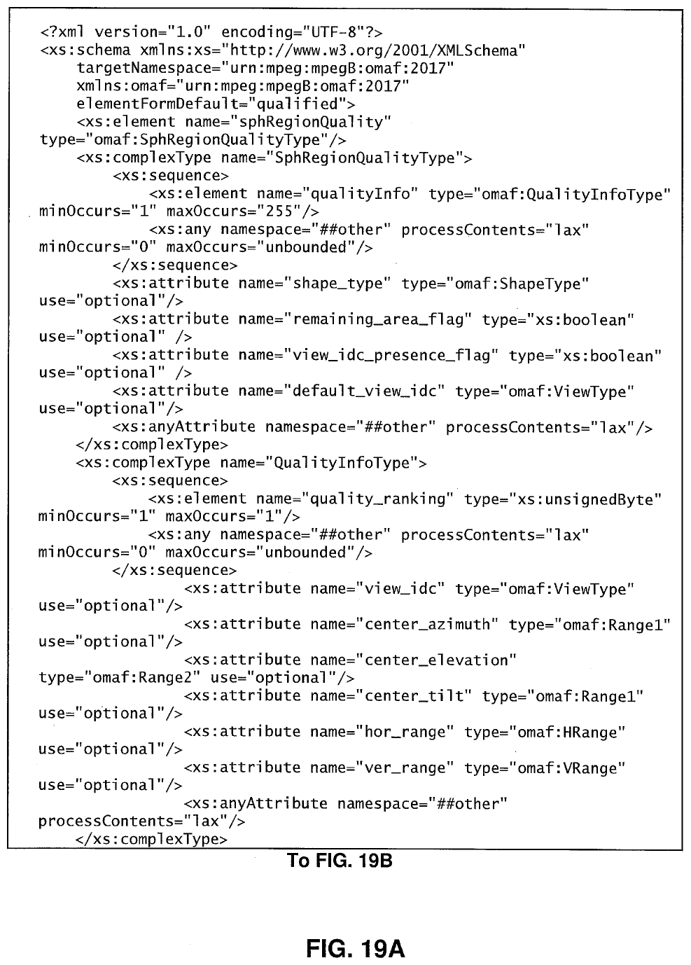

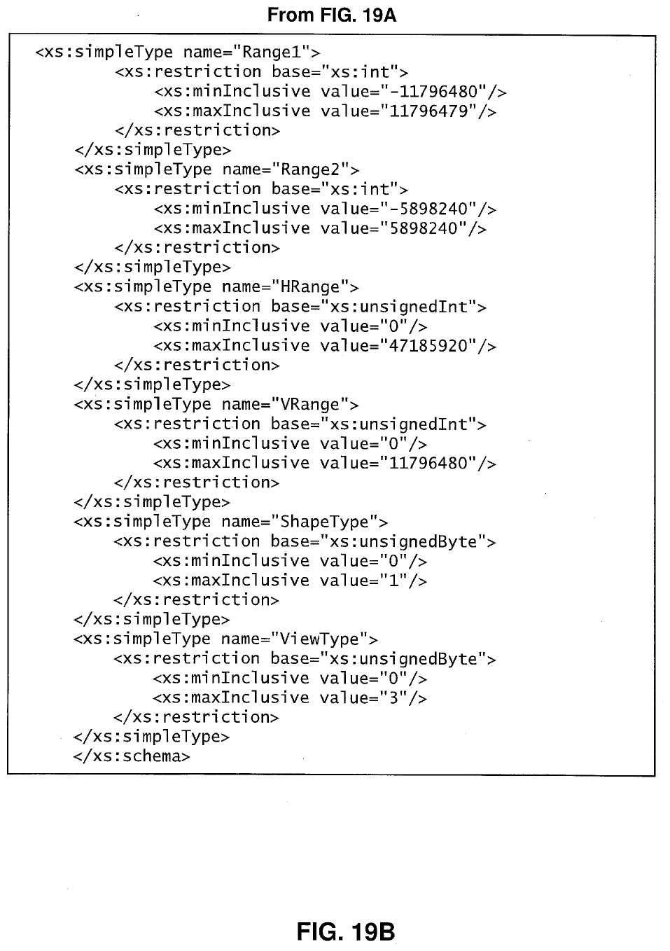

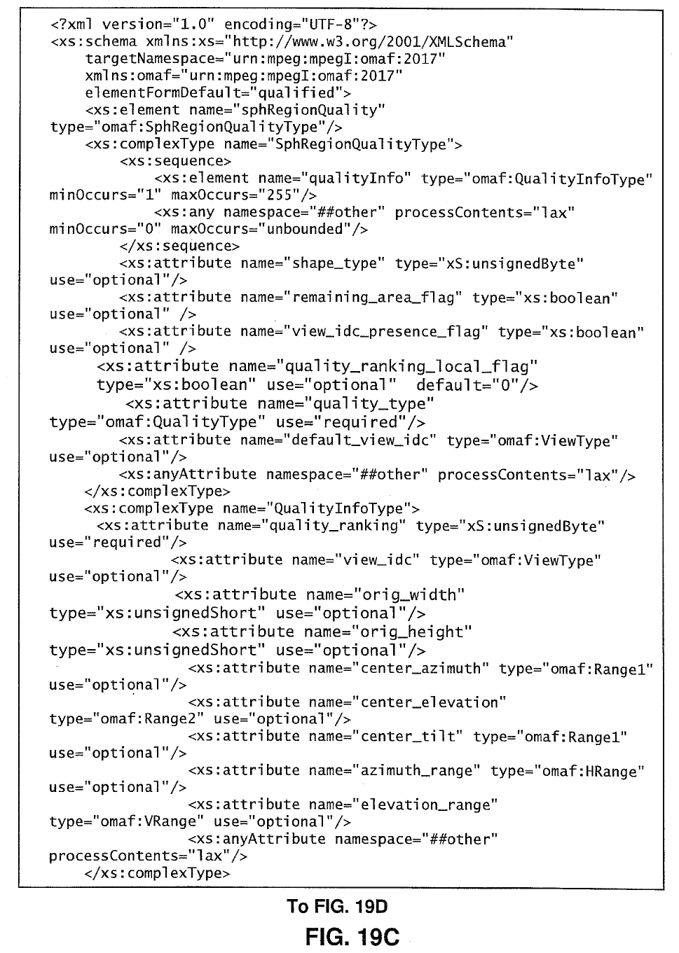

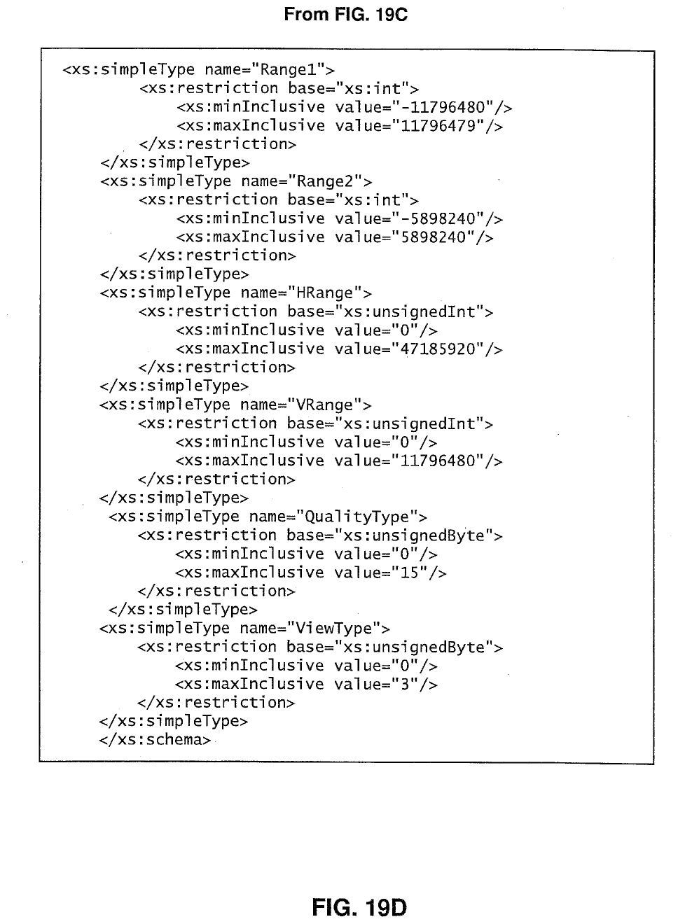

In another example FIGS. 19A-19B is a computer program listing illustrating examples of signaling metadata according to one or more techniques of this disclosure. FIGS. 19A-19B illustrates an example of a defined XML schema corresponding to the example SRQR descriptor described with respect to Table 19. In one example, the data type of elements and attributes in Table 19A will be as defined in the schema in FIGS. 19A-19B. In one example, the schema illustrated in FIGS. 19A-19B shall be represented in a XML schema that has namespace-urn:mpeg:mpegB:omaf:2017.

It should be noted that the difference between the computer program listing in FIGS. 18A-18B and FIGS. 19A-19B is that in FIGS. 19A-19D the attributes sphRegionQuality @shape_type, sphRegionQuality @remaining_area_flag, sphRegionQuality @ view_idc_presence_flag are optional where as they are required in FIGS. 18A-18B. Making these attributes optional and assigning default values to them saves bits when signaling.

In one example, the following constraints may be applied to a SRQR descriptor:
When sphRegionQuality @remaining_area_flag is equal to 0 all sphRegionQuality.qualityInfo elements shall have each of the attributes sphRegionQuality.qualityInfo@center_azimuth, sphRegionQuality.qualityInfo@center_elevation, sphRegionQuality.qualityInfo@center_tilt, sphRegionQuality.qualityInfo@hor_Range, sphRegionQuality.qualityInfo@ver_range present.
When sphRegionQuality@remaining_area_flag is equal to 1 only one sphRegionQuality.qualityInfo element shall have each of the attributes sphRegionQuality.qualityInfo@center_azimuth, sphRegionQuality.qualityInfo@center_elevation, sphRegionQuality.qualityInfo@center_tilt, sphRegionQuality.qualityInfo@hor_Range, sphRegionQuality.qualityInfo@ver_range absent and all the other sphRegionQuality.qualityInfo elements shall have each of the attributes sphRegionQuality.qualityInfo@center_azimuth, sphRegionQuality.qualityInfo@center_elevation, sphRegionQuality.qualityInfo@center_tilt, sphRegionQuality.qualityInfo@hor_Range, sphRegionQuality.qualityInfo@ver_range present.

In one example, according to the techniques described herein, media presentation description generator 502 may be configured to generate spherical region-wise quality ranking descriptor based on the following example definition:

A SupplementalProperty element with a @ schemeIdUri attribute equal to “urn:mpeg:omaf:srqr:2017” is referred to as a spherical region-wise quality ranking (SRQR) descriptor. At most one SRQR descriptor for each sphRegionQuality @shape_type value of 0 and 1 may be present at adaptation set level. At most one SRQR descriptor for each sphRegionQuality @shape_type value of 0 and 1 may be present at representation level. A SRQR descriptor shall not be present at MPD level. The SRQR descriptor indicates a quality ranking value of a quality ranking sphere region relative to other quality ranking sphere regions in the same Adaptation Set and relative to SRQR descriptors and @qualityRanking values in all Adaptation Sets that have the same @ value in the DASH Viewpoint element as the Adaptation Set containing this SRQR descriptor or containing the Representation that contains this SRQR descriptor. The sphere region for the quality-ranking is specified by syntax elements shape_type, center_azimuth, center_elevation, center_tilt, hor_range, ver_range in SphereRegionStruct as specified in clause 7.5 of Choi_1. When the quality ranking value sphRegionQuality.qualityinfo@quality_ranking is non-zero, the picture quality within the entire indicated quality ranking sphere region is approximately constant. The @ value attribute of the SRQR descriptor shall not be present. The SRQR descriptor shall include a sphRegionQuality element with its sub-elements and attributes as specified in Table 19B:

TABLE 19B

| Elements and | | | |
|---|---|---|---|
| attributes for | | | |
| SRQR descriptor | Use | Data type | Description |
| sphRegionQuality | 1 | omaf:SphRegionQuality | Container element which includes one or more quality |
| | | Type | information elements (sphRegionQuality.qualityInfo) |
| | | | and common set of attributes |
| | | | (sphRegionQuality@shape_type, |
| | | | sphRegionQuality@remaining_area_flag, |
| | | | sphRegionQuality@view_idc_presence_flag, |
| | | | sphRegionQuality@default_view_idc) that apply to all |
| | | | those quality information elements. |
| sphRegionQuality | O | xs: unsignedByte | Value 0 specifies that the quality ranking sphere region |
| @shape_type | | | is indicated through four great circles as specified in |
| | | | clause 7.5.2.3 of Choi_1. Value 1 specifies that the |
| | | | quality ranking sphere region is indicated through two |
| | | | azimuth and two elevation circles as specified in clause |
| | | | 7.5.2.3 of Choi_1. When not present |
| | | | sphRegionQuality@shape_type is inferred to be equal |
| | | | to 0. |
| sphRegionQuality | O | xs:boolean | Value 0 specifies that all the quality ranking sphere |
| @remaining_area_flag | | | regions are specified by the signalled |
| | | | sphRegionQuality.qualityInfo elements. Value 1 |
| | | | specifies that all except the last quality ranking sphere |
| | | | regions are specified by the signalled |
| | | | sphRegionQuality.qualityInfo elements, and the last |
| | | | remaining quality ranking sphere region is the sphere |
| | | | region within the coverage sphere region, not covered |
| | | | by the union of the quality ranking sphere regions |
| | | | specified by the signalled |
| | | | sphRegionQuality.qualityInfo elements. When not |
| | | | present sphRegionQuality@remaining_area_flag is |
| | | | inferred to be equal to 0. |
| sphRegionQuality | O | xs:boolean | Value 0 specifies that |
| @view_idc_presence_flag | | | sphRegionQuality.qualityInfo@view_idc is not |
| | | | signalled in each sphRegionQuality.qualityInfo |
| | | | element. Value 1 specifies that |
| | | | sphRegionQuality.qualityInfo@view_idc is signalled |
| | | | and indicates the association of quality ranking sphere |
| | | | regions with particular (left or right or both) views or |
| | | | monoscopic content. When not present |
| | | | sphRegionQuality@view_idc_presence_flag is inferred |
| | | | to be equal to 0. |
| sphRegionQuality | M | xs:boolean | Value 0 specifies that quality_rankings specified |
| @quality_ranking_local_flag | | | indicates a quality ranking value of a quality ranking |
| | | | sphere region relative to other quality ranking sphere |
| | | | regions in the same Adaptation Set and relative to |
| | | | SRQR descriptors and @qualityRanking values in all |
| | | | Adaptation Sets that have the same @value in the |
| | | | DASH Viewpoint element as the Adaptation Set |
| | | | containing this SRQR descriptor. Value 1 that |
| | | | quality_rankings specified indicates a quality ranking |
| | | | value of a quality ranking sphere region relative to |
| | | | other quality ranking sphere regions in the same |
| | | | Adaptation Set only. When not present a value of 0 is |
| | | | inferred. |
| | | | NOTE - |
| | | | sphRegionQuality@quality_ranking_local_flag equal |
| | | | to 0 might be used in combination with Preselection |
| | | | and the quality rankings of sphere regions with |
| | | | sphRegionQuality@quality_ranking_local_flag equal |
| | | | to 1 may be present in Adaptation Sets that are not the |
| | | | Main Adaptation Sets of a Preselection. |
| sphRegionQuality | M | omaf:QualityType | indicates which factor causes the differences in the |
| @quality_type | | | quality of packed regions on the picture. Value 0 |
| | | | specifies that all packed regions correspond to the same |
| | | | projected picture resolution. Value 1 specifies that at |
| | | | least one horRatio value, as derived in 5.4, may differ |
| | | | from other horRatio values among all pairs of packed |
| | | | and projected regions of the picture or at least one |
| | | | verRatio value, as derived in 5.4, may differ from other |
| | | | verRatio values among all pairs of packed and |
| | | | projected regions of the picture. Values greater 1 are |
| | | | reserved. |
| sphRegionQuality | CM | omaf:ViewType | Value 0 indicates that all the quality ranking sphere |
| @default_view_idc | | | regions are monoscopic. Value 1 indicates that all the |
| | | | quality ranking sphere regions are on the left view of |
| | | | stereoscopic content. Value 2 indicates that all the |
| | | | quality ranking sphere regions are on the right view of |
| | | | stereoscopic content. Value 3 indicates that all the |
| | | | quality ranking sphere regions are on both the left and |
| | | | right views. sphRegionQuality@default_view_idc shall |
| | | | be present when |
| | | | sphRegionQuality@view_idc_presence_flag is equal to |
| | | | 0. sphRegionQuality@default_view_idc shall be absent |
| | | | when sphRegionQuality@view_idc_presence_flag is |
| | | | equal to 1. |
| sphRegionQuality.quality | 1 . . . 255 | omaf:QualityInfoType | Element whose attribute |
| Info | | | sphRegionQuality.qualityinfo@quality_ranking |
| | | | provides quality ranking for one quality ranking sphere |
| | | | region described by its attributes |
| | | | sphRegionQuality.qualityInfo@view_idc, |
| | | | sphRegionQuality.qualityInfo@center_azimuth, |
| | | | sphRegionQuality.qualityInfo@center_elevation, |
| | | | sphRegionQuality.qualityInfo@center_tilt, |
| | | | sphRegionQuality.qualityInfo@hor_range, |
| | | | sphRegionQuality.qualityInfo@ver_range. |
| sphRegionQuality.quality | M | xs:unsignedByte | specifies a quality ranking value of the quality ranking |
| Info@quality_ranking | | | sphere region. |
| | | | sphRegionQuality.qualityinfo@quality_ranking equal |
| | | | to 0 indicates that the quality ranking is not defined. |
| | | | When quality ranking sphere region A has a non-zero |
| | | | sphRegionQuality.qualityinfo@quality_ranking value |
| | | | less than the |
| | | | sphRegionQuality.qualityinfo@quality_ranking value |
| | | | of quality ranking sphere region B, quality ranking |
| | | | sphere region A has a higher quality than quality |
| | | | ranking sphere region B. When quality ranking sphere |
| | | | region A partly or entirely overlaps with quality ranking |
| | | | sphere region B, |
| | | | sphRegionQuality.qualityinfo@quality_ranking of |
| | | | quality ranking sphere region A shall be equal to |
| | | | spbRegionQuality.qualityinfo@quality_ranking of |
| | | | quality ranking sphere region B. |
| sphRegionQuality.quality | O | omaf:ViewType | 0 indicates that the content is monoscopic, 1 indicates |
| Info@view_idc | | | that the quality ranking sphere region is on the left view |
| | | | of stereoscopic content, 2 indicates that the quality |
| | | | ranking sphere region is on the right view of |
| | | | stereoscopic content, 3 indicates that the quality ranking |
| | | | sphere region is on both the left and right views. |
| | | | sphRegionQuality.qualityInfo@view_idc shall be |
| | | | present when |
| | | | sphRegionQuality@view_idc_presence_flag is equal to |
| | | | 1. sphRegionQuality.qualityInfo@view_idc shall be |
| | | | absent when |
| | | | sphRegionQuality@view_idc_presence_flag is equal to |
| | | | 0. |
| sphRegionQuality.quality | CM | xs:unsignedShort | width of such a monoscopic projected picture for which |
| Info@orig_width | | | horRatio, as derived in 5.4 of Choi_1 for each of the |
| | | | packed regions that cover the quality ranking 2D |
| | | | region, is equal to 1. Shall not be present when |
| | | | sphRegionQuality@quality_type is equal to 1. Shall be |
| | | | present when sphDRegionQuality@quality_type is |
| | | | equal to 1. |
| sphRegionQuality.quality | CM | xs:unsignedShort | height of such a monoscopic projected picture for which |
| Info@orig_height | | | horRatio, as derived in 5.4 of Choi_1 for each of the |
| | | | packed regions that cover the quality ranking 2D |
| | | | region, is equal to 1. Shall not be present when |
| | | | sphDRegionQuality@quality_type is equal to 1. Shall |
| | | | be present when sphDRegionQuality@quality_type is |
| | | | equal to 1. |
| sphRegionQuality.quality | CM | omaf:Range1 | Specifies the azimuth of the center point of the quality |
| Info@center_azimuth | | | ranking sphere region, in degrees, relative to the global |
| | | | coordinate axes. |
| | | | sphRegionQuality.qualityInfo@center_azimuth shall be |
| | | | present when sphRegionQuality@remaining_area_flag |
| | | | is equal to 0. |
| | | | sphRegionQuality.qualityInfo@center_azimuth shall be |
| | | | absent in only one sphRegionQuality.qualityInfo |
| | | | element and shall be present in all the other |
| | | | sphRegionQuality.qualityInfo elements when |
| | | | sphRegionQuality@remaining_area_flag is equal to 1. |
| sphRegionQuality.quality | CM | omaf:Range2 | Specifies the pitch of the center point of the quality |
| Info@center_elevation | | | ranking sphere region, in degrees, relative to the global |
| | | | coordinate axes. |
| | | | sphRegionQuality.qualityInfo@center_elevation shall |
| | | | be present when |
| | | | sphRegionQuality@remaining_area_flag is equal to 0. |
| | | | sphRegionQuality.qualityInfo@center_elevation shall |
| | | | be absent in only one sphRegionQuality.qualityInfo |
| | | | element and shall be present in all the other |
| | | | sphRegionQuality.qualityInfo elements when |
| | | | sphRegionQuality@remaining_area_flag is equal to 1. |
| sphRegionQuality.quality | CM | omaf:Range1 | Specifies the tilt angle for the quality ranking sphere |
| Info@center_tilt | | | region. sphRegionQuality.qualityInfo@center_tilt shall |
| | | | be present when |
| | | | sphRegionQuality@remaining_area_flag is equal to 0. |
| | | | sphRegionQuality.qualityInfo@center_tilt shall be |
| | | | absent in only one one sphRegionQuality.qualityInfo |
| | | | element and shall be present in all the other |
| | | | sphRegionQuality.qualityInfo elements when |
| | | | sphRegionQuality@remaining_area_flag is equal to 1. |
| sphRegionQuality.quality | CM | omaf:HRange | Specifies the horizontal range of the quality ranking |
| Info@azimuth_range | | | sphere region through its center point. |
| | | | sphRegionQuality.qualityInfo@hor_range shall be |
| | | | present when spbRegionQuality@remaining_area_flag |
| | | | is equal to 0. sphRegionQuality.qualityInfo@hor_range |
| | | | shall be absent in only one |
| | | | sphRegionQuality.qualityInfo element and shall be |
| | | | present in all the other sphRegionQuality.qualityInfo |
| | | | elements when |
| | | | sphRegionQuality@remaining_area_flag is equal to 1. |
| sphRegionQuality.quality | CM | omaf:VRange | Specifies the vertical range of the quality raking sphere |
| Info@elevation_range | | | region through its center point. |
| | | | sphRegionQuality.qualityInfo@ver_range shall be |
| | | | present when sphRegionQuality@remaining_area_flag |
| | | | is equal to 0. sphRegionQuality.qualityInfo@ver_range |
| | | | shall be absent in only one |
| | | | sphRegionQuality.qualityInfo element and shall be |
| | | | present in all the other sphRegionQuality.qualityInfo |
| | | | elements when |
| | | | sphRegionQuality@remaining_area_flag is equal to 1. |

NOTE: A player is recommended to parse spherical region-wise quality ranking (SRQR) descriptors and select the Adaptation Sets and Representations that match the user's viewing orientation in a manner that:
The quality ranking value on the region covering the viewport is greater than 0 and less than that for other regions.
The resolution of the region covering the viewport is suitable for the display. If sphRegionQuality @quality_type equal to 1, sphRegionQuality.qualityInfo @orig_width and sphRegionQuality.qualityInfo @orig_height represent the width and height of the monoscopic projected picture from which the packed region covering the viewport has been extracted. Otherwise, width and height of VisualSampleEntry can be used to conclude the resolution on the viewport.

FIGS. 19C-19D is a computer program listing illustrating examples of signaling metadata according to one or more techniques of this disclosure. FIGS. 19C-19D illustrates an example of a defined XML schema corresponding to the example SRQR descriptor described with respect to Table 19B. In one example, the data type of elements and attributes in Table 19B will be as defined in the schema in FIGS. 19C-19D. In one example, the schema illustrated in FIGS. 19C-19D shall be represented in a XML schema that has namespace-urn:mpeg:mpegI:omaf:2017.

In one example, according to the techniques described herein, media presentation description generator 502 may be configured to generate a 2D region-wise quality ranking descriptor. In one example, a 2D region-wise quality ranking descriptor may be based on the following example definition:

A SupplementalProperty element with a @ schemeIdUri attribute equal to “urn:mpeg:omaf:2dqr:2017” is referred to as a 2D region-wise quality ranking (2DQR) descriptor. At most one 2DQR descriptor may be present at adaptation set level. At most one 2DQR descriptor may be present at representation level. A 2DQR descriptor shall not be present at MPD level. The 2DQR descriptor indicates a quality ranking value of a quality ranking 2D region relative to other quality ranking 2D regions in the same Adaptation Set and relative to 2DQR descriptors and @qualityRanking values in all Adaptation Sets that have the same @ value in the DASH Viewpoint element as the Adaptation Set containing this 2DQR descriptor or containing the Representation that contains this 2DQR descriptor. When the quality ranking value twoDRegionQuality.twoDqualityinfo @ quality ranking is non-zero, the picture quality within the entire indicated quality ranking 2D region is approximately constant. The @ value attribute of the 2DQR descriptor shall not be present. The 2DQR descriptor shall include a twoDRegionQuality element with its sub-elements and attributes as specified in Table 20:

TABLE 20A

| Elements and | | | |
|---|---|---|---|
| attributes for | | | |
| 2DQR descriptor | Use | Data type | Description |
| twoDRegionQuality | 1 | omaf:twoDRegion | Container element which include one or more 2D region quality |
| | | QualityType | information elements (twoDRegionQuality.twoDqualityInfo) and |
| | | | common set of attributes (twoDRegionQuality |
| | | | @remaining_area_flag, twoDRegionQuality |
| | | | @view_idc_presence_flag, twoDRegionQuality |
| | | | @default_view_idc) that apply to all those quality information |
| | | | elements. |
| twoDRegionQuality | O | xs:boolean | Value 0 specifies that all the quality ranking 2D regions are |
| @remaining_area_flag | | | specified by the signalled twoDRegionQuality.twoDqualityInfo |
| | | | elements. Value 1 specifies that all except the last quality |
| | | | ranking 2D regions are specified by the signalled |
| | | | twoDRegionQuality.twoDqualityInfo elements, and the last |
| | | | remaining quality ranking 2D region is the 2D region within the |
| | | | coverage sphere region, not covered by the union of the quality |
| | | | ranking 2D regions specified by the signalled |
| | | | twoDRegionQuality.twoDqualityInfo elements. |
| twoDRegionQuality | O | xs:boolean | Value 0 specifies that |
| @view_idc_presence_flag | | | twoDRegionQuality.twoDqualityInfo@view_idc is not signalled. |
| | | | Value 1 specifies that |
| | | | twoDRegionQuality.twoDqualityInfo@view_idc is signalled and |
| | | | indicates the association of quality ranking 2D regions with |
| | | | particular (left or right or both) views or monoscopic content. |
| | | | When not present twoDRegionQuality |
| | | | @view_idc_presence_flag is inferred to be equal to 0. |
| twoDRegionQuality | CM | omaf:ViewType | Value 0 indicates that all the quality ranking 2D regions are |
| @default_view_idc | | | monoscopic. Value 1 indicates that all the quality ranking 2D |
| | | | regions are on the left view of stereoscopic content. Value 2 |
| | | | indicates that all the quality ranking 2D regions are on the right |
| | | | view of stereoscopic content. Value 3 indicates that all the |
| | | | quality ranking 2D regions are on both the left and right views. |
| | | | twoDRegionQuality@default_view_idc shall be present when |
| | | | twoDRegionQuality@view_idc_presence_flag is equal to 0. |
| | | | twoDRegionQuality@default_view_idc shall be absent when |
| | | | twoDRegionQuality@view_idc_presence_flag is equal to 1. |
| twoDRegionQuality. | 1 . . . 255 | omaf:twoDQuality | Element whose attribute |
| twoDqualityInfo | | InfoType | twoDRegionQuality.twoDqualityinfo@quality_ranking provides |
| | | | quality ranking for one quality ranking 2D region described by |
| | | | its attributes twoDRegionQuality.twoDqualityInfo@view_idc, |
| | | | twoDRegionQuality.twoDqualityInfo@left_offset, |
| | | | twoDRegionQuality.twoDqualityInfo@top_offset, |
| | | | twoDRegionQuality.twoDqualityInfo@region_width, |
| | | | twoDRegionQuality.twoDqualityInfo@region_height. |
| twoDRegionQuality. | M | xs:unsignedByte | specifies a quality ranking value of the quality ranking 2D |
| twoDqualityinfo | | | region. twoDRegionQuality.twoDqualityinfo@quality_ranking |
| @quality_ranking | | | equal to 0 indicates that the quality ranking is not defined. When |
| | | | quality ranking 2D region A has a non-zero |
| | | | twoDRegionQuality.twoDqualityinfo@quality_ranking value |
| | | | less than the |
| | | | twoDRegionQuality.twoDqualityinfo@quality_ranking value of |
| | | | quality ranking 2D region B, quality ranking 2D region A has a |
| | | | higher quality than quality ranking 2D region B. When quality |
| | | | ranking 2D region A partly or entirely overlaps with quality |
| | | | ranking 2D region B, |
| | | | twoDRegionQuality.twoDqualityinfo@quality_ranking of |
| | | | quality ranking 2D region A shall be equal to |
| | | | twoDRegionQuality.twoDqualityinfo@quality_ranking of |
| | | | quality ranking 2D region B. |
| twoDRegionQuality. | O | omaf:ViewType | 0 indicates that the content is monoscopic, 1 indicates that the |
| twoDqualityInfo | | | quality ranking 2D region is on the left view of stereoscopic |
| @view_idc | | | content, 2 indicates that the quality ranking 2D region is on the |
| | | | right view of stereoscopic content, 3 indicates that the quality |
| | | | ranking 2D region is on both the left and right views. |
| | | | twoDRegionQuality.twoDqualityInfo@view_idc shall be present |
| | | | when twoDRegionQuality@view_idc_presence_flag is equal to |
| | | | 1. twoDRegionQuality.twoDqualityInfo@view_idc shall be |
| | | | absent when twoDRegionQuality@view_idc_presence_flag is |
| | | | equal to 0. |
| twoDRegionQuality. | CM | xs:unsignedInt | Specifies the horizontal coordinate of the upper left corner of the |
| twoDqualityInfo | | | quality ranking 2D region within the picture in visual |
| @left_offset | | | presentation size of the 2D representation. |
| | | | twoDRegionQuality.twoDqualityInfo@left_offset shall be |
| | | | present when twoDRegionQuality@remaining_area_flag is equal |
| | | | to 0. twoDRegionQuality.twoDqualityInfo@left_offset shall be |
| | | | absent in only one twoDRegionQuality.twoDqualityInfo element |
| | | | and shall be present in all the other |
| | | | twoDRegionQuality.twoDqualityInfo elements when |
| | | | twoDRegionQuality@remaining_area_flag is equal to 1. |
| twoDRegionQuality. | CM | xs:unsignedInt | Specifies the vertical coordinate of the upper left corner of the |
| twoDqualityInfo | | | quality ranking 2D region within the picture in visual |
| @top_offset | | | presentation size of the 2D representation. |
| | | | twoDRegionQuality.twoDqualityInfo@top_offset shall be |
| | | | present when twoDRegionQuality@remaining_area_flag is equal |
| | | | to 0. twoDRegionQuality.twoDqualityInfo@top_offset shall be |
| | | | absent in only one twoDRegionQuality.twoDqualityInfo element |
| | | | and shall be present in all the other |
| | | | twoDRegionQuality.twoDqualityInfo elements when |
| | | | twoDRegionQuality@remaining_area_flag is equal to 1. |
| twoDRegionQuality. | CM | xs:unsignedInt | Specifies the width of the quality ranking 2D region within the |
| twoDqualityInfo | | | picture in visual presentation size of the 2D representation. |
| @region_width | | | twoDRegionQuality.twoDqualityInfo@region_width shall be |
| | | | present when twoDRegionQuality@remaining_area_flag is equal |
| | | | to 0. twoDRegionQuality.twoDqualityInfo@region_width shall |
| | | | be absent in only one twoDRegionQuality.twoDqualityInfo |
| | | | element and shall be present in all the other |
| | | | twoDRegionQuality.twoDqualityInfo elements when |
| | | | twoDRegionQuality@remaining_area_flag is equal to 1. |
| twoDRegionQuality. | CM | xs:unsignedInt | Specifies the height of the quality ranking 2D region within the |
| twoDqualityInfo | | | picture in visual presentation size of the 2D representation. |
| @region_height | | | twoDRegionQuality.twoDqualityInfo@region_height shall be |
| | | | present when twoDRegionQuality@remaining_area_flag is equal |
| | | | to 0. twoDRegionQuality.twoDqualityInfo@region_height shall |
| | | | be absent in only one twoDRegionQuality.twoDqualityInfo |
| | | | element and shall be present in all the other |
| | | | twoDRegionQuality.twoDqualityInfo elements when |
| | | | twoDRegionQuality@remaining_area_flag is equal to 1. |

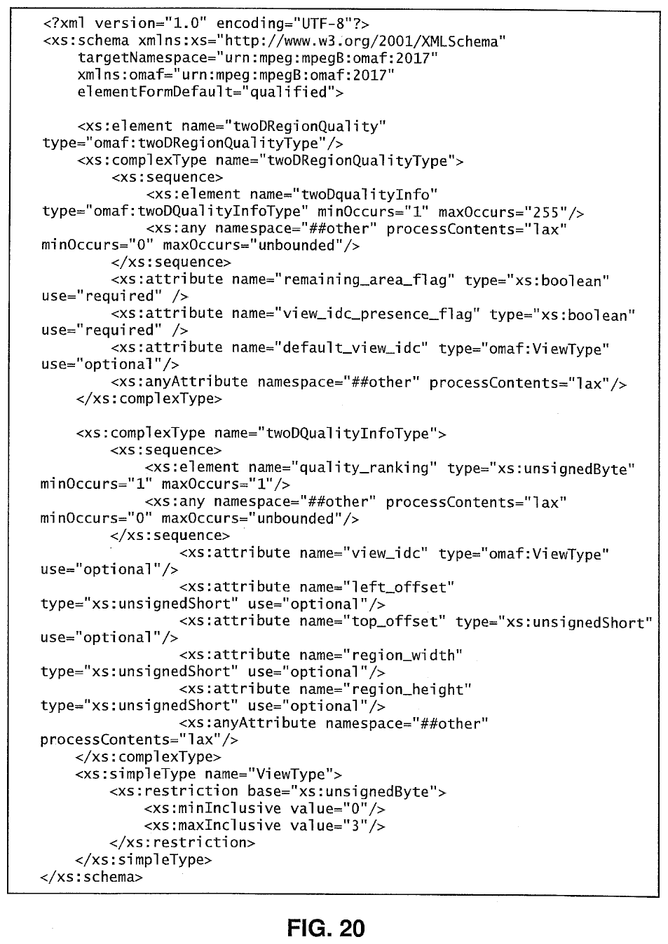

FIG. 20 is a computer program listing illustrating examples of signaling metadata according to one or more techniques of this disclosure. FIG. 20 illustrates an example of a defined XML schema corresponding to the example 2DQR descriptor described with respect to Table 20A. In one example, the data type of elements and attributes in Table 20A will be as defined in the schema in FIG. 20. In one example, the schema illustrated in FIG. 20 shall be represented in a XML schema that has namespaceurn:mpeg:mpegB:omaf:2017.

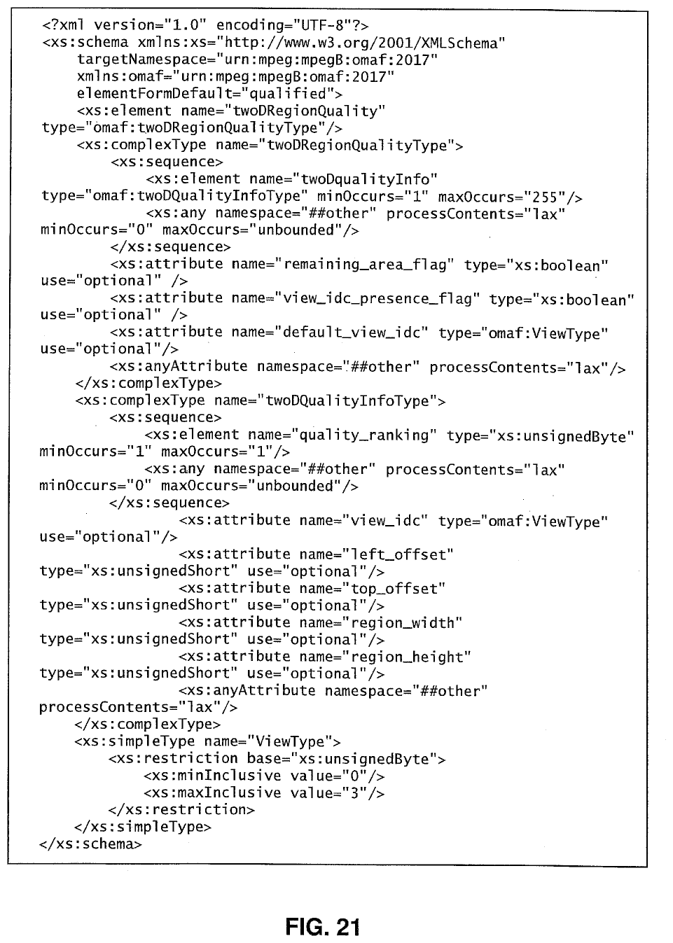

In another example, FIG. 21 is a computer program listing illustrating examples of signaling metadata according to one or more techniques of this disclosure. FIG. 21 illustrates an example of a defined XML schema corresponding to the example 2DQR descriptor described with respect to Table 20A. In one example, the data type of elements and attributes in Table 20A will be as defined in the schema in FIG. 21. In one example, the schema illustrated in FIG. 121 shall be represented in a XML schema that has namespace-urn:mpeg:mpegB:omaf:2017.

It should be noted that the difference between the computer program listing in FIG. 20 and FIG. 21 is that in the FIG. 21 the attributes twoDRegionQuality @remaining_area_flag, twoDRegionQuality @ view_idc_presence_flag are optional where as they are required in FIG. 20. Making these attributes optional and assigning default values to them saves bits when signaling.

In one example, the following constraints may be applied to a 2DQR descriptor:
When twoDRegionQuality@remaining_area_flag is equal to 0 all twoDRegionQuality.twoDqualityInfo elements shall have each of the attributes twoDRegionQuality.twoDqualityInfo@left_offset, twoDRegionQuality.twoDqualityInfo@top_offset, twoDRegionQuality.twoDqualityInfo@region_width, twoDRegionQuality.twoDqualityInfo@region_height present.
When twoDRegionQuality @remaining_area_flag is equal to 1 only one twoDRegionQuality.twoDqualityInfo element shall have each of the attributes twoDRegionQuality.twoDqualityInfo@left_offset, twoDRegionQuality.twoDqualityInfo@top_offset, twoDRegionQuality.twoDqualityInfo@region_width, twoDRegionQuality.twoDqualityInfo@region_height absent and all the other twoDRegionQuality.twoDqualityInfo elements shall have each of the attributes twoDRegionQuality.twoDqualityInfo@left_offset, twoDRegionQuality.twoDqualityInfo@top_offset, twoDRegionQuality.twoDqualityInfo@region_width, twoDRegionQuality.twoDqualityInfo@region_height present.

In one example, according to the techniques described herein, media presentation description generator 502 may be configured to generate a 2D region-wise quality ranking descriptor based on the following example definition:

A SupplementalProperty element with a @ schemeIdUri attribute equal to “urn:mpeg:omaf:2dqr:2017” is referred to as a 2D region-wise quality ranking (2DQR) descriptor. At most one 2DQR descriptor may be present at adaptation set level. At most one 2DQR descriptor may be present at representation level. A 2DQR descriptor shall not be present at MPD level. The 2DQR descriptor indicates a quality ranking value of a quality ranking 2D region relative to other quality ranking 2D regions in the same Adaptation Set and relative to 2DQR descriptors and @qualityRanking values in all Adaptation Sets that have the same @ value in the DASH Viewpoint element as the Adaptation Set containing this 2DQR descriptor or containing the Representation that contains this 2DQR descriptor. When the quality ranking value twoDRegionQuality.twoDqualityinfo @quality_ranking is non-zero, the picture quality within the entire indicated quality ranking 2D region is approximately constant. The @ value attribute of the 2DQR descriptor shall not be present. The 2DQR descriptor shall include a twoDRegionQuality element with its sub-elements and attributes as specified in Table 20B:

TABLE 20B

| Elements and | | | |
|---|---|---|---|
| attributes for | | | |
| 2DQR descriptor | Use | Data type | Description |
| twoDRegionQuality | 1 | omaf:twoDRegion | Container element which include one or more 2D region quality |
| | | Quality | information elements (twoDRegionQuality.twoDqualityInfo) and |
| | | Type | common set of attributes (twoDRegionQuality |
| | | | @remaining_area_flag, twoDRegionQuality |
| | | | @view_idc_presence_flag, twoDRegionQuality |
| | | | @default_view_idc) that apply to all those quality information |
| | | | elements. |
| twoDRegionQuality | O | xs:boolean | Value 0 specifies that all the quality ranking 2D regions are |
| @remaining_area_flag | | | specified by the signalled twoDRegionQuality.twoDqualityInfo |
| | | | elements. Value 1 specifies that all except the last quality |
| | | | ranking 2D regions are specified by the signalled |
| | | | twoDRegionQuality.twoDqualityInfo elements, and the last |
| | | | remaining quality ranking 2D region is the 2D region within the |
| | | | coverage sphere region, not covered by the union of the quality |
| | | | ranking 2D regions specified by the signalled |
| | | | twoDRegionQuality.twoDqualityInfo elements. |
| twoDRegionQuality | O | xs:boolean | Value 0 specifies that |
| @view_idc_presence_flag | | | twoDRegionQuality.twoDqualityInfo@view_idc is not signalled. |
| | | | Value 1 specifies that |
| | | | twoDRegionQuality.twoDqualityInfo@view_idc is signalled and |
| | | | indicates the association of quality ranking 2D regions with |
| | | | particular (left or right or both) views or monoscopic content. |
| | | | When not present twoDRegionQuality |
| | | | @view_idc_presence_flag is inferred to be equal to 0. |
| twoDRegionQuality | O | xs:boolean | Value 0 specifies that quality_rankings specified indicates a |
| @quality_ranking_local_flag | | | quality ranking value of a quality ranking sphere region relative |
| | | | to other quality ranking sphere regions in the same Adaptation |
| | | | Set and relative to SRQR descriptors and @qualityRanking |
| | | | values in all Adaptation Sets that have the same @value in the |
| | | | DASH Viewpoint element as the Adaptation Set containing this |
| | | | SRQR descriptor. Value 1 that quality rankings specified |
| | | | indicates a quality ranking value of a quality ranking sphere |
| | | | region relative to other quality ranking sphere regions in the |
| | | | same Adaptation Set only. When not present a value of 0 is |
| | | | inferred. |
| | | | NOTE—twoDRegionQuality@quality_ranking_local_flag equal |
| | | | to 0 might be used in combination with Preselection and the |
| | | | quality rankings of sphere regions with |
| | | | twoDRegionQuality@quality_ranking_local_flag equal to 1 may |
| | | | be present in Adaptation Sets that are not the Main Adaptation |
| | | | Sets of a Preselection. |
| twoDRegionQuality | M | omaf:Quality | indicates which factor causes the differences in the quality of |
| @quality_type | | Type | packed regions on the picture. Value 0 specifies that all packed |
| | | | regions correspond to the same projected picture resolution. |
| | | | Value 1 specifies that at least one horRatio value, as derived in |
| | | | 5.4, may differ from other horRatio values among all pairs of |
| | | | packed and projected regions of the picture or at least one |
| | | | verRatio value, as derived in 5.4, may differ from other verRatio |
| | | | values among all pairs of packed and projected regions of the |
| | | | picture. Values greater 1 are reserved. |
| twoDRegionQuality | CM | omaf:ViewType | Value 0 indicates that all the quality ranking 2D regions are |
| @default_view_idc | | | monoscopic. Value 1 indicates that all the quality ranking 2D |
| | | | regions are on the left view of stereoscopic content. Value 2 |
| | | | indicates that all the quality ranking 2D regions are on the right |
| | | | view of stereoscopic content. Value 3 indicates that all the |
| | | | quality ranking 2D regions are on both the left and right views. |
| | | | twoDRegionQuality@default_view_idc shall be present when |
| | | | twoDRegionQuality@view_idc_presence_flag is equal to 0. |
| | | | twoDRegionQuality@default_view_idc shall be absent when |
| | | | twoDRegionQuality@view_idc_presence_flag is equal to 1. |
| twoDRegionQuality. | 1 . . . 255 | omaf:twoDQuality | Element whose attribute |
| twoDqualityInfo | | InfoType | twoDRegionQuality.twoDqualityinfo@quality_ranking provides |
| | | | quality ranking for one quality ranking 2D region described by |
| | | | its attributes twoDRegionQuality.twoDqualityInfo@view_idc, |
| | | | twoDRegionQuality.twoDqualityInfo@left_offset, |
| | | | twoDRegionQuality.twoDqualityInfo@top_offset, |
| | | | twoDRegionQuality.twoDqualityInfo@region_width, |
| | | | twoDRegionQuality.twoDqualityInfo@region_height. |
| twoDRegionQuality. | M | xs:unsignedByte | specifies a quality ranking value of the quality ranking 2D |
| twoDqualityinfo | | | region. twoDRegionQuality.twoDqualityinfo@quality_ranking |
| @quality_ranking | | | equal to 0 indicates that the quality ranking is not defined. When |
| | | | quality ranking 2D region A has a non-zero |
| | | | twoDRegionQuality.twoDqualityinfo@quality_ranking value |
| | | | less than the |
| | | | twoDRegionQuality.twoDqualityinfo@quality_ranking value of |
| | | | quality ranking 2D region B, quality ranking 2D region A has a |
| | | | higher quality than quality ranking 2D region B. When quality |
| | | | ranking 2D region A partly or entirely overlaps with quality |
| | | | ranking 2D region B, |
| | | | twoDRegionQuality.twoDqualityinfo@quality_ranking of |
| | | | quality ranking 2D region A shall be equal to |
| | | | twoDRegionQuality.twoDqualityinfo@quality_ranking of |
| | | | quality ranking 2D region B. |
| twoDRegionQuality. | O | omaf:ViewType | 0 indicates that the content is monoscopic, 1 indicates that the |
| twoDqualityInfo | | | quality ranking 2D region is on the left view of stereoscopic |
| @view_idc | | | content, 2 indicates that the quality ranking 2D region is on the |
| | | | right view of stereoscopic content, 3 indicates that the quality |
| | | | ranking 2D region is on both the left and right views. |
| | | | twoDRegionQuality.twoDqualityInfo@view_idc shall be present |
| | | | when twoDRegionQuality@view_idc_presence_flag is equal to |
| | | | 1. twoDRegionQuality.twoDqualityInfo@view_idc shall be |
| | | | absent when twoDRegionQuality@view_idc_presence_flag is |
| | | | equal to 0. |
| twoDRegionQuality. | CM | xs:unsignedShort | width of such a monoscopic projected picture for which |
| qualityInfo@orig_width | | | horRatio, as derived in 5.4 of Choi_1 for each of the packed |
| | | | regions that cover the quality ranking 2D region, is equal to 1. |
| | | | Shall not be present when twoDRegionQuality@quality_type is |
| | | | equal to 1. Shall be present when |
| | | | twoDRegionQuality@quality_type is equal to 1. |
| twoDRegionQuality. | CM | xs:unsignedShort | height of such a monoscopic projected picture for which |
| qualityInfo@orig_height | | | horRatio, as derived in 5.4 of Choi_1 for each of the packed |
| | | | regions that cover the quality ranking 2D region, is equal to 1. |
| | | | Shall not be present when twoDRegionQuality@quality_type is |
| | | | equal to 1. Shall be present when |
| | | | twoDRegionQuality@quality_type is equal to 1. |
| twoDRegionQuality. | CM | xs:unsignedInt | Specifies the horizontal coordinate of the upper left corner of the |
| twoDqualityInfo | | | quality ranking 2D region within the picture in visual |
| @left_offset | | | presentation size of the 2D representation. |
| | | | twoDRegionQuality.twoDqualityInfo@left_offset shall be |
| | | | present when twoDRegionQuality@remaining_area_flag is equal |
| | | | to 0. twoDRegionQuality.twoDqualityInfo@left_offset shall be |
| | | | absent in only one twoDRegionQuality.twoDqualityInfo element |
| | | | and shall be present in all the other |
| | | | twoDRegionQuality.twoDqualityInfo elements when |
| | | | twoDRegionQuality@remaining_area_flag is equal to 1. |
| twoDRegionQuality. | CM | xs:unsignedInt | Specifies the vertical coordinate of the upper left comer of the |
| twoDqualityInfo | | | quality ranking 2D region within the picture in visual |
| @top_offset | | | presentation size of the 2D representation. |
| | | | twoDRegionQuality.twoDqualityInfo@top_offset shall be |
| | | | present when twoDRegionQuality@remaining_area_flag is equal |
| | | | to 0. twoDRegionQuality.twoDqualityInfo@top_offset shall be |
| | | | absent in only one twoDRegionQuality.twoDqualityInfo element |
| | | | and shall be present in all the other |
| | | | twoDRegionQuality.twoDqualityInfo elements when |
| | | | twoDRegionQuality@remaining_area_flag is equal to 1. |
| twoDRegionQuality. | CM | xs:unsignedInt | Specifies the width of the quality ranking 2D region within the |
| twoDqualityInfo | | | picture in visual presentation size of the 2D representation. |
| @region_width | | | twoDRegionQuality.twoDqualityInfo@region_width shall be |
| | | | present when twoDRegionQuality@remaining_area_flag is equal |
| | | | to 0. twoDRegionQuality.twoDqualityInfo@region_width shall |
| | | | be absent in only one twoDRegionQuality.twoDqualityInfo |
| | | | element and shall be present in all the other |
| | | | twoDRegionQuality.twoDqualityInfo elements when |
| | | | twoDRegionQuality@remaining_area_flag is equal to 1. |
| twoDRegionQuality. | CM | xs:unsignedInt | Specifies the height of the quality ranking 2D region within the |
| twoDqualityInfo | | | picture in visual presentation size of the 2D representation. |
| @region_height | | | twoDRegionQuality.twoDqualityInfo@region_height shall be |
| | | | present when twoDRegionQuality@remaining_area_flag is equal |
| | | | to 0. twoDRegionQuality.twoDqualityInfo@region_height shall |
| | | | be absent in only one twoDRegionQuality.twoDqualityInfo |
| | | | element and shall be present in all the other |
| | | | twoDRegionQuality.twoDqualityInfo elements when |
| | | | twoDRegionQuality@remaining_area_flag is equal to 1. |

NOTE: A player is recommended to parse 2D region-wise quality ranking (2DQR) descriptors and select the Adaptation Sets and Representations that match the user's viewing orientation in a manner that:
The quality ranking value on the region covering the viewport is greater than 0 and less than that for other regions.
The resolution of the region covering the viewport is suitable for the display. If twoDRegionQuality@quality_type equal to 1, twopDRegionQuality.qualityInfo @orig_width and twoDRegionQuality.qualityInfo@orig_height represent the width and height of the monoscopic projected picture from which the packed region covering the viewport has been extracted. Otherwise, width and height of VisualSampleEntry can be used to conclude the resolution on the viewport.

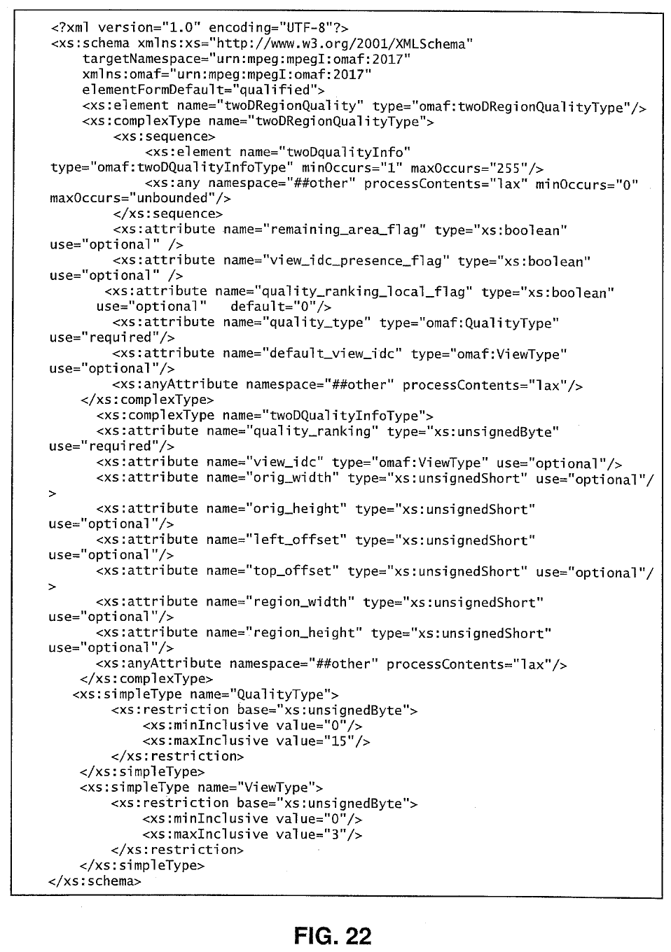

FIG. 22 is a computer program listing illustrating examples of signaling metadata according to one or more techniques of this disclosure. FIG. 22 illustrates an example of a defined XML schema corresponding to the example 2DQR descriptor described with respect to Table 20B. In one example, the data type of elements and attributes in Table 20B will be as defined in the schema in FIG. 22. In one example, the schema illustrated in FIG. 22 shall be represented in a XML schema that has namespaceurn:mpeg:mpegI:omaf:2017.

As decribed above, Choi specifies an omnidirectional fisheye video format. In one example, according to the techniques described herein, media presentation description generator 502 may be configured to generate a fisheye omnidirectional video (FOMV) descriptor. In one example, a fisheye omnidirectional video descriptor may be based on the following example definition:

A SupplementalProperty element with a @ schemeIdUri attribute equal to “urn:mpeg:omaf:fomv:2017” is referred to as a fisheye omnidirectional video (FOMV) descriptor. At most one FOMV descriptor may be present at adaptation set level. An FOMV descriptor shall not be present at MPD or representation level. The FOMV descriptor indicates that each Representation carries a fisheye omnidirectional video track containing a FisheyeOmniVideoBox. The @ value attribute of the FOMV descriptor shall not be present. The FOMV descriptor shall include a omaf:@view_dimension_idc attribute whose value shall be as specified in the Table 21:

TABLE 21

| Attribute for | | | |
|---|---|---|---|
| FOMV | | Data | |
| descriptor | Use | type | Description |
| omaf:@view_dimension_idc | M | Omaf:view | Has the same semantics as the view_dimension_idc syntax element (as |
| | | DIdcType | specified in clause 6.2.2) of the FisheyeOmniVideoInfo syntax structure |
| | | | in the FisheyeOmniVideoBox in the tracks carried in the representations |
| | | | of this adaptation set. |

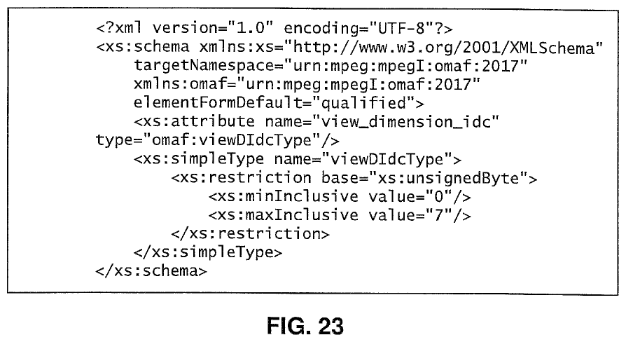

FIG. 23 is a computer program listing illustrating examples of signaling metadata according to one or more techniques of this disclosure. FIG. 23 illustrates an example of a defined XML schema corresponding to the example FOMV descriptor described with respect to Table 21. In one example, the data type of elements and attributes in Table 21 will be as defined in the schema in FIG. 23. In one example, the schema illustrated in FIG. 23 shall be represented in a XML schema that has namespace-urn:mpeg:mpegI:omaf:2017.

In this manner, media presentation description generator 502 represents an example of a device configured to signal information associated with a virtual reality application according to one or more of the techniques described herein.

Referring again to FIG. 1, interface 108 may include any device configured to receive data generated by data encapsulator 107 and transmit and/or store the data to a communications medium. Interface 108 may include a network interface card, such as an Ethernet card, and may include an optical transceiver, a radio frequency transceiver, or any other type of device that can send and/or receive information. Further, interface 108 may include a computer system interface that may enable a file to be stored on a storage device. For example, interface 108 may include a chipset supporting Peripheral Component Interconnect (PCI) and Peripheral Component Interconnect Express (PCIe) bus protocols, proprieta3ry bus protocols, Universal Serial Bus (USB) protocols, I²C, or any other logical and physical structure that may be used to interconnect peer devices.

Referring again to FIG. 1, destination device 120 includes interface 122, data decapsulator 123, video decoder 124, and display 126. Interface 122 may include any device configured to receive data from a communications medium. Interface 122 may include a network interface card, such as an Ethernet card, and may include an optical transceiver, a radio frequency transceiver, or any other type of device that can receive and/or send information. Further, interface 122 may include a computer system interface enabling a compliant video bitstream to be retrieved from a storage device. For example, interface 122 may include a chipset supporting PCI and PCIe bus protocols, proprietary bus protocols, USB protocols, I²C, or any other logical and physical structure that may be used to interconnect peer devices. Data decapsulator 123 may be configured to receive a bitstream generated by data encaspulator 107 and perform sub-bitstream extraction according to one or more of the techniques described herein.

Video decoder 124 may include any device configured to receive a bitstream and/or acceptable variations thereof and reproduce video data therefrom. Display 126 may include any device configured to display video data. Display 126 may comprise one of a variety of display devices such as a liquid crystal display (LCD), a plasma display, an organic light emitting diode (OLED) display, or another type of display. Display 126 may include a High Definition display or an Ultra High Definition display. Display 126 may include a stereoscopic display. It should be noted that although in the example illustrated in FIG. 1, video decoder 124 is described as outputting data to display 126, video decoder 124 may be configured to output video data to various types of devices and/or sub-components thereof. For example, video decoder 124 may be configured to output video data to any communication medium, as described herein. Destination device 120 may include a receive device.

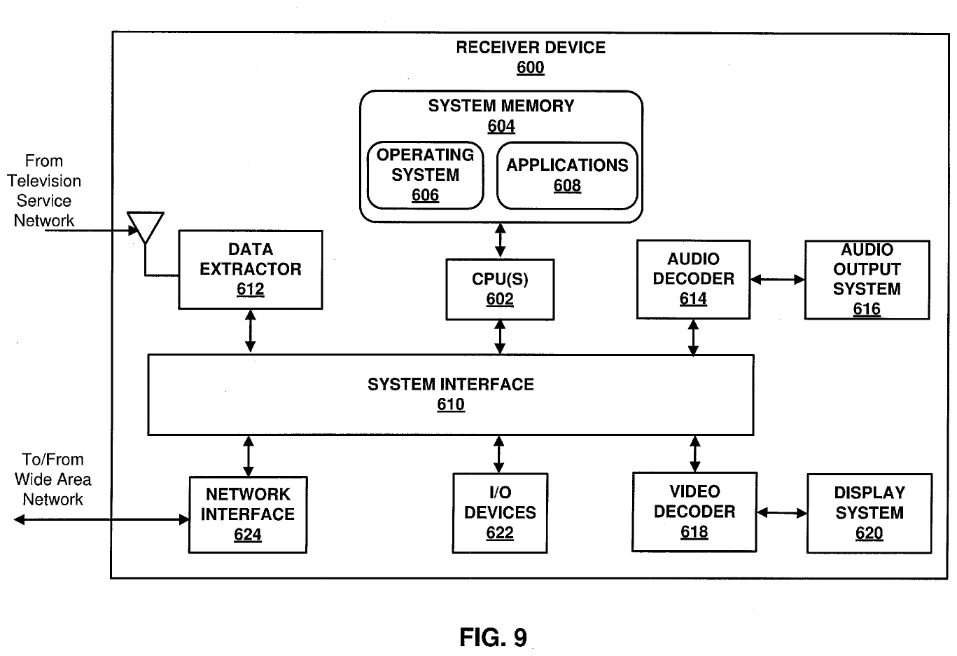

FIG. 9 is a block diagram illustrating an example of a receiver device that may implement one or more techniques of this disclosure. That is, receiver device 600 may be configured to parse a signal based on the semantics described above with respect to one or more of the tables described above. Receiver device 600 is an example of a computing device that may be configured to receive data from a communications network and allow a user to access multimedia content, including a virtual reality application. In the example illustrated in FIG. 9, receiver device 600 is configured to receive data via a television network, such as, for example, television service network 404 described above. Further, in the example illustrated in FIG. 9, receiver device 600 is configured to send and receive data via a wide area network. It should be noted that in other examples, receiver device 600 may be configured to simply receive data through a television service network 404. The techniques described herein may be utilized by devices configured to communicate using any and all combinations of communications networks.

As illustrated in FIG. 9, receiver device 600 includes central processing unit(s) 602, system memory 604, system interface 610, data extractor 612, audio decoder 614, audio output system 616, video decoder 618, display system 620, I/O device(s) 622, and network interface 624. As illustrated in FIG. 9, system memory 604 includes operating system 606 and applications 608. Each of central processing unit(s) 602, system memory 604, system interface 610, data extractor 612, audio decoder 614, audio output system 616, video decoder 618, display system 620, I/O device(s) 622, and network interface 624 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although receiver device 600 is illustrated as having distinct functional blocks, such an illustration is for descriptive purposes and does not limit receiver device 600 to a particular hardware architecture. Functions of receiver device 600 may be realized using any combination of hardware, firmware and/or software implementations.

CPU(s) 602 may be configured to implement functionality and/or process instructions for execution in receiver device 600. CPU(s) 602 may include single and/or multi-core central processing units. CPU(s) 602 may be capable of retrieving and processing instructions, code, and/or data structures for implementing one or more of the techniques described herein. Instructions may be stored on a computer readable medium, such as system memory 604.

System memory 604 may be described as a non-transitory or tangible computer-readable storage medium. In some examples, system memory 604 may provide temporary and/or long-term storage. In some examples, system memory 604 or portions thereof may be described as non-volatile memory and in other examples portions of system memory 604 may be described as volatile memory. System memory 604 may be configured to store information that may be used by receiver device 600 during operation. System memory 604 may be used to store program instructions for execution by CPU(s) 602 and may be used by programs running on receiver device 600 to temporarily store information during program execution. Further, in the example where receiver device 600 is included as part of a digital video recorder, system memory 604 may be configured to store numerous video files.

Applications 608 may include applications implemented within or executed by receiver device 600 and may be implemented or contained within, operable by, executed by, and/or be operatively/communicatively coupled to components of receiver device 600. Applications 608 may include instructions that may cause CPU(s) 602 of receiver device 600 to perform particular functions. Applications 608 may include algorithms which are expressed in computer programming statements, such as, for-loops, while-loops, if-statements, do-loops, etc. Applications 608 may be developed using a specified programming language. Examples of programming languages include, Java™, Jini™, C, C++, Objective C, Swift, Perl, Python, PhP, UNIX Shell, Visual Basic, and Visual Basic Script. In the example where receiver device 600 includes a smart television, applications may be developed by a television manufacturer or a broadcaster. As illustrated in FIG. 9, applications 608 may execute in conjunction with operating system 606. That is, operating system 606 may be configured to facilitate the interaction of applications 608 with CPUs(s) 602, and other hardware components of receiver device 600. Operating system 606 may be an operating system designed to be installed on set-top boxes, digital video recorders, televisions, and the like. It should be noted that techniques described herein may be utilized by devices configured to operate using any and all combinations of software architectures.

System interface 610 may be configured to enable communications between components of receiver device 600. In one example, system interface 610 comprises structures that enable data to be transferred from one peer device to another peer device or to a storage medium. For example, system interface 610 may include a chipset supporting Accelerated Graphics Port (AGP) based protocols, Peripheral Component Interconnect (PCI) bus based protocols, such as, for example, the PCI Express™ (PCIe) bus specification, which is maintained by the Peripheral Component Interconnect Special Interest Group, or any other form of structure that may be used to interconnect peer devices (e.g., proprietary bus protocols).

As described above, receiver device 600 is configured to receive and, optionally, send data via a television service network. As described above, a television service network may operate according to a telecommunications standard. A telecommunications standard may define communication properties (e.g., protocol layers), such as, for example, physical signaling, addressing, channel access control, packet properties, and data processing. In the example illustrated in FIG. 9, data extractor 612 may be configured to extract video, audio, and data from a signal. A signal may be defined according to, for example, aspects DVB standards, ATSC standards, ISDB standards, DTMB standards, DMB standards, and DOCSIS standards.

Data extractor 612 may be configured to extract video, audio, and data, from a signal. That is, data extractor 612 may operate in a reciprocal manner to a service distribution engine. Further, data extractor 612 may be configured to parse link layer packets based on any combination of one or more of the structures described above.

Data packets may be processed by CPU(s) 602, audio decoder 614, and video decoder 618. Audio decoder 614 may be configured to receive and process audio packets. For example, audio decoder 614 may include a combination of hardware and software configured to implement aspects of an audio codec. That is, audio decoder 614 may be configured to receive audio packets and provide audio data to audio output system 616 for rendering. Audio data may be coded using multi-channel formats such as those developed by Dolby and Digital Theater Systems. Audio data may be coded using an audio compression format. Examples of audio compression formats include Motion Picture Experts Group (MPEG) formats, Advanced Audio Coding (AAC) formats, DTS-HD formats, and Dolby Digital (AC-3) formats. Audio output system 616 may be configured to render audio data. For example, audio output system 616 may include an audio processor, a digital-to-analog converter, an amplifier, and a speaker system. A speaker system may include any of a variety of speaker systems, such as headphones, an integrated stereo speaker system, a multi-speaker system, or a surround sound system.

Video decoder 618 may be configured to receive and process video packets. For example, video decoder 618 may include a combination of hardware and software used to implement aspects of a video codec. In one example, video decoder 618 may be configured to decode video data encoded according to any number of video compression standards, such as ITU-T H.262 or ISO/IEC MPEG-2 Visual, ISO/IEC MPEG-4 Visual, ITU-T H.264 (also known as ISO/IEC MPEG-4 Advanced video Coding (AVC)), and High-Efficiency Video Coding (HEVC). Display system 620 may be configured to retrieve and process video data for display. For example, display system 620 may receive pixel data from video decoder 618 and output data for visual presentation. Further, display system 620 may be configured to output graphics in conjunction with video data, e.g., graphical user interfaces. Display system 620 may comprise one of a variety of display devices such as a liquid crystal display (LCD), a plasma display, an organic light emitting diode (OLED) display, or another type of display device capable of presenting video data to a user. A display device may be configured to display standard definition content, high definition content, or ultra-high definition content.

I/O device(s) 622 may be configured to receive input and provide output during operation of receiver device 600. That is, I/O device(s) 622 may enable a user to select multimedia content to be rendered. Input may be generated from an input device, such as, for example, a push-button remote control, a device including a touch-sensitive screen, a motion-based input device, an audio-based input device, or any other type of device configured to receive user input. I/O device(s) 622 may be operatively coupled to receiver device 600 using a standardized communication protocol, such as for example, Universal Serial Bus protocol (USB), Bluetooth, ZigBee or a proprietary communications protocol, such as, for example, a proprietary infrared communications protocol.

Network interface 624 may be configured to enable receiver device 600 to send and receive data via a local area network and/or a wide area network. Network interface 624 may include a network interface card, such as an Ethernet card, an optical transceiver, a radio frequency transceiver, or any other type of device configured to send and receive information. Network interface 624 may be configured to perform physical signaling, addressing, and channel access control according to the physical and Media Access Control (MAC) layers utilized in a network. Receiver device 600 may be configured to parse a signal generated according to any of the techniques described above with respect to FIG. 8. In this manner, receiver device 600 represents an example of a device configured parse one or more syntax elements including information associated with a virtual reality application.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

Various examples have been described. These and other examples are within the scope of the following claims.

<Overview>

In one example, a method of signaling information associated with an omnidirectional video comprises signaling region-wise quality ranking information associated with an omnidirectional video using a media presentation description document, wherein signaling region-wise quality ranking information associated with an omnidirectional video using a media presentation description document includes signaling a set of values using a comma separated list enclosed by delimiters.

In one example, a device comprises one or more processors configured to signal region-wise quality ranking information associated with an omnidirectional video using a media presentation description document, wherein signaling region-wise quality ranking information associated with an omnidirectional video using a media presentation description document includes signaling a set of values using a comma separated list enclosed by delimiters.

In one example, a non-transitory computer-readable storage medium comprises instructions stored thereon that, when executed, cause one or more processors of a device to signaling region-wise quality ranking information associated with an omnidirectional video using a media presentation description document, wherein signaling region-wise quality ranking information associated with an omnidirectional video using a media presentation description document includes signaling a set of values using a comma separated list enclosed by delimiters.

In one example, an apparatus comprises means for signaling region-wise quality ranking information associated with an omnidirectional video using a media presentation description document, wherein signaling region-wise quality ranking information associated with an omnidirectional video using a media presentation description document includes signaling a set of values using a comma separated list enclosed by delimiters.

In one example, a method of determining information associated with an omnidirectional video comprises parsing region-wise quality ranking information associated with an omnidirectional video using a media presentation description document, wherein parsing region-wise quality ranking information associated with an omnidirectional video using a media presentation description document includes parsing a set of values from a comma separated list enclosed by delimiters.

In one example, a device comprises one or more processors configured to parse region-wise quality ranking information associated with an omnidirectional video using a media presentation description document, wherein parsing region-wise quality ranking information associated with an omnidirectional video using a media presentation description document includes parsing a set of values from a comma separated list enclosed by delimiters.

In one example, a non-transitory computer-readable storage medium comprises instructions stored thereon that, when executed, cause one or more processors of a device to parse region-wise quality ranking information associated with an omnidirectional video using a media presentation description document, wherein parsing region-wise quality ranking information associated with an omnidirectional video using a media presentation description document includes parsing a set of values from a comma separated list enclosed by delimiters.

In one example, an apparatus comprises means for parsing region-wise quality ranking information associated with an omnidirectional video using a media presentation description document, wherein parsing region-wise quality ranking information associated with an omnidirectional video using a media presentation description document includes parsing a set of values from a comma separated list enclosed by delimiters.

### CROSS REFERENCE

This Nonprovisional application claims priority under 35 U.S.C. § 119 on provisional Application No. 62/529,429 on Jul. 6, 2017 and provisional Application No. 62/530,136 on Jul. 8, 2017 and provisional Application No. 62/530,253 on Jul. 9, 2017 and provisional Application No. 62/570,540 on Oct. 10, 2017 and provisional Application No. 62/572,312 on Oct. 13, 2017 and provisional Application No. 62/585,864 on Nov. 14, 2017, the entire contents of which are hereby incorporated by reference.

1-11. (canceled)

12. A method of signaling information associated with an omnidirectional video, the method comprising:
signaling region-wise quality ranking information associated with an omnidirectional video using a media presentation description document, wherein the media presentation description document includes a container element including one or more quality information elements and a common set of attributes that apply to all those quality information elements,
wherein signaling region-wise quality ranking information includes signaling a value for an attribute in the common set of attributes that indicates a shape type for a sphere region, and
wherein signaling region-wise quality ranking information includes for a quality information element signaling a value for an attribute indicating a quality ranking of the sphere region.

13. The method of claim 12, wherein signaling region-wise quality ranking information includes for the quality information element signaling a value for an attribute indicating a view type of the sphere region.

14. The method of claim 13, wherein signaling region-wise quality ranking information includes for the quality information element signaling a value for an attribute indicating an azimuth of the center point of the sphere region.

15. The method of claim 14, wherein signaling region-wise quality ranking information includes for the quality information element signaling a value for an attribute indicating a pitch of the center point of the sphere region.

16. The method of claim 15, wherein signaling region-wise quality ranking information includes for the quality information element signaling a value for an attribute indicating a tilt angle of the sphere region.

17. A method of determining information associated with an omnidirectional video, the method comprising:
receiving region-wise quality ranking information associated with an omnidirectional video in a media presentation description document, wherein the media presentation description document includes a container element including one or more quality information elements and a common set of attributes that apply to all those quality information elements;
parsing a value for an attribute in the common set of attributes that indicates a shape type for a sphere region; and
parsing a value for an attribute for a quality information element indicating a quality ranking of the sphere region.

18. The method of claim 17, further comprising parsing a value for an attribute for the quality information element indicating a view type of the sphere region.

19. The method of claim 18, further comprising parsing a value for an attribute for the quality information element indicating an azimuth of the center point of the sphere region.

20. The method of claim 19, further comprising parsing a value for an attribute for the quality information element indicating a pitch of the center point of the sphere region.

21. The method of claim 20, further comprising parsing a value for an attribute for the quality information element indicating a tilt angle of the sphere region.

22. A device comprising one or more processors configured to:
receive region-wise quality ranking information associated with an omnidirectional video in a media presentation description document, wherein the media presentation description document includes a container element including one or more quality information elements and a common set of attributes that apply to all those quality information elements;
parse a value for an attribute in the common set of attributes that indicates a shape type for a sphere region; and
parse a value for an attribute for a quality information element indicating a quality ranking of the sphere region.

23. The device of claim 22, the one or more processors further configured to parse a value for an attribute for the quality information element indicating a view type of the sphere region.

24. The device of claim 23, the one or more processors further configured to parse a value for an attribute for the quality information element indicating an azimuth of the center point of the sphere region.

25. The device of claim 24, the one or more processors further configured to parse a value for an attribute for the quality information element indicating a pitch of the center point of the sphere region.

26. The device of claim 25, the one or more processors further configured to parse a value for an attribute for a quality information element indicating a tilt angle of the sphere region.
